(19) United States
(12) Patent Application Publication
(10) Pub. No.: US 2022/0201765 A1
(43) Pub. Date: Jun. 23, 2022

(54) METHOD AND APPARATUS FOR DETERMINING WHETHER TO USE BUFFER STATUS REPORT ENHANCEMENT IN A WIRELESS COMMUNICATION SYSTEM

(71) Applicant: ASUSTek Computer Inc., Taipei City (TW)

(72) Inventors: Yi-Hsuan HUANG, Taipei City (TW); Tun-Huai SHIH, Taipei City (TW); Meng-Hui OU, Taipei City (TW)

(21) Appl. No.: 17/551,742

(22) Filed: Dec. 15, 2021

Related U.S. Application Data
(60) Provisional application No. 63/127,348, filed on Dec. 18, 2020.
(60) Provisional application No. 63/127,362, filed on Dec. 18, 2020.
(60) Provisional application No. 63/127,531, filed on Dec. 18, 2020.
(60) Provisional application No. 63/130,539, filed on Dec. 24, 2020.

(51) Int. Cl. H04W 74/08; H04W 28/02; H04W 24/10; H04B 17/318

(52) U.S. Cl. CPC H04W 74/0841; H04W 28/0278; H04W 84/06; H04B 17/318; H04W 24/10

(57) ABSTRACT

A method and apparatus are disclosed. In an example from the perspective of a User Equipment (UE), the UE receives a configuration, of a logical channel, associated with 2-step Random Access (RA) procedure. The UE triggers a Regular Buffer Status Report (BSR) for the logical channel. The UE determines whether to initiate a first 2-step RA procedure or to initiate a first 4-step RA procedure based on the configuration of the logical channel.

### CROSS-REFERENCE TO RELATED APPLICATIONS

The present Application claims the benefit of U.S. Provisional Patent Application Ser. No. 63/127,348 filed on Dec. 18, 2020, the entire disclosure of which is incorporated herein in its entirety by reference. The present Application also claims the benefit of U.S. Provisional Patent Application Ser. No. 63/127,362 filed on Dec. 18, 2020, the entire disclosure of which is incorporated herein in its entirety by reference. The present Application also claims the benefit of U.S. Provisional Patent Application Ser. No. 63/127,531 filed on Dec. 18, 2020, the entire disclosure of which is incorporated herein in its entirety by reference. The present Application also claims the benefit of U.S. Provisional Patent Application Ser. No. 63/130,539 filed on Dec. 24, 2020, the entire disclosure of which is incorporated herein in its entirety by reference.

### FIELD

This disclosure generally relates to wireless communication networks, and more particularly, to a method and apparatus for determining whether to use Buffer Status Report (BSR) enhancement in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE), the UE receives a configuration, of a logical channel, associated with 2-step Random Access (RA) procedure. The UE triggers a Regular Buffer Status Report (BSR) for the logical channel. The UE determines whether to initiate a first 2-step RA procedure or to initiate a first 4-step RA procedure based on the configuration of the logical channel.

In an example from the perspective of a UE, the UE receives a configuration, of a logical channel, associated with 2-step RA procedure. The UE triggers a Regular BSR for the logical channel. The UE determines whether or not to initiate a first 2-step RA procedure based on the configuration of the logical channel.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with scheduling UE transmission according to one exemplary embodiment.

FIG. 6 is a diagram illustrating an exemplary scenario associated with a procedure associated with Buffer Status Report (BSR) and/or Scheduling Request (SR) according to one exemplary embodiment.

FIG. 7 is a flow chart according to one exemplary embodiment.

FIG. 8 is a flow chart according to one exemplary embodiment.

FIG. 9 is a flow chart according to one exemplary embodiment.

FIG. 10 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: RP-201256, “Solutions for NR to support non-terrestrial networks (NTN)”; 3GPP TR 38.821 V16.0.0, “Solutions for NR to support non-terrestrial networks (NTN)”; 3GPP TS 38.321 V16.2.1, “NR, MAC protocol specification”; 3GPP TS 38.331 V16.2.0, “NR, RRC protocol specification”; 3GPP TS 38.300 V16.3.0, “NR, NR and NG-RAN Overall Description, Stage 2”; RP-193238, “New SID on support of reduced capability NR devices”; R2-2008701, “Report of 3GPP TSG RAN2#111-e meeting, Online”; R2-2009064, “Enhancements on UL scheduling for NTN”. The standards and documents listed above are hereby expressly incorporated by reference in their entirety.

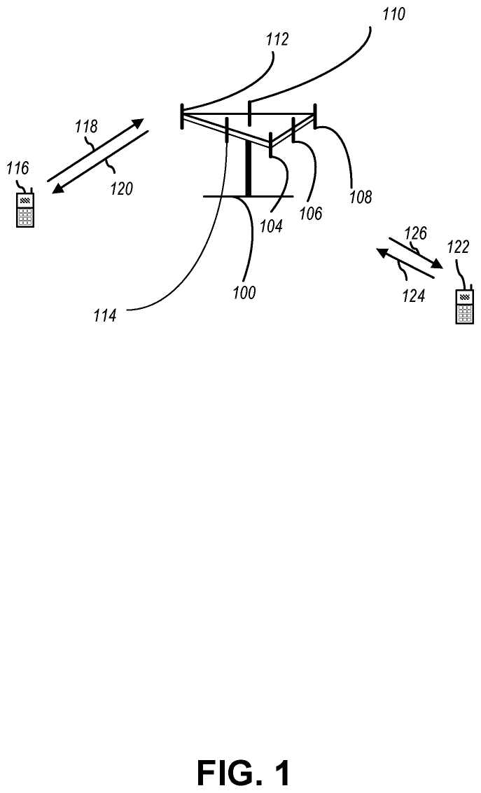

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

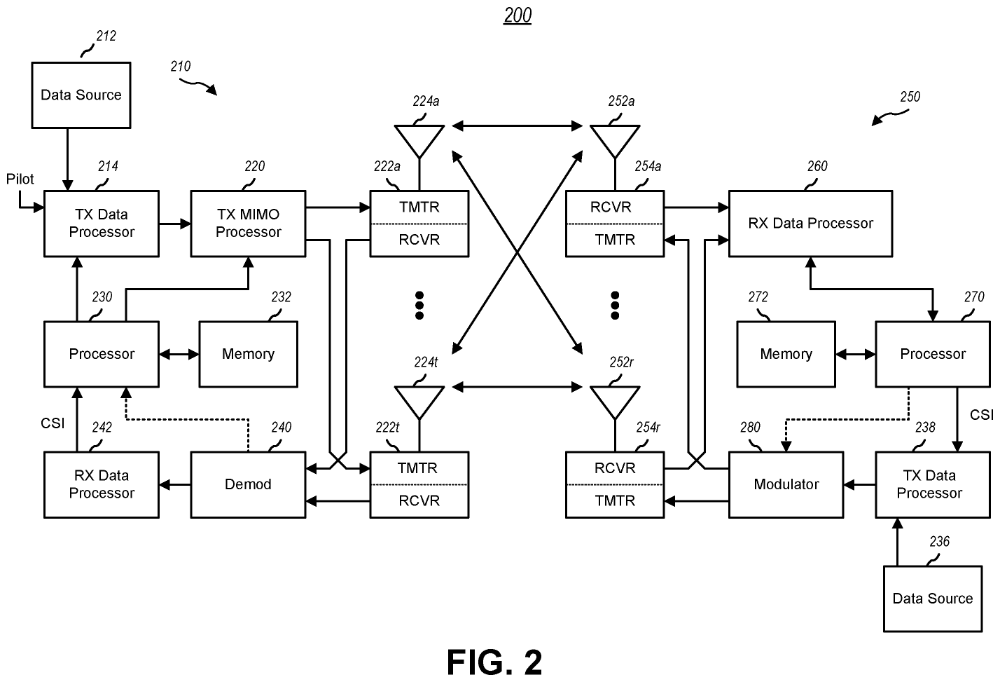

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

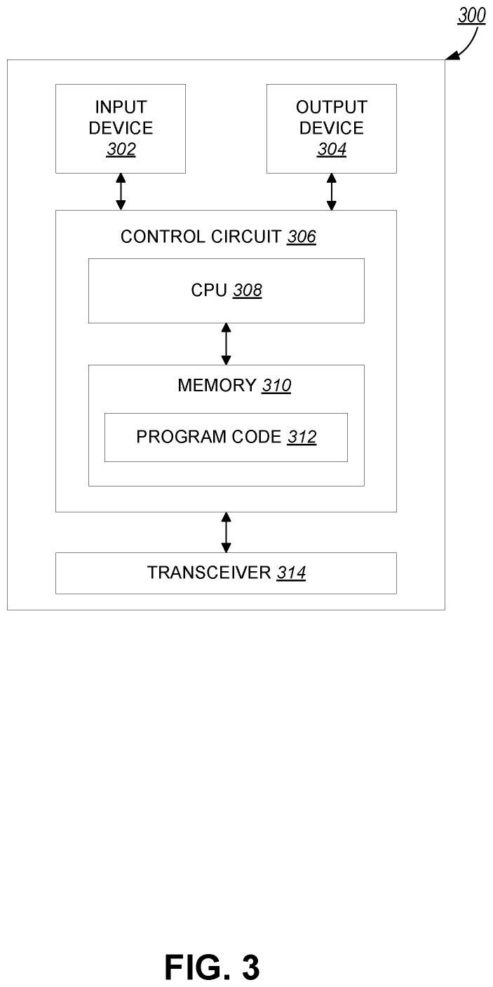

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

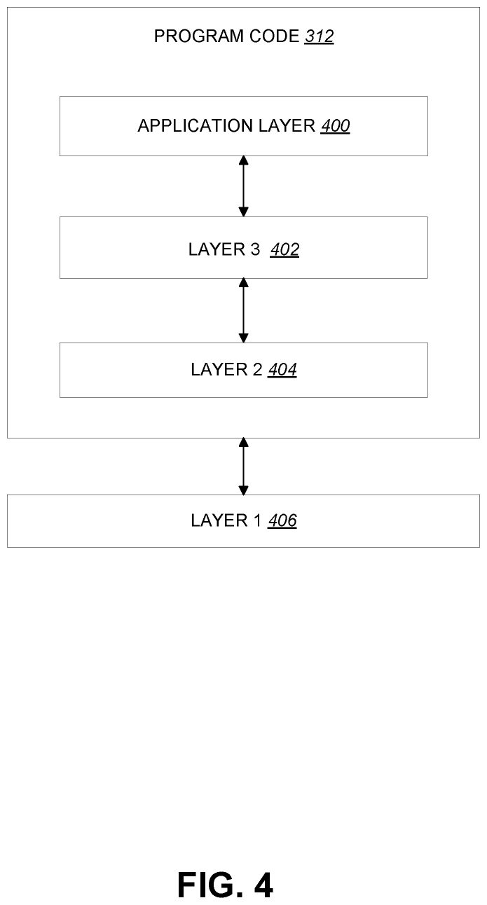

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1portion 406. The Layer 3 portion 402 may perform radio resource control. The Layer 2 portion 404 may perform link control. The Layer 1 portion 406 may perform and/or implement physical connections.

A work item of non-terrestrial networks (NTNs) in NR has been approved in RAN plenary #88 meeting. The description of the work item is provided in RP-201256, one or more parts of which are quoted below:

3 Justification

Non-terrestrial networks refer to networks, or segments of networks, using an airborne or spaceborne vehicle for transmission:
Spaceborne vehicles: Satellites (including Low Earth Orbiting (LEO) satellites, Medium Earth Orbiting (MEO) satellites, Geostationary Earth Orbiting (GEO) satellites as well as Highly Elliptical Orbiting (HEO) satellites)
Airborne vehicles: High Altitude Platforms (HAPs) encompassing Unmanned Aircraft Systems (UAS) including Lighter than Air UAS (LTA), Heavier than Air UAS (HTA), all operating in altitudes typically between 8 and 50 km, quasi-stationary.

Furthermore an email discussion took place between RAN#85 and #86 on the scoping of a REl-17 WI on non-terrestrial network. The report of this email discussion is available in RP-192500. It concluded that the Rel-17 NR-NTN NWI should include two activities:
Normative activity on NR-NTN to develop specifications to support the following scenarios:
   Transparent payload based LEO scenario addressing at least 3GPP class 3 UE with and without GNSS capability and both Earth fixed &/or moving cell scenario (as per SI outcome).
      Note 1: Addressing LEO will provide the flexibility to also support transparent payload based HAPS based scenarios.
   Transparent payload based GEO scenario addressing UE with GNSS capability.
      Note 2: Addressing LEO and GEO scenarios will enable NR to support all NGSO scenarios with circular orbit at altitude greater than or equal to 600 km.
Study activity on NTN scenarios addressing
   Transparent payload based HAPS scenarios: Study of enablers for Spectrum coexistence with cellular (additional Coresets, PCI confusion mitigation, . . . )
   IoT-NTN based scenarios
   NTN-network based location of UE (for regulatory services): identify possible solutions

Addressing LEO and GEO scenarios will enable to support all NGSO scenarios with circular orbit at altitude greater than or equal to 600 km

4 Objective

4.1 Objective of SI or Core part WI or Testing part WI

The work item aims to specify the enhancements identified for NR NTN (non-terrestrial networks) especially LEO and GEO with implicit compatibility to support HAPS (high altitude platform station) and ATG (air to ground) scenarios according to the following principles:
FDD is assumed for core specification work for NR-NTN.
Earth fixed Tracking area is assumed with Earth fixed and moving cells
UEs with GNSS capabilities are assumed.
Transparent payload is assumed

The detailed objectives are to specify enhancing features to Rel-15 & Rel-16's NR radio interface & NG-RAN as follows:

4.1.2 RAN2

The following user plane procedures enhancements should be specified (see TR 38.821)
MAC
   [. . .]
   Enhancement on UL scheduling to reduce scheduling latency.
   DRX:
      If HARQ feedback is enabled, introduction of offset for drx-HARQ-RTT-TimerDL and drx-HARQ-RTT-TimerUL.
      If HARQ is turned off per HARQ process, adaptions in HARQ procedure
   Scheduling Request: Extension of the value range of sr-ProhibitTimer

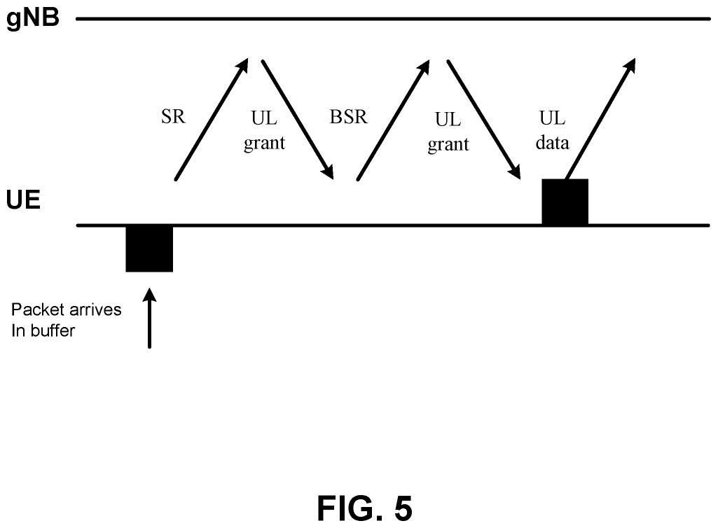

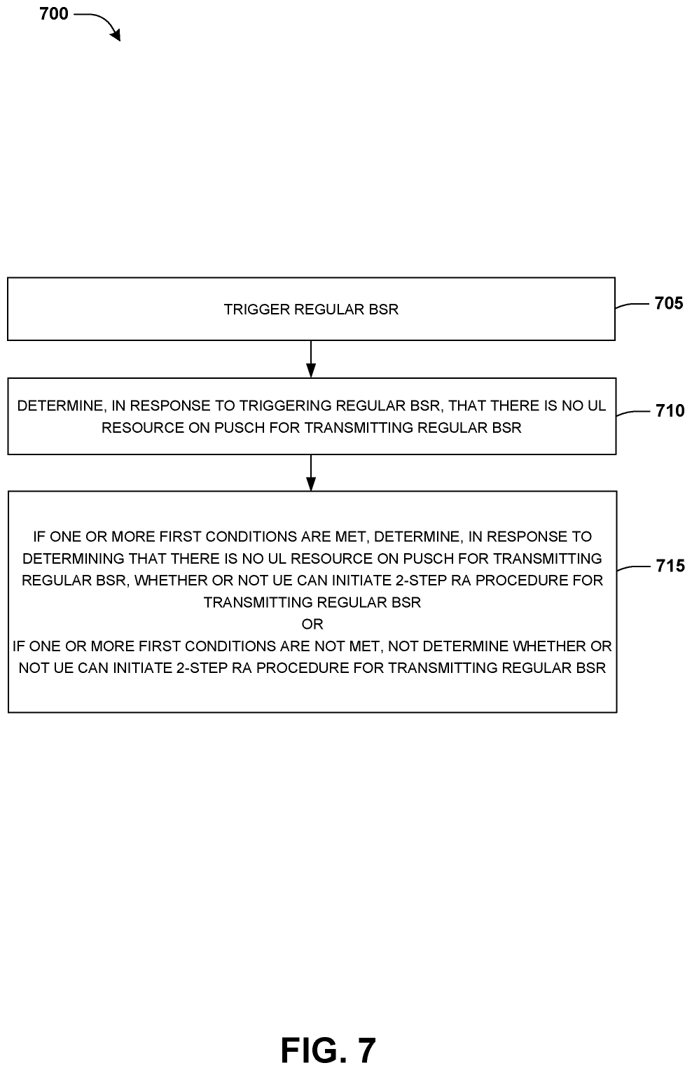

Scheduling enhancement of NTN is described in 3GPP TR 38.821 V16.0.0. Notably, FIG. 7.2.1.5-1 of Section 7.2.1.5.1 of 3GPP TR 38.821 V16.0.0, entitled “Scheduling of UE transmission”, is reproduced herein as FIG. 5. One or more parts of 3GPP TR 38.821 V16.0.0 are quoted below:

7.2.1.5 Uplink scheduling

7.2.1.5.1 Assignment of uplink resources

Problem Statement

The typical procedure when data arrives in the buffer is to trigger a Buffer Status Report and if the UE does not have any uplink resources for transmitting the BSR, the UE will go on to do a Scheduling Request to ask for resources. Since the scheduling request is only an indication telling the network that the UE requires scheduling, the network will not know the full extent of the resources required to schedule the UE, thus first the network may typically schedule the UE with a grant large enough to send a BSR so that the network may schedule the UE more accordingly as seen in FIG. 7.2.1.5-1.

### FIG. 7.2.1.5-1: Scheduling of UE transmission

In non-terrestrial networks the drawback of this procedure is that it would take at least 2 Round-trip times from data arriving in the buffer at the UE side until it can be properly scheduled with resources that would fit the data and the required QoS. Due to the large propagation delays this may become prohibitively large.

Possible Solutions/Options

In order to mitigate the problem there may be a number of possible solutions. In Table 7.2.1.5-1 some different options in terms of their pros, cons and delays have been characterized. However the feasibility of the solutions has not been discussed in detail and will be addressed during the work item phase.

TABLE 7.2.1.5-1
Scheduling enhancement options

| Scheduling | | | | |
|---|---|---|---|---|
| option | Pros | Cons | Delays* | |
| SR-BSR | Low resource overhead | Large delays | At least 2 | |
| procedure | required | | RTTs of delay | |
| Sending large | Potentially low resource | Still takes 2 RTTs before UE | 1-2 | RTTs |
| grant in | overhead | has the BSR | | |
| response to SR | | Might be a waste in terms of | | |
| | | resources since network is still | | |
| | | not aware of the buffer situation | | |
| | | of the UE | | |
| Configured | Low latency with right | Large overhead | 0-1 | RTT** |
| grant | configuration | Trade-off between latency and | | |
| | | overhead | | |
| BSR-indication | Low latency with correct | Large spec-impact | 1 | RTT |
| in SR | configuration | Resource overhead impact | | |
| | | unclear, larger than SR | | |
| BSR over 2- | Low latency | RACH resources required | 0-1 | RTT** |
| step random | Low overhead | | | |
| access | | | | |

*the number of RTTs before full scheduling based on BSR can begin.
**if configured grant/2-step allocation is large enough and data can be transmitted in the grant.

In NR, BSR and SR procedures are discussed in 3GPP TS 38.321 V16.2.1, one or more parts of which are quoted below:

5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure (see clause 5.21), at most one PUCCH resource for SR is configured per BWP.

Each SR configuration corresponds to one or more logical channels and/or to SCell beam failure recovery and/or to consistent LBT failure. Each logical channel, SCell beam failure recovery, and consistent LBT failure, may be mapped to zero or one SR configuration, which is configured by RRC. The SR configuration of the logical channel that triggered a BSR (clause 5.4.5) or the SCell beam failure recovery or the consistent LBT failure (clause 5.21) (if such a configuration exists) is considered as corresponding SR configuration for the triggered SR. Any SR configuration may be used for an SR triggered by Pre-emptive BSR (clause 5.4.7).

RRC configures the following parameters for the scheduling request procedure:
sr-ProhibitTimer (per SR configuration);
sr-TransMax (per SR configuration).

The following UE variables are used for the scheduling request procedure:
SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

Except for SCell beam failure recovery, all pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR (see clause 5.4.5) prior to the MAC PDU assembly. Except for SCell beam failure recovery, all pending SR(s) for BSR triggered according to the BSR procedure (clause 5.4.5) shall be cancelled and each respective sr-ProhibitTimer shall be stopped when the UL grant(s) can accommodate all pending data available for transmission. All pending SR(s) for Pre-emptive BSR triggered according to the Pre-emptive BSR procedure (clause 5.4.7) prior to the MAC PDU assembly shall be cancelled and each respective sr-ProhibitTimer shall be stopped when a MAC PDU containing the relevant Pre-emptive BSR MAC CE is transmitted. Pending SR triggered for beam failure recovery of an SCell shall be cancelled and respective sr-ProhibitTimer shall be stopped when the MAC PDU is transmitted and this PDU includes an BFR MAC CE or Truncated BFR MAC CE which contains beam failure recovery information of that SCell. [. . .]

Only PUCCH resources on a BWP which is active at the time of SR transmission occasion are considered valid.

As long as at least one SR is pending, the MAC entity shall for each pending SR:
1> if the MAC entity has no valid PUCCH resource configured for the pending SR:
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      3> if the PUCCH resource for the SR transmission occasion overlaps with neither a UL-SCH resource nor an SL-SCH resource; or
      3> if the MAC entity is able to perform this SR transmission simultaneously with the transmission of the SL-SCH resource; or
      3> if the MAC entity is configured with lch-basedPrioritization, and the PUCCH resource for the SR transmission occasion does not overlap with an uplink grant received in a Random Access Response nor with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized, and the priority of the uplink grant is determined as specified in clause 5.4.1; or
      [. . . ]
         4> consider the SR transmission as a prioritized SR transmission.
         4> consider the other overlapping uplink grant(s), if any, as a de-prioritized uplink grant(s);
         4> if SR_COUNTER <sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if lbt-FailureRecoveryConfig is not configured:
         6> increment SR_COUNTER by 1.
         4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure (see clause 5.1) on the SpCell and cancel all pending SRs.
      3> else:
         4> consider the SR transmission as a de-prioritized SR transmission.

NOTE 1: Except for SR for SCell beam failure recovery, the selection of which valid PUCCH resource for SR to signal SR on when the MAC entity has more than one overlapping valid PUCCH resource for the SR transmission occasion is left to UE implementation.

[. . . ]

NOTE 4: For a UE operating in a semi-static channel access mode as described in TS 37.213 [18], PUCCH resources overlapping with the idle time of a fixed frame period are not considered valid.

The MAC entity may stop, if any, ongoing Random Access procedure due to a pending SR for BSR and BFR which has no valid PUCCH resources configured, which was initiated by MAC entity prior to the MAC PDU assembly. The ongoing Random Access procedure due to a pending SR for BSR may be stopped when the MAC PDU is transmitted using a UL grant other than a UL grant provided by Random Access Response or a UL grant determined as specified in clause 5.1.2a for the transmission of the MSGA payload, and this PDU includes a BSR MAC CE which contains buffer status up to (and including) the last event that triggered a BSR (see clause 5.4.5) prior to the MAC PDU assembly, or when the UL grant(s) can accommodate all pending data available for transmission. The ongoing Random Access procedure due to a pending SR for BFR of an SCell may be stopped when the MAC PDU is transmitted using a UL grant other than a UL grant provided by Random Access Response or a UL grant determined as specified in clause 5.1.2a for the transmission of the MSGA payload and this PDU contains an BFR MAC CE or Truncated BFR MAC CE which includes beam failure recovery information of that SCell. Upon deactivation of SCell (as specified in clause 5.9) configured with beam failure detection the ongoing Random Access procedure due to a pending SR for BFR may be stopped if all triggered BFRs for SCells are cancelled.

5.4.5 Buffer Status Reporting

The Buffer Status reporting (BSR) procedure is used to provide the serving gNB with information about UL data volume in the MAC entity.
RRC configures the following parameters to control the BSR:
periodicBSR-Timer;
retxBSR-Timer;
logicalChannelSR-DelayTimerApplied;
logicalChannelSR-DelayTimer;
logicalChannelSR-Mask;
logicalChannelGroup.

Each logical channel may be allocated to an LCG using the logicalChannelGroup. The maximum number of LCGs is eight.

The MAC entity determines the amount of UL data available for a logical channel according to the data volume calculation procedure in TSs 38.322 [3] and 38.323 [4].

A BSR shall be triggered if any of the following events occur:
UL data, for a logical channel which belongs to an LCG, becomes available to the MAC entity; and either
   this UL data belongs to a logical channel with higher priority than the priority of any logical channel containing available UL data which belong to any LCG; or
   none of the logical channels which belong to an LCG contains any available UL data.
in which case the BSR is referred below to as ‘Regular BSR’;
UL resources are allocated and number of padding bits is equal to or larger than the size of the Buffer Status Report MAC CE plus its subheader, in which case the BSR is referred below to as ‘Padding BSR’;
retxBSR-Timer expires, and at least one of the logical channels which belong to an LCG contains UL data, in which case the BSR is referred below to as ‘Regular BSR’;
periodicBSR-Timer expires, in which case the BSR is referred below to as ‘Periodic BSR’.
NOTE 1: When Regular BSR triggering events occur for multiple logical channels simultaneously, each logical channel triggers one separate Regular BSR.

For Regular BSR, the MAC entity shall:
1> if the BSR is triggered for a logical channel for which logicalChannelSR-DelayTimerApplied with value true is configured by upper layers:
   2> start or restart the logicalChannelSR-DelayTimer.
1> else:
   2> if running, stop the logicalChannelSR-DelayTimer.

For Regular and Periodic BSR, the MAC entity shall:
1> if more than one LCG has data available for transmission when the MAC PDU containing the BSR is to be built:
   2> report Long BSR for all LCGs which have data available for transmission.
1> else:
   2> report Short BSR.

[. . . ]

For BSR triggered by retxBSR-Timer expiry, the MAC entity considers that the logical channel that triggered the BSR is the highest priority logical channel that has data available for transmission at the time the BSR is triggered.

The MAC entity shall:
1> if the Buffer Status reporting procedure determines that at least one BSR has been triggered and not cancelled:
   2> if UL-SCH resources are available for a new transmission and the UL-SCH resources can accommodate the BSR MAC CE plus its subheader as a result of logical channel prioritization:
      3> instruct the Multiplexing and Assembly procedure to generate the BSR MAC CE(s) as defined in clause 6.1.3.1;
      3> start or restart periodicBSR-Timer except when all the generated BSRs are long or short Truncated BSRs;
      3> start or restart retxBSR-Timer.
   2> if a Regular BSR has been triggered and logicalChannelSR-DelayTimer is not running:
      3> if there is no UL-SCH resource available for a new transmission; or
      3> if the MAC entity is configured with configured uplink grant(s) and the Regular BSR was triggered for a logical channel for which logicalChannelSR-Mask is set to false; or
      3> if the UL-SCH resources available for a new transmission do not meet the LCP mapping restrictions (see clause 5.4.3.1) configured for the logical channel that triggered the BSR:
         4> trigger a Scheduling Request.

NOTE 2: UL-SCH resources are considered available if the MAC entity has an active configuration for either type of configured uplink grants, or if the MAC entity has received a dynamic uplink grant, or if both of these conditions are met. If the MAC entity has determined at a given point in time that UL-SCH resources are available, this need not imply that UL-SCH resources are available for use at that point in time.

A MAC PDU shall contain at most one BSR MAC CE, even when multiple events have triggered a BSR. The Regular BSR and the Periodic BSR shall have precedence over the padding BSR.

The MAC entity shall restart retxBSR-Timer upon reception of a grant for transmission of new data on any UL-SCH.

All triggered BSRs may be cancelled when the UL grant(s) can accommodate all pending data available for transmission but is not sufficient to additionally accommodate the BSR MAC CE plus its subheader. All BSRs triggered prior to MAC PDU assembly shall be cancelled when a MAC PDU is transmitted and this PDU includes a Long or Short BSR MAC CE which contains buffer status up to (and including) the last event that triggered a BSR prior to the MAC PDU assembly.

The initialization procedure of random access is discussed in 3GPP TS 38.300 V16.3.0, one or more parts of which are quoted below: TS 38.300 [5] and TS 38.321 [3] as below:

9.2.6 Random Access Procedure

The random access procedure is triggered by a number of events:
Initial access from RRC_IDLE;
RRC Connection Re-establishment procedure;
DL or UL data arrival during RRC_CONNECTED when UL synchronisation status is “non-synchronised”;
UL data arrival during RRC_CONNECTED when there are no PUCCH resources for SR available;
SR failure;
Request by RRC upon synchronous reconfiguration (e.g. handover);
Transition from RRC_INACTIVE;
To establish time alignment for a secondary TAG;
Request for Other SI (see clause 7.3);
Beam failure recovery;
Consistent UL LBT failure on SpCell.

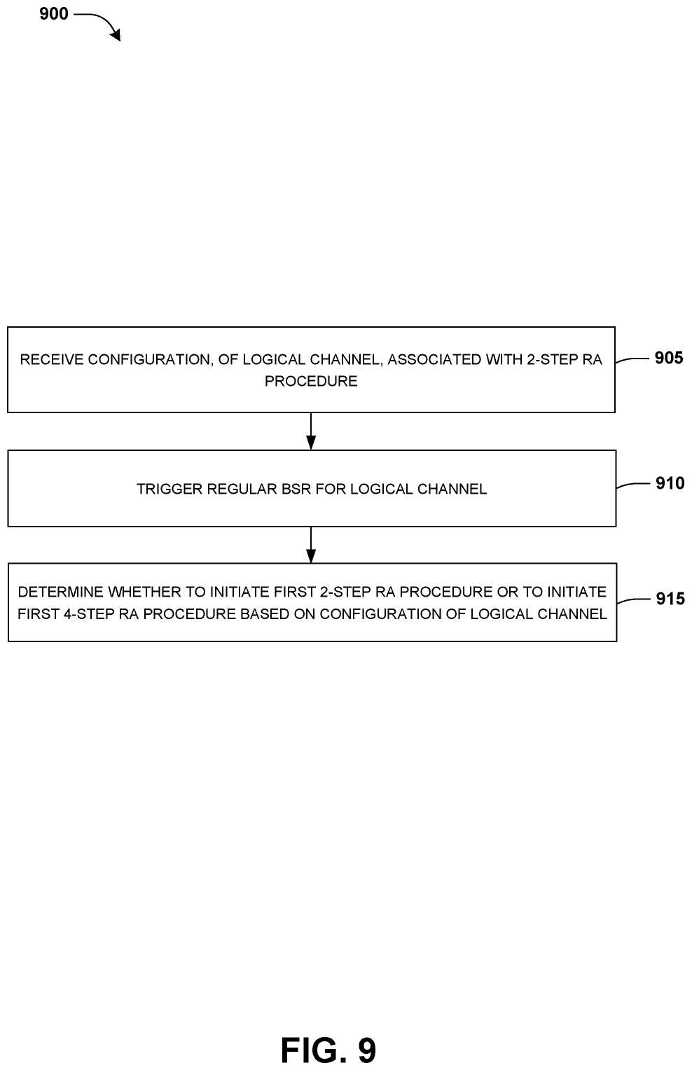

Two types of random access procedure are supported: 4-step RA type with MSG1 and 2-step RA type with MSGA. Both types of RA procedure support contention-based random access (CBRA) and contention-free random access (CFRA) as shown on FIG. 9.2.6-1 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type. [. . . ]

If the random access procedure with 2-step RA type is not completed after a number of MSGA transmissions, the UE can be configured to switch to CBRA with 4-step RA type.

The initialization procedure of random access is discussed in 3GPP TS 38.321 V16.2.1, one or more parts of which are quoted below:

5.1 Random Access procedure

5.1.1 Random Access procedure initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-Preambleindex different from Ob000000.

[. . . ]RRC configures the following parameters for the Random Access procedure:
prach-Configurationindex: the available set of PRACH occasions for the transmission of the Random Access Preamble for Msg1. These are also applicable to the MSGA PRACH if the PRACH occasions are shared between 2-step and 4-step RA types;
[. . . ]
msgA-prach-Configurationlndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
rsrp-ThresholdSSB: an RSRP threshold for the selection of the SSB for 4-step RA type. If the Random Access procedure is initiated for beam failure recovery, rsrp-ThresholdSSB used for the selection of the SSB within candidateBeamRSList refers to rsrp-ThresholdSSB in BeamFailureRecoveryConfig IE;
rsrp-ThresholdCSl-RS: an RSRP threshold for the selection of CSI-RS for 4-step RA type. If the Random Access procedure is initiated for beam failure recovery, rsrp-ThresholdCSl-RS is equal to rsrp-ThresholdSSB in BeamFailureRecoveryConfig IE;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
msgA-TransMax: The maximum number of MSGA transmissions when both 4-step and 2-step RA type Random Access Resources are configured;
[. . . ]
scalingFactorBl: a scaling factor for prioritized Random Access procedure;
ra-PreambleIndex: Random Access Preamble;
ra-ssb-OccasionMasklndex: defines PRACH occasion(s) associated with an SSB in which the MAC entity may transmit a Random Access Preamble (see clause 7.4);
msgA-SSB-SharedRO-Masklndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-Masklndex is not configured, then all 4-step RA type PRACH occasions are available for 2-step RA type (see clause 7.4);
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
preambleTransMax: the maximum number of Random Access Preamble transmission;
ssb-perRACH-OccasionAndCB-PreamblesPerSSB: defines the number of SSBs mapped to each PRACH occasion for 4-step RA type and the number of contention-based Random Access Preambles mapped to each SSB;
msgA-CB-PreamblesPerSSB-PerSharedRO: defines the number of contention-based Random Access Preambles for 2-step RA type mapped to each SSB when the PRACH occasions are shared between 2-step and 4-step RA types;
msgA-SSB-PerRACH-OccasionAndCB-PreamblesPerSSB: defines the number of SSBs mapped to each PRACH occasion for 2-step RA type and the number of contention-based Random Access Preambles mapped to each SSB;
msgA-PUSCH-ResourceGroupA: defines MSGA PUSCH resources that the UE shall use when performing MSGA transmission using Random Access Preambles group A;
msgA-PUSCH-ResourceGroupB: defines MSGA PUSCH resources that the UE shall use when performing MSGA transmission using Random Access Preambles group B;
msgA-PUSCH-resource-Index: identifies the index of the PUSCH resource used for MSGA in case of contention-free Random Access with 2-step RA type;
[. . . ]

When the Random Access procedure is initiated on a Serving Cell, the MAC entity shall:
1> if the carrier to use for the Random Access procedure is explicitly signalled:
   2> select the signalled carrier for performing Random Access procedure;
   2> set the PCMAX to _{PcmAx,f,,} of the signalled carrier.
1> else if the carrier to use for the Random Access procedure is not explicitly signalled; and
1> if the Serving Cell for the Random Access procedure is configured with supplementary uplink as specified in TS 38.331 [5]; and
1> if the RSRP of the downlink pathloss reference is less than rsrp-ThresholdSSB-SUL:
   2> select the SUL carrier for performing Random Access procedure;
   2> set the PCMAX to P_{CMAX,f,c} of the SUL carrier.
1> else:
   2> select the NUL carrier for performing Random Access procedure;
   2> set the PCMAX to P_{CMAX,f,c} of the NUL carrier.
1> perform the BWP operation as specified in clause 5.15;
1> if the Random Access procedure is initiated by PDCCH order and if the ra-PreambleIndex explicitly provided by PDCCH is not Ob000000; or
1> if the Random Access procedure was initiated for SI request (as specified in TS 38.331 [5]) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA_TYPE to 4-stepRA.
1> else if the BWP selected for Random Access procedure is configured with both 2-step and 4-step RA type Random Access Resources and the RSRP of the downlink pathloss reference is above msgA-RSRP-Threshold; or
1> if the BWP selected for Random Access procedure is only configured with 2-step RA type Random Access resources (i.e. no 4-step RACH RA type resources configured); or
1> if the Random Access procedure was initiated for reconfiguration with sync and if the contention-free Random Access Resources for 2-step RA type have been explicitly provided in rach-ConfigDedicated for the BWP selected for Random Access procedure:
   2> set the RA_TYPE to 2-stepRA.
1> else:
   2> set the RA_TYPE to 4-stepRA.
1> perform initialization of variables specific to Random Access type as specified in clause 5.1.1a;
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

The initialization procedure of 2-step RA is discussed in 3GPP TS 38.321 V16.2.1, one or more parts of which are quoted below:

5.1.2a Random Access Resource selection for 2-step RA type

If the selected RA_TYPE is set to 2-stepRA, the MAC entity shall:
[. . . ]
1> else (i.e. for the contention-based Random Access Preamble selection):
   2> if at least one of the SSBs with SS-RSRP above msgA-RSRP-ThresholdSSB is available:
      3> select an SSB with SS-RSRP above msgA-RSRP-ThresholdSSB.
   2> else:
      3> select any SSB.
   2> if contention-free Random Access Resources for 2-step RA type have not been configured and if Random Access Preambles group has not yet been selected during the current Random Access procedure:
      3> if Random Access Preambles group B for 2-step RA type is configured:
         4> if the potential MSGA payload size (UL data available for transmission plus MAC subheader and, where required, MAC CEs) is greater than the ra-MsgA-SizeGroupA and the pathloss is less than PCMAX (of the Serving Cell performing the Random Access Procedure)—msgA-PreambleReceivedTargetPower—msgA-DeltaPreamble—msgA-messagePowerOffsetGroupB; or
         4> if the Random Access procedure was initiated for the CCCH logical channel and the CCCH SDU size plus MAC subheader is greater than ra-MsgA-SizeGroupA:
         5> select the Random Access Preambles group B.
         4> else:
         5> select the Random Access Preambles group A.
      3> else:
         4> select the Random Access Preambles group A.
   2> else if contention-free Random Access Resources for 2-step RA type have been configured and if Random Access Preambles group has not yet been selected during the current Random Access procedure:
      3> if Random Access Preambles group B for 2-step RA type is configured; and
      3> if the transport block size of the MSGA payload configured in the rach-ConfigDedicated corresponds to the transport block size of the MSGA payload associated with Random Access Preambles group B:
         4> select the Random Access Preambles group B.
      3> else:
         4> select the Random Access Preambles group A.
   2> else (i.e. Random Access preambles group has been selected during the current Random Access procedure):
      3> select the same group of Random Access Preambles as was used for the Random Access Preamble transmission attempt corresponding to the earlier transmission of MSGA.
   2> select a Random Access Preamble randomly with equal probability from the 2-step RA type Random Access Preambles associated with the selected SSB and the selected Random Access Preambles group;
   2> set the PREAMBLE_INDEX to the selected Random Access Preamble;
1> determine the next available PRACH occasion from the PRACH occasions corresponding to the selected SSB permitted by the restrictions given by the msgA-SSB-SharedRO-Masklndex if configured and ra-ssb-OccasionMasklndex if configured (the MAC entity shall select a PRACH occasion randomly with equal probability among the consecutive PRACH occasions allocated for 2-step RA type according to clause 8.1 of TS 38.213 [6], corresponding to the selected SSB; the MAC entity may take into account the possible occurrence of measurement gaps when determining the next available PRACH occasion corresponding to the selected SSB);
1> if the Random Access Preamble was not selected by the MAC entity among the contention-based Random Access Preamble(s):
   2> select a PUSCH occasion from the PUSCH occasions configured in msgA-CFRA-PUSCH corresponding to the PRACH slot of the selected PRACH occasion, according to msgA-PUSCH-resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion according to clause 8.1A of TS 38.213 [6];
   2> determine the UL grant for the MSGA payload according to the PUSCH configuration associated with the selected Random Access Preambles group and determine the associated HARQ information;
   2> if the selected preamble and PRACH occasion is mapped to a valid PUSCH occasion as specified in clause 8.1A of TS 38.213 [6]:
      3> deliver the UL grant and the associated HARQ information to the HARQ entity.
1> perform the MSGA transmission procedure (see clause 5.1.3a).

The Bandwidth Part (BWP) operation of random access (RA) is discussed in 3GPP TS 38.321 V16.2.1, one or more parts of which are quoted below:

5.15 Bandwidth Part (BWP) Operation

5.15.1 Downlink and Uplink

In addition to clause 12 of TS 38.213 [6], this clause specifies requirements on BWP operation.

A Serving Cell may be configured with one or multiple BWPs, and the maximum number of BWP per Serving Cell is specified in TS 38.213 [6].

The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the MAC entity itself upon initiation of Random Access procedure or upon detection of consistent LBT failure on SpCell. Upon RRC (re-) configuration of firstActiveDownlinkBWP-Id and/or firstActive UplinkBWP-Id for SpCell or activation of an SCell, the DL BWP and/or UL BWP indicated by firstActiveDownlinkBWP-Id and/or firstActiveUplinkBWP-Id respectively (as specified in TS 38.331 [5]) is active without receiving PDCCH indicating a downlink assignment or an uplink grant. The active BWP for a Serving Cell is indicated by either RRC or PDCCH (as specified in TS 38.213 [6]). For unpaired spectrum, a DL BWP is paired with a UL BWP, and BWP switching is common for both UL and DL.

[. . .]

For each activated Serving Cell configured with a BWP, the MAC entity shall:
1> if a BWP is activated and the active DL BWP for the Serving Cell is not the dormant BWP:
   2> transmit on UL-SCH on the BWP;
   2> transmit on RACH on the BWP, if PRACH occasions are configured;
   2> monitor the PDCCH on the BWP;
   2> transmit PUCCH on the BWP, if configured;
   2> report CSI for the BWP;
   2> transmit SRS on the BWP, if configured;
   2> receive DL-SCH on the BWP;
   2> (re-)initialize any suspended configured uplink grants of configured grant Type 1 on the active BWP according to the stored configuration, if any, and to start in the symbol according to rules in clause 5.8.2;
   [. . . ]
1> if a BWP is activated and the active DL BWP for the Serving Cell is dormant BWP:
   2> stop the bwp-InactivityTimer of this Serving Cell, if running
   2> not monitor the PDCCH on the BWP;
   2> not monitor the PDCCH for the BWP;
   2> not receive DL-SCH on the BWP;
   2> not report CSI on the BWP, report CSI except aperiodic CSI for the BWP;
   2> not transmit SRS on the BWP;
   2> not transmit on UL-SCH on the BWP;
   2> not transmit on RACH on the BWP;
   2> not transmit PUCCH on the BWP.
   2> clear any configured downlink assignment and any configured uplink grant Type 2 associated with the SCell respectively;
   2> suspend any configured uplink grant Type 1 associated with the SCell;
   2> if configured, perform beam failure detection and beam failure recovery for the SCell if beam failure is detected.
1> if a BWP is deactivated:
   2> not transmit on UL-SCH on the BWP;
   2> not transmit on RACH on the BWP;
   2> not monitor the PDCCH on the BWP;
   2> not transmit PUCCH on the BWP;
   2> not report CSI for the BWP;
   2> not transmit SRS on the BWP;
   2> not receive DL-SCH on the BWP;
   2> clear any configured downlink assignment and configured uplink grant of configured grant Type 2 on the BWP;
   2> suspend any configured uplink grant of configured grant Type 1 on the inactive BWP.

Upon initiation of the Random Access procedure on a Serving Cell, after the selection of carrier for performing Random Access procedure as specified in clause 5.1.1, the MAC entity shall for the selected carrier of this Serving Cell:
1> if PRACH occasions are not configured for the active UL BWP:
   2> switch the active UL BWP to BWP indicated by initialUplinkBWP;
   2> if the Serving Cell is an SpCell:
      3> switch the active DL BWP to BWP indicated by initialDownlinkBWP.
1> else:
   2> if the Serving Cell is an SpCell:
      3> if the active DL BWP does not have the same bwp-Id as the active UL BWP:
         4> switch the active DL BWP to the DL BWP with the same bwp-Id as the active UL BWP.
1> stop the bwp-InactivityTimer associated with the active DL BWP of this Serving Cell, if running
1> if the Serving Cell is SCell:
   2> stop the bwp-InactivityTimer associated with the active DL BWP of SpCell, if running
1> perform the Random Access procedure on the active DL BWP of SpCell and active UL BWP of this Serving Cell.

If the MAC entity receives a PDCCH for BWP switching of a Serving Cell, the MAC entity shall:
1> if there is no ongoing Random Access procedure associated with this Serving Cell; or
1> if the ongoing Random Access procedure associated with this Serving Cell is successfully completed upon reception of this PDCCH addressed to C-RNTI (as specified in clauses 5.1.4, 5.1.4a, and 5.1.5):
   2> cancel, if any, triggered consistent LBT failure for this Serving Cell;
   2> perform BWP switching to a BWP indicated by the PDCCH.

If the MAC entity receives a PDCCH for BWP switching for a Serving Cell(s) or a dormancy SCell group(s) while a Random Access procedure associated with that Serving Cell is ongoing in the MAC entity, it is up to UE implementation whether to switch BWP or ignore the PDCCH for BWP switching, except for the PDCCH reception for BWP switching addressed to the C-RNTI for successful Random Access procedure completion (as specified in clauses 5.1.4, 5.1.4a, and 5.1.5) in which case the UE shall perform BWP switching to a BWP indicated by the PDCCH. Upon reception of the PDCCH for BWP switching other than successful contention resolution, if the MAC entity decides to perform BWP switching, the MAC entity shall stop the ongoing Random Access procedure and initiate a Random Access procedure after performing the BWP switching; if the MAC decides to ignore the PDCCH for BWP switching, the MAC entity shall continue with the ongoing Random Access procedure on the Serving Cell.

The 2-step RA configuration on a BWP is discussed in 3GPP TS 38.331 V16.2.0, one or more parts of which are quoted below:

BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

BWP-UplinkCommon information element

| BWP-UplinkCommon ::= | SEQUENCE { |
|---|---|
| genericParameters | BWP, |
| rach-ConfigCommon | SetupRelease { RACH- |
| ConfigCommon } | OPTIONAL, -- |
| Need M | |
| pusch-ConfigCommon | SetupRelease { PUSCH- |
| ConfigCommon } | OPTIONAL, -- Need |
| M | |
| pucch-ConfigCommon | SetupRelease { PUCCH- |
| ConfigCommon } | OPTIONAL, -- Need |
| M | |
| [...] | |
| msgA-ConfigCommon-r16 | SetupRelease { MsgA- |
| ConfigCommon-r16 } | OPTTONAL -- |

Cond SpCellOnly2
}

BWP-UplinkCommon field descriptions
msgA-ConfigCommon
Configuration of the cell specific PRACH and PUSCH resource parameters for transmission of
MsgA in 2-step random access type procedure. The NW can configure msgA-ConfigCommon only
for UL BWPs if the linked DL BWPs (same bwp-Id as UL-BWP) are the initial DL BWPs or DL
BWPs containing the SSB associated to the initial BL BWP
pucch-ConfigCommon
Cell specific parameters for the PUCCH of this BWP.
pusch-ConfigCommon
Cell specific parameters for the PUSCH of this BWP.
rach-ConfigCommon
Configuration of cell specific random access parameters which the UE uses for contention based
and contention free random access as well as for contention based beam failure recovery in this
BWP. The NW configures SSB-based RA (and hence RACH-ConfigCommon)
only for UL BWPs if
the linked DL BWPs (same bwp-Id as UL-BWP) are the initial DL BWPs or DL BWPs containing
the SSB associated to the initial DL BWP. The network configures rach-ConfigCommon, whenever
it configures contention free random access (for reconfiguration with sync or for beam failure
recovery).
[ . . . ]

| Conditional Presence | Explanation |
|---|---|
| SpCellOnly2 | The field is optionally present, Need M, in the |
| | BWP-UplinkCommon of an SpCell. |
| | It is absent otherwise. |

[. . . ]

MsgA-ConfigCommon

The IE MsgA-ConfigCommon is used to configure the PRACH and PUSCH resource for transmission of MsgA in 2-step random access type procedure.

| | |
|---|---|
| MsgA-ConfigCommon-r16 ::= | SEQUENCE { |
| rach-ConfigCommonTwoStepRA-r16 | RACH-ConfigCommonTwoStepRA- |

r16,

| | |
|---|---|
| msgA-PUSCH-Config-r16 | MsgA-PUSCH-Config-r16 |

OPTIONAL --Cond InitialBWPConfig
}

MsgA-ConfigCommon field descriptions
msgA-PUSCH-Config
Configuration of cell-specific MsgA PUSCH parameters which the UE uses for contention-based
MsgA PUSCH transmission of this BWP. If the field is not configured for the selected UL BWP, the
UE shall use the MsgA PUSCH configuration of initial UL BWP.
rach-ConfigCommonTwoStepRA
Configuration of cell specific random access parameters which the UE uses for contention based
and contention free 2-step random access type procedure as well as for 2-step RA type contention
based beam failure recovery in this BWP.

| Conditional Presence | Explanation |
|---|---|
| InitialBWPConfig | The field is mandatory present when MsgA-ConfigCommon is |
| | configured for the initial uplink BWP, or when MsgA-ConfigCommon |
| | is configured for a non-initial uplink BWP and MsgA-ConfigCommon |
| | is not configured for the initial uplink BWP, otherwise the field is |
| | Need S. |

Non-terrestrial networks (NTNs) are to be introduced in NR to use an airborne/spaceborne vehicle as a platform for providing mobile services (such as discussed in RP-201256). A UE may link to a network (NW) (e.g., an NTN) through different platforms comprising low earth orbiting (LEO) satellite, medium earth orbiting (MEO) satellite, highly elliptical orbiting (HEO) satellite, geostationary earth orbiting (GEO) satellite, and/or high altitude platform station (HAPS) (such as discussed in 3GPP TR 38.821 V16.0.0). The NTN may offer a wide-area coverage and provide NW access in a scenario where coverage from terrestrial networks (TNs) is unfeasible for a UE (e.g., when the UE is located in a desert, a polar area, and/or on an airplane). Due to a distance (e.g., a large distance) from a UE to one or more platforms of the NTN, a transmission between the UE and a NW in NTN has a longer round trip time (RTT) than the transmission between the UE and a NW in TN. To transmit data in NTN, it may be beneficial (and/or needed) to reduce propagation delay and/or exchanges between a UE and a NW.

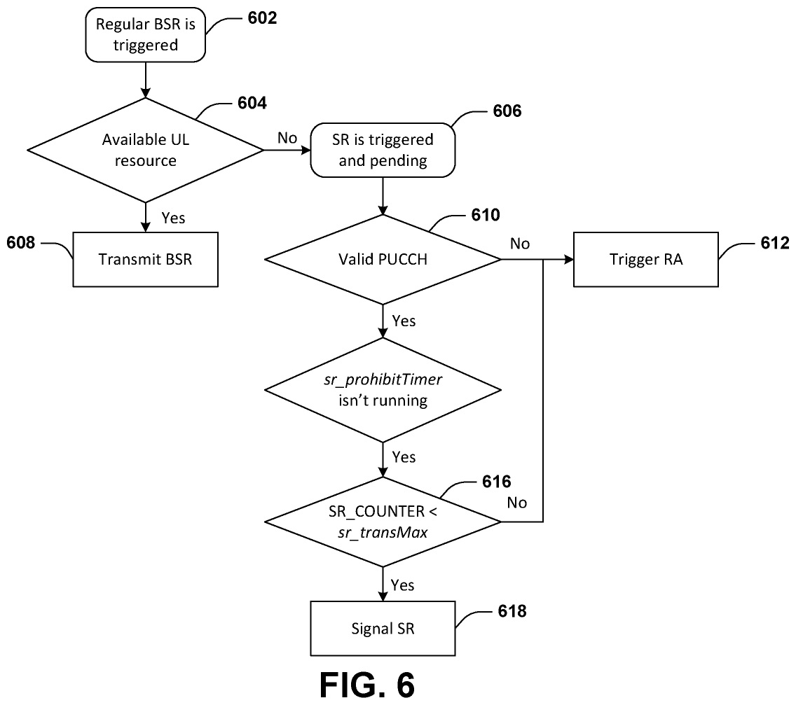

FIG. 6 illustrates a procedure of Buffer Status Report (BSR) and Scheduling Request (SR) in NR. A UE may trigger 602 a BSR (e.g., a Regular BSR). The UE may trigger 602 the BSR when data arrives (e.g., the UE may trigger 602 the BSR in response to uplink (UL) data arrival). At 604 , it may be determined whether or not one or more UL resources (e.g., dynamic UL grant and/or configured UL grant) for transmitting the BSR are available. If there are one or more UL resources for transmitting the BSR, the UE may transmit 608 the BSR. If there are no UL resources (e.g., no available UL resources) for transmitting the BSR, the UE may trigger 606 a SR. The SR may be considered to be pending when (and/or after) the SR is triggered. At 610, it may be determined whether or not the UE has one or more Physical Uplink Control Channel (PUCCH) resources (e.g., one or more valid PUCCH resources). If the UE has one or more PUCCH resources (e.g., one or more valid PUCCH resources) for a pending SR, the UE may check 616 a number of SR transmissions (e.g., SR_COUNTER) when a prohibit timer (e.g., sr-ProhibitTimer) is not running (e.g., if the prohibit timer is running, the UE may wait until the prohibit timer is not running to check 616 the number of SR transmissions). In some examples, checking 616 the number of SR transmissions (e.g., SR_COUNTER) may comprise comparing the number of SR transmissions (e.g., SR_COUNTER) with a transmission threshold (e.g., sr-TransMax). In some examples, if the number of SR transmissions (e.g., SR_COUNTER) is less than the transmission threshold (e.g., sr-TransMax), the UE signals SR 618. In some examples, if the UE does not have one or more PUCCH resources (e.g., one or more valid PUCCH resources) for a pending SR (e.g., determined at 610) and/or the number of SR transmissions (e.g., SR_COUNTER) is not less than the transmission threshold (e.g., sr-TransMax), the UE may trigger 612 (e.g., initiate) a random access (RA) procedure and may cancel one or more pending SRs (e.g., all pending SRs).

In some examples, in a procedure (e.g., a typical procedure), the NW may provide the UE with a UL grant, for transmitting a BSR (e.g., a Regular BSR), after receiving a SR from the UE (e.g., the NW may transmit the UL grant, for transmitting the BSR, to the UE after the NW receives the SR from the UE). The NW may provide the UE with a UL grant for transmitting UL data after receiving the BSR from the UE (e.g., the NW may transmit the UL grant, for transmitting the UL data, after the NW receives the BSR from the UE). The UE may be required to signal SR (e.g., transmit the SR to the NW), transmit BSR (e.g., transmit the BSR to the NW after signaling the SR) and transmit UL data (e.g., transmit the UL data to the NW after transmitting the BSR). Accordingly, the overall procedure (for the UE to transmit SR, BSR and/or UL data) may take at least 2 RTT from data arrival (e.g., UL data arrival at the UE) to data transmission (e.g., transmission of the UL data to the NW) after receiving a UL grant (e.g., an appropriate UL grant) from the NW. Due to the large propagation delay in NTN, UL scheduling may require some enhancements to reduce latency, and one or more possible solutions are present in 3GPP TR 38.821 V16.0.0. BSR over 2-step RA is a possible solution with low latency and overhead, and the solution is agreed to be further studied in 3GPP RAN2 #111 (such as discussed in R2-2008701).

In some systems (e.g., systems according to current specification), the RA procedure may be initiated when one or more events occur, wherein the one or more events may comprise Radio Resource Control (RRC) state transition, RRC Connection re-establishment, time alignment requirement, SR failure (e.g., SR failure may occur when there are no PUCCH resources, and/or if SR is transmitted more than a threshold number of times), handover, System Information (SI) request, beam failure recovery (BFR), and/or Listen Before Talk (LBT) failure (such as discussed in 3GPP TS 38.331 V16.2.0). In some examples, when a RA procedure is initiated, the UE may select an RA type of the RA procedure (e.g., 2-step RA and/or 4-step RA) based on an RA configuration and/or a radio condition (such as discussed in 3GPP TS 38.321 V16.2.1). For example, the UE may initiate a 2-step RA procedure or a 4-step RA procedure based on the RA configuration and/or the radio condition. If contention-free random access (CFRA) resources are provided by the NW (e.g.., if the UE is provided with the CFRA resources from the NW), the UE may select the RA type (e.g., the RA type of the RA procedure) related to the Contention Free (CF) resources (e.g., the CFRA resources). For contention-based random access (CBRA), the UE may select 2-step RA if a Bandwidth Part (BWP) is configured with (e.g., only configured with) 2-step RA and/or a Reference Signal Received Power (RSRP) of a downlink pathloss reference is higher than an RSRP threshold (e.g., msgA-RSRP-Threshold). For example, the UE may initiate a 2-step RA procedure if the RSRP of the downlink pathloss reference is higher than the RSRP threshold (e.g., msgA-RSRP-Threshold). Alternatively and/or additionally, the UE may initiate a 4-step RA procedure if the RSRP of the downlink pathloss reference is not higher than the RSRP threshold (e.g., msgA-RSRP-Threshold).

In a 2-step RA procedure, the UE may transmit Message A (MSGA) comprising UL data on Physical Uplink Shared Channel (PUSCH) (e.g., the UL data on PUSCH may correspond to a PUSCH payload) and a RA preamble on Physical Random Access Channel (PRACH) (e.g., a PRACH occasion associated with transmitting the RA preamble on PRACH may be associated with the PUSCH payload). After the NW receives (e.g., successfully receives) the MSGA (e.g., after the network receives the RA preamble and the associated PUSCH payload) from the UE, the network may obtain (e.g., get) a BSR (e.g., a Regular BSR) in the PUSCH payload (e.g., the network may obtain the BSR in the PUSCH payload if the BSR is included in the PUSCH payload). For example, the UE may transmit the BSR to the network without performing one or more operations prior to transmitting the BSR (e.g., the one or more operations may comprise transmitting a SR and receiving a UL grant in response to the SR), thereby reducing a UL scheduling delay. In some examples, transmitting the BSR over 2-step RA may take merely 1 RTT (or more than 1 RTT) from data arrival (e.g., UL data arrival at the UE) to data transmission (e.g., transmission of the UL data to the NW).

In some examples, throughout the present disclosure, such as throughout description of Concept 1, one, some and/or all instances of “BSR” may refer to “Regular BSR” unless otherwise specified. In some examples, a Regular BSR is not a Periodic BSR. In some examples, a Regular BSR is not a Padding BSR. In some examples, a UE may trigger a Regular BSR based on one or more of the conditions specified in clause 5.4.5 of 3GPP TS 38.321 V16.2.1. In some examples, a UE may trigger a Regular BSR when a UL data, for a logical channel with a priority higher than one or more priorities of one or more other logical channels containing available UL data, becomes available (e.g., the UE may trigger the Regular BSR in response to the UL data becoming available for the logical channel that has a priority higher than the one or more priorities of the one or more other logical channels containing available UL data, wherein the one or more priorities may comprise all priorities of all other logical channels, of the UE, that contain available UL data). In some examples, a UE may trigger a Regular BSR when an UL data becomes available and no logical channel of a plurality of logical channels contains any available UL data (e.g., the UE may trigger the Regular BSR in response to the UL data becoming available if no logical channel of the plurality of logical channels contains any available UL data, wherein the plurality of logical channels may comprise all logical channels of the UE other than a logical channel for which the UL data becomes available). In some examples, a UE may trigger a SR, in response to triggering a Regular BSR, based on one or more of the conditions specified in clause 5.4.5 of 3GPP TS 38.321 V16.2.1. In some examples, a UE may trigger a SR, in response to triggering a Regular BSR, when there is no UL resource available for a new transmission (e.g., for the Regular BSR).

Concept 1

In order to reduce an overall UL scheduling delay due to a large RTT (and/or large propagation delay) in NTN, a UE connected to an NTN cell may determine to initiate (e.g., directly initiate) a 2-step RA procedure for transmitting a BSR even if (and/or regardless of whether or not) there is a valid PUCCH resource for SR transmission after the BSR is triggered. In some examples, in this case, the 2-step RA may be initiated in response to the triggered BSR and may not be in response to a triggered SR. In some examples, in this case, the UE may not trigger a SR if the UE determines to initiate (e.g., directly initiate) 2-step RA for transmitting the BSR.

However, if a BSR (e.g., triggering a BSR) may trigger a 2-step RA without any restriction, the mechanism as described above (e.g., transmitting BSR via the 2-step RA) may result in higher collision probability in 2-step RA procedure since more UEs may be performing 2-step RA at the same time in an NTN cell. The higher collision probability may result in a lower success probability of the 2-step RA procedure, and/or may weaken the effectiveness of the mechanism. Accordingly, the UE should not unrestrictedly use 2-step RA for transmitting BSR (e.g., directly transmitting BSR), such as with or without triggering SR.

To solve one or more of the aforementioned issues (e.g., to avoid higher collision probability in 2-step RA due to directly initiating 2-step RA for transmitting BSR), the UE may perform a check of one or more conditions before (and/or upon) initiating 2-step RA for transmitting the BSR. In some examples, the UE may perform a check in response to triggering the BSR. The UE may determine whether or not to initiate (e.g., directly initiate) 2-step RA for transmitting the BSR based on a result of the check. Alternatively and/or additionally, the UE may determine whether or not the UE is allowed to initiate (e.g., directly initiate) 2-step RA for transmitting the BSR based on the result of the check.

Alternatively and/or additionally, the UE may perform the check (and/or a second check of one or more one or more conditions) to determine whether to initiate a 2-step RA or to initiate a 4-step RA for transmitting the BSR.

In some examples, if the UE determines that the check is passed (e.g., one or more conditions of the check are met), the UE may initiate (e.g., directly initiate) a 2-step RA procedure for transmitting the BSR. Alternatively and/or additionally, if the UE determines that the check is passed (e.g., one or more conditions of the check are met), the UE may be allowed to initiate (e.g., directly initiate) a 2-step RA for transmitting the BSR.

Alternatively and/or additionally, if the UE determines that the check is failed (e.g., one or more conditions of the check are not met), the UE may not initiate (e.g., directly initiate) a 2-step RA procedure for transmitting the BSR. Alternatively and/or additionally, if the UE determines that the check is failed (e.g., one or more conditions of the check are not met), the UE may not be allowed to initiate (e.g., directly initiate) a 2-step RA procedure for transmitting the BSR.

In some examples, the UE may determine, based on the result of the check, whether or not a BSR (e.g., triggering the BSR) triggers (e.g., directly triggers) a 2-step RA procedure. For example, if the check is passed (e.g., one or more conditions of the check are met), the BSR (e.g., triggering the BSR) may trigger (e.g., directly trigger) a 2-step RA procedure (and/or the UE may be allowed to trigger (e.g., directly trigger) the 2-step RA procedure in response to triggering the BSR). Alternatively and/or additionally, if the check is failed (e.g., one or more conditions of the check are not met), the BSR (e.g., triggering the BSR) may not trigger (e.g., directly trigger) a 2-step RA procedure (and/or the UE may not be allowed to trigger (e.g., directly trigger) the 2-step RA procedure in response to triggering the BSR).

In some examples, the BSR triggering (e.g., directly triggering) a 2-step RA procedure may mean that the 2-step RA procedure is triggered (e.g., directly triggered) by the BSR (instead of the 2-step RA procedure being triggered by a SR that is triggered by the BSR).

In an example scenario, the UE may initiate a RA procedure for establishing an RRC connection (e.g., for transmission of a RRCSetupRequest message) when the UE is in RRC IDLE state.

The check may be based on one or more of Embodiments 1-6 provided below.

### Embodiment 1

In Embodiment 1, the check may be based on an RRC state of the UE (e.g., an RRC state of the UE when the BSR is triggered).

The UE may determine whether or not to initiate (and/or whether or not the UE is allowed to initiate) a 2-step RA procedure for transmitting the BSR based on the RRC state of the UE (e.g., the RRC state of the UE when the BSR is triggered).

In some examples, the UE may determine whether or not to initiate (and/or whether or not the UE is allowed to initiate) a 2-step RA procedure for transmitting the BSR if the UE is in a first state. In an example, the UE may not determine (and/or may not be allowed to determine) whether or not to initiate a 2-step RA procedure for transmitting BSR if the UE is not in the first state.

In some examples, the UE may determine whether or not to initiate (and/or whether or not the UE is allowed to initiate) a 2-step RA procedure for transmitting the BSR if the UE is not in a second state. In an example, the UE may not determine (and/or may not be allowed to determine) whether or not to initiate a 2-step RA procedure for transmitting BSR if the UE is in the second state.

In an example, a first condition of the check may be that the UE is in the first state (when the BSR is triggered, for example). For example, the first condition may be met if the UE is in the first state (when the BSR is triggered, for example). The first condition may not be met if the UE is not in the first state (when the BSR is triggered, for example). In an example, the UE performing the check may comprise determining whether or not the first condition is met. The UE may determine to initiate (and/or may determine that the UE is allowed to initiate) a 2-step RA procedure for transmitting the BSR based on the first condition being met. The UE may determine not to initiate (and/or may determine that the UE is not allowed to initiate) a 2-step RA procedure for transmitting the BSR based on the first condition not being met. Alternatively and/or additionally, in an example, the UE may determine whether or not to initiate (and/or whether or not the UE is allowed to initiate) a 2-step RA procedure for transmitting the BSR based on the first condition being met. Alternatively and/or additionally, the UE may not determine (and/or may not be allowed to determine) whether or not to initiate a 2-step RA procedure for transmitting BSR based on the first condition not being met.

In an example, a second condition of the check may be that the UE is not in the second state (when the BSR is triggered, for example). For example, the second condition may be met if the UE is not in the second state (when the BSR is triggered, for example). The second condition may not be met if the UE is in the second state (when the BSR is triggered, for example). In an example, the UE performing the check may comprise determining whether or not the second condition is met. The UE may determine to initiate (and/or may determine that the UE is allowed to initiate) a 2-step RA procedure for transmitting the BSR based on the second condition being met. The UE may determine not to initiate (and/or may determine that the UE is not allowed to initiate) a 2-step RA procedure for transmitting the BSR based on the second condition not being met. Alternatively and/or additionally, in an example, the UE may determine whether or not to initiate (and/or whether or not the UE is allowed to initiate) a 2-step RA procedure for transmitting the BSR based on the second condition being met. Alternatively and/or additionally, the UE may not determine (and/or may not be allowed to determine) whether or not to initiate a 2-step RA procedure for transmitting BSR based on the second condition not being met.

The check according to Embodiment 1 (e.g., the check comprising determining whether or not the first condition and/or the second condition are met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the first condition and/or the second condition being met. It may be determined that the BSR does not trigger (e.g., directly trigger) a 2-step RA procedure for transmitting the BSR based on the first condition and/or the second condition not being met.

The first state may be a first RRC state. The first RRC state may be RRC_CONNECTED state. The first RRC state may be RRC_INACTIVE state. The first RRC state may be RRC_IDLE state.

The second state may be a second RRC state. The second RRC state may be RRC_CONNECTED state. The second RRC state may be RRC_INACTIVE state. The second RRC state may be RRC_IDLE state.

The first state (e.g., the first RRC state) may be different from the second state (e.g., the second RRC state).

In some examples, an RRC layer of the UE may indicate, to a Medium Access Control (MAC) layer of the UE, a current RRC state of the UE. For example, the MAC layer may perform the check (e.g., determine whether or not the first condition and/or the second condition are met) based on the current RRC state indicated by the RRC layer.

### Embodiment 2

In Embodiment 2, the check may be based on a logical channel that triggered the BSR.

The UE may determine whether or not to initiate (and/or whether or not the UE is allowed to initiate) a 2-step RA procedure for transmitting the BSR based on the logical channel that triggered the BSR (and/or based on other information in addition to the logical channel that triggered the BSR). The UE may determine whether to initiate a 2-step RA procedure for transmitting the BSR or to initiate a 4-step RA procedure for transmitting the BSR based on the logical channel that triggered the BSR (and/or based on other information in addition to the logical channel that triggered the BSR). The UE may determine whether the UE is allowed to initiate a 2-step RA procedure for transmitting the BSR or is allowed to initiate a 4-step RA procedure for transmitting the BSR based on the logical channel that triggered the BSR (and/or based on other information in addition to the logical channel that triggered the BSR).

In some examples, the UE initiates (and/or is allowed to initiate) a 2-step RA procedure for transmitting the BSR if the logical channel that triggered the BSR is a first logical channel. Alternatively and/or additionally, the UE may not initiate (and/or may not be allowed to initiate) a 2-step RA procedure for transmitting the BSR if the logical channel that triggered the BSR is not the first logical channel.

In some examples, the UE initiates (and/or is allowed to initiate) a 2-step RA procedure for transmitting the BSR if the logical channel that triggered the BSR is not a second logical channel. Alternatively and/or additionally, the UE may not initiate (and/or may not be allowed to initiate) a 2-step RA procedure for transmitting the BSR if the logical channel that triggered the BSR is the second logical channel.

In an example, a third condition of the check may be that the logical channel that triggered the BSR is the first logical channel. For example, the third condition may be met if the logical channel that triggered the BSR is the first logical channel. The third condition may not be met if the logical channel that triggered the BSR is not the first logical channel. In an example, the UE performing the check may comprise determining whether or not the third condition is met. The UE may determine to initiate (and/or may determine that the UE is allowed to initiate) a 2-step RA procedure for transmitting the BSR based on the third condition being met. The UE may determine not to initiate (and/or may determine that the UE is not allowed to initiate) a 2-step RA procedure for transmitting the BSR based on the third condition not being met.

In an example, a fourth condition of the check may be that the logical channel that triggered the BSR is not the second logical channel. For example, the fourth condition may be met if the logical channel that triggered the BSR is not the second logical channel. The fourth condition may not be met if the logical channel that triggered the BSR is the second logical channel. In an example, the UE performing the check may comprise determining whether or not the fourth condition is met. The UE may determine to initiate (and/or may determine that the UE is allowed to initiate) a 2-step RA procedure for transmitting the BSR based on the fourth condition being met. The UE may determine not to initiate (and/or may determine that the UE is not allowed to initiate) a 2-step RA procedure for transmitting the BSR based on the fourth condition not being met.

The check according to Embodiment 2 (e.g., the check comprising determining whether or not the third condition and/or the fourth condition are met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the third condition and/or the fourth condition being met. It may be determined that the BSR does not trigger (e.g., directly trigger) a 2-step RA procedure for transmitting the BSR based on the third condition and/or the fourth condition not being met.

The first logical channel may be Common Control Channel (CCCH). The first logical channel may be Dedicated Control Channel (DCCH). The first logical channel may be Dedicated Traffic Channel (DTCH). The first logical channel may be a logical channel (e.g., a specific logical channel) indicated by the NW (e.g., the NW may transmit an indication of the first logical channel to the UE and/or the UE may determine the first logical channel based on the indication). For example, the NW may indicate, to the UE, one or more logical channels with which the BSR may be transmitted by 2-step RA directly (in response to a logical channel of the one or more logical channels triggering the BSR, for example).

The second logical channel may be CCCH. The second logical channel may be DCCH. The second logical channel may be DTCH. The second logical channel may be a logical channel (e.g., a specific logical channel) indicated by the NW (e.g., the NW may transmit an indication of the second logical channel to the UE and/or the UE may determine the second logical channel based on the indication). For example, the NW may indicate, to the UE, one or more logical channels with which the BSR may not be transmitted by 2-step RA directly (in response to a logical channel of the one or more logical channels triggering the BSR, for example).

The first logical channel may be different from the second logical channel.

In some examples, the NW may configure and/or indicate a logical channel via a configuration of the logical channel (e.g., the NW may configure the UE with the logical channel via the configuration). In some examples, the configuration may indicate whether or not a BSR, triggered by the logical channel, may be transmitted by 2-step RA procedure. In some examples, the UE may trigger a BSR for the logical channel based on one or more of the conditions specified in clause 5.4.5 of 3GPP TS 38.321 V16.2.1. The UE may initiate (and/or may be allowed to initiate) a 2-step RA procedure for transmitting the BSR if the configuration of the logical channel that triggered the BSR indicates that the logical channel can trigger a 2-step RA procedure. The UE may not initiate (and/or may not be allowed to initiate) a 2-step RA procedure for transmitting the BSR if the configuration of the logical channel that triggered the BSR indicates that the logical channel cannot trigger a 2-step RA procedure. The UE may initiate (and/or may be allowed to initiate) a 4-step RA procedure for transmitting the BSR if the configuration of the logical channel that triggered the BSR indicates that the logical channel cannot trigger a 2-step RA procedure.

### Embodiment 3

In Embodiment 3, the check may be based on whether or not a radio bearer (e.g., a certain radio bearer) has data available for transmission (e.g., whether or not the radio bearer has data available for transmission when the BSR is triggered).

The UE may determine whether or not to initiate (and/or whether or not the UE is allowed to initiate) a 2-step RA procedure for transmitting the BSR based on whether or not a radio bearer (e.g., a certain radio bearer) has data available for transmission when the BSR is triggered.

In some examples, the UE initiates (and/or is allowed to initiate) a 2-step RA procedure for transmitting the BSR if a first radio bearer does not have data available for transmission. Alternatively and/or additionally, the UE may not initiate (and/or may not be allowed to initiate) a 2-step RA procedure for transmitting the BSR if the first radio bearer has data available for transmission.

In some examples, the UE initiates (and/or is allowed to initiate) a 2-step RA procedure for transmitting the BSR if a second radio bearer has data available for transmission. Alternatively and/or additionally, the UE may not initiate (and/or may not be allowed to initiate) a 2-step RA procedure for transmitting the BSR if the second radio bearer does not have data available for transmission.

In an example, a fifth condition of the check may be that the first radio bearer does not have data available for transmission. For example, the fifth condition may be met if the first radio bearer does not have data available for transmission. The fifth condition may not be met if the first radio bearer has data available for transmission. In an example, the UE performing the check may comprise determining whether or not the fifth condition is met. The UE may determine to initiate (and/or may determine that the UE is allowed to initiate) a 2-step RA procedure for transmitting the BSR based on the fifth condition being met. The UE may determine not to initiate (and/or may determine that the UE is not allowed to initiate) a 2-step RA procedure for transmitting the BSR based on the fifth condition not being met.

In an example, a sixth condition of the check may be that the second radio bearer has data available for transmission. For example, the sixth condition may be met if the second radio bearer has data available for transmission. The sixth condition may not be met if the second radio bearer does not have data available for transmission. In an example, the UE performing the check may comprise determining whether or not the sixth condition is met. The UE may determine to initiate (and/or may determine that the UE is allowed to initiate) a 2-step RA procedure for transmitting the BSR based on the sixth condition being met. The UE may determine not to initiate (and/or may determine that the UE is not allowed to initiate) a 2-step RA procedure for transmitting the BSR based on the sixth condition not being met.

The check according to Embodiment 3 (e.g., the check comprising determining whether or not the fifth condition and/or the sixth condition are met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the fifth condition and/or the sixth condition being met. It may be determined that the BSR does not trigger (e.g., directly trigger) a 2-step RA procedure for transmitting the BSR based on the fifth condition and/or the sixth condition not being met.

In some examples, the first radio bearer is a first Signaling Radio Bearer (SRB). The first radio bearer may be SRBO. The first radio bearer may be SRB1. The first radio bearer may be SRB2. The first radio bearer may be SRB3. Alternatively and/or additionally, the first radio bearer may be a first Data Radio Bearer (DRB) (e.g., a first user DRB). The first radio bearer may be a radio bearer (e.g., a specific radio bearer) indicated by the NW.

In some examples, the second radio bearer is a second SRB. The second radio bearer may be SRB0. The second radio bearer may be SRB1. The second radio bearer may be SRB2. The second radio bearer may be SRB3. Alternatively and/or additionally, the second radio bearer may be a second DRB (e.g., a second user DRB). The second radio bearer may be a radio bearer (e.g., a specific radio bearer) indicated by the NW.

The first radio bearer may be different from the second radio bearer.

### Embodiment 4

In Embodiment 4, the check may be based on whether or not an RRC message (e.g., a certain RRC message) is to be transmitted (e.g., when the BSR is triggered).

The UE may determine whether or not to initiate (and/or whether or not the UE is allowed to initiate) a 2-step RA procedure for transmitting the BSR based on whether or not an RRC message (e.g., a certain RRC message) is to be transmitted (e.g., is pending transmission) when the BSR is triggered.

In some examples, the UE initiates (and/or is allowed to initiate) a 2-step RA procedure for transmitting the BSR if a first RRC message is not to be transmitted (e.g., the first RRC message is not pending transmission) (when the BSR is triggered, for example). Alternatively and/or additionally, the UE may not initiate (and/or may not be allowed to initiate) a 2-step RA procedure for transmitting BSR if the first RRC message is to be transmitted (e.g., the first RRC message is pending transmission) (when the BSR is triggered, for example).

In some examples, the UE initiates (and/or is allowed to initiate and/or determines whether or not to initiate) a 2-step RA procedure for transmitting the BSR if a second RRC message is to be transmitted (e.g., the second RRC message is pending transmission) (when the BSR is triggered, for example). Alternatively and/or additionally, the UE may not initiate (and/or may not be allowed to initiate) a 2-step RA procedure for transmitting BSR if the second RRC message is not to be transmitted (e.g., the second RRC message is not pending transmission) (when the BSR is triggered, for example).

In an example, a seventh condition of the check may be that the first RRC message is not to be transmitted (when the BSR is triggered, for example). For example, the seventh condition may be met if the first RRC message is not to be transmitted (e.g., the first RRC message is not pending transmission). The seventh condition may not be met if the first RRC message is to be transmitted (e.g., the first RRC message is pending transmission). In an example, the UE performing the check may comprise determining whether or not the seventh condition is met. The UE may determine to initiate (and/or may determine that the UE is allowed to initiate) a 2-step RA procedure for transmitting the BSR based on the seventh condition being met. The UE may determine not to initiate (and/or may determine that the UE is not allowed to initiate) a 2-step RA procedure for transmitting the BSR based on the seventh condition not being met.

In an example, an eighth condition of the check may be that the second RRC message is to be transmitted (when the BSR is triggered, for example). For example, the eighth condition may be met if the second RRC message is to be transmitted (e.g., the second RRC message is pending transmission). The eighth condition may not be met if the second RRC message is not to be transmitted (e.g., the second RRC message is not pending transmission). In an example, the UE performing the check may comprise determining whether or not the eighth condition is met. The UE may determine to initiate (and/or may determine that the UE is allowed to initiate) a 2-step RA procedure for transmitting the BSR based on the eighth condition being met. The UE may determine not to initiate (and/or may determine that the UE is not allowed to initiate) a 2-step RA procedure for transmitting the BSR based on the eighth condition not being met.

The check according to Embodiment 4 (e.g., the check comprising determining whether or not the seventh condition and/or the eighth condition are met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the seventh condition and/or the eighth condition being met. It may be determined that the BSR does not trigger (e.g., directly trigger) a 2-step RA procedure for transmitting the BSR based on the seventh condition and/or the eighth condition not being met.

The first RRC message may be RRCSetupRequest message. The first RRC message may be RRCResurneRequest message. The first RRC message may be RRCReestablishrnentRequest message. The first RRC message may be RRCReconfigurationComplete mes sage.

The second RRC message may be RRCSetupRequest message. The second RRC message may be RRCResurneRequest message. The second RRC message may be RRCReestablishrnentRequest message. The second RRC message may be RRCReconfigurationComplete mes sage.

The first RRC message may be different from the second RRC message.

### Embodiment 5

In Embodiment 5, the check may be based on whether or not the UE has one or more valid PUCCH resources for SR.

In some examples, a valid PUCCH resource for SR may be a PUCCH resource on a BWP that is active (e.g., a PUCCH resource on an active BWP of the UE). In some examples, an invalid PUCCH for SR may be a PUCCH resource on a BWP that is not active (e.g., a PUCCH resource on an inactive BWP of the UE).

The UE may determine whether or not to initiate (and/or whether or not the UE is allowed to initiate) a 2-step RA procedure for transmitting the BSR based on whether or not the UE has one or more valid PUCCH resources for SR.

In some examples, the UE initiates (and/or is allowed to initiate) a 2-step RA procedure for transmitting the BSR if the UE has one or more valid PUCCH resources for SR. Alternatively and/or additionally, the UE may not initiate (and/or may not be allowed to initiate) a 2-step RA procedure for transmitting BSR if the UE does not have one or more valid PUCCH resources for SR.

In an example, a ninth condition of the check may be that the UE has one or more valid PUCCH resources for SR. For example, the ninth condition may be met if the UE has one or more valid PUCCH resources for SR. The ninth condition may not be met if the UE does not have one or more valid PUCCH resources for SR. In an example, the UE performing the check may comprise determining whether or not the ninth condition is met. The UE may determine to initiate (and/or may determine that the UE is allowed to initiate) a 2-step RA procedure for transmitting the BSR based on the ninth condition being met. The UE may determine not to initiate (and/or may determine that the UE is not allowed to initiate) a 2-step RA procedure for transmitting the BSR based on the ninth condition not being met.

The check according to Embodiment 5 (e.g., the check comprising determining whether or not the ninth condition is met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the ninth condition being met. It may be determined that the BSR does not trigger (e.g., directly trigger) a 2-step RA procedure for transmitting the BSR based on the ninth condition not being met.

In some examples, one or more valid PUCCH resources for SR (e.g., SR that is triggered by a BSR and/or that is to be triggered by the BSR) are one or more PUCCH resources comprised in an SR configuration corresponding to a logical channel that triggered the BSR. For example, if the UE triggers a BSR based on data from a first logical channel becoming available for transmission and the first logical channel corresponds to a first SR configuration, the UE may consider that the UE has one or more valid PUCCH resources for SR (e.g., SR that is triggered by the BSR). In other words, the UE may have one or more valid PUCCH resources for a first SR (triggered by a first BSR, for example), wherein the UE may not have one or more valid PUCCH resources for a second SR (triggered by a second BSR, for example). The UE may have one or more valid PUCCH resources for the first SR based on the first SR configuration associated with the first SR comprising the one or more valid PUCCH resources. The UE may not have one or more valid PUCCH resources for the second SR based on a second SR configuration associated with the second SR (e.g., the second SR configuration may correspond to a second logical channel that triggers the second BSR) not comprising one or more valid PUCCH resources (and/or the UE may not have one or more valid PUCCH resources for the second SR based on the second SR configuration associated with the second SR not being available).

In some examples, in response to triggering a BSR (e.g., upon triggering the BSR), if the UE does not have one or more valid PUCCH resources comprised in a SR configuration corresponding to a logical channel that triggered the BSR (e.g., the NW does not configure the SR configuration to the logical channel that triggered the BSR), the UE may determine whether or not to initiate a 2-step RA procedure for transmitting the BSR without triggering a SR (rather than triggering the SR and then canceling the triggered SR, for example).

### Embodiment 6

In Embodiment 6, the check may be based on whether or not an RRC procedure (e.g., a certain RRC procedure) is ongoing (e.g., when the BSR is triggered).

The UE may determine whether or not to initiate (and/or whether or not the UE is allowed to initiate) a 2-step RA procedure for transmitting the BSR based on whether or not an RRC procedure (e.g., a certain RRC procedure) is ongoing when the BSR is triggered.

In some examples, the UE initiates (and/or is allowed to initiate) a 2-step RA procedure for transmitting the BSR if a first RRC procedure is ongoing. Alternatively and/or additionally, the UE may not initiate (and/or may not be allowed to initiate) a 2-step RA procedure for transmitting the BSR if the first RRC procedure is not ongoing.

In some examples, the UE initiates (and/or is allowed to initiate) a 2-step RA procedure for transmitting the BSR if a second RRC procedure is not ongoing. Alternatively and/or additionally, the UE may not initiate (and/or may not be allowed to initiate) a 2-step RA procedure for transmitting the BSR if the second RRC procedure is ongoing.

In an example, a tenth condition of the check may be that the first RRC procedure is ongoing (when the BSR is triggered, for example). For example, the tenth condition may be met if the first RRC procedure is ongoing. The tenth condition may not be met if the first RRC procedure is not ongoing. In an example, the UE performing the check may comprise determining whether or not the tenth condition is met. The UE may determine to initiate (and/or may determine that the UE is allowed to initiate) a 2-step RA procedure for transmitting the BSR based on the tenth condition being met. The UE may determine not to initiate (and/or may determine that the UE is not allowed to initiate) a 2-step RA procedure for transmitting the BSR based on the tenth condition not being met.

In an example, an eleventh condition of the check may be that the second RRC procedure is not ongoing. For example, the eleventh condition may be met if the second RRC procedure is not ongoing. The eleventh condition may not be met if the second RRC procedure is ongoing. In an example, the UE performing the check may comprise determining whether or not the eleventh condition is met. The UE may determine to initiate (and/or may determine that the UE is allowed to initiate) a 2-step RA procedure for transmitting the BSR based on the eleventh condition being met. The UE may determine not to initiate (and/or may determine that the UE is not allowed to initiate) a 2-step RA procedure for transmitting the BSR based on the eleventh condition not being met.

The check according to Embodiment 6 (e.g., the check comprising determining whether or not the tenth condition and/or the eleventh condition are met) may be applied to determine whether or not the BSR triggers (e.g., directly triggers) a 2-step RA procedure. In an example, it may be determined that the BSR triggers (e.g., directly triggers) a 2-step RA procedure for transmitting the BSR based on the tenth condition and/or the eleventh condition being met. It may be determined that the BSR does not trigger (e.g., directly trigger) a 2-step RA procedure for transmitting the BSR based on the tenth condition and/or the eleventh condition not being met.

The first RRC procedure may be RRC connection establishment procedure. The first RRC procedure may be RRC connection resume procedure. The first RRC procedure may be RRC connection re-establishment procedure. The first RRC procedure may be RRC reconfiguration procedure not for Handover. The first RRC procedure may be Handover procedure (e.g., reconfiguration with sync).

The second RRC procedure may be RRC connection establishment procedure. The second RRC procedure may be RRC connection resume procedure. The second RRC procedure may be RRC connection re-establishment procedure. The second RRC procedure may be RRC reconfiguration procedure not for Handover. The second RRC procedure may be Handover procedure (e.g., reconfiguration with sync).

The first RRC procedure may be different from the second RRC procedure.

In some examples, the RRC layer of the UE may indicate, to the MAC layer of the UE, whether or not an RRC procedure (e.g., the first RRC procedure and/or the second RRC procedure) is ongoing. For example, the MAC layer may perform the check (e.g., determine whether or not the tenth condition and/or the eleventh condition are met) based on whether or not the RRC procedure is ongoing (as indicated by the RRC layer, for example).

In some examples, an RRC procedure may be ongoing during a period of time between a time at which the RRC procedure starts and a time at which the RRC procedure ends (e.g., the RRC procedure may end when the RRC procedure is successfully completed or unsuccessfully completed).

In some examples, one, some and/or all of the techniques and/or conditions discussed with respect to one, some and/or all of Embodiments 1-6 may be formed and/or combined to a new embodiment. For example, the check may comprise determining whether or not one or more conditions associated with one or more of Embodiments 1-6 are met. For example, the one or more conditions may comprise the first condition, the second condition, the third condition, the fourth condition, the fifth condition, the sixth condition, the seventh condition, the eighth condition, the ninth condition, the tenth condition, the eleventh condition and/or one or more other conditions.

Scenarios 1-18 corresponding to scenarios in which a BSR may be triggered are provided below.

In Scenario 1, the UE is in RRC_CONNECTED state when the BSR is triggered.

In Scenario 2, the UE is in RRC_INACTIVE state when the BSR is triggered.

In Scenario 3, the UE is in RRC_IDLE state when the BSR is triggered.

In Scenario 4, the BSR is triggered during an RRC connection establishment procedure.

In Scenario 5, the BSR is triggered during an RRC connection resume procedure.

In Scenario 6, the BSR is triggered during an RRC connection re-establishment procedure.

In Scenario 7, the BSR is triggered during an RRC reconfiguration procedure not for Handover.

In Scenario 8, the BSR is triggered during a Handover procedure (e.g., reconfiguration with sync).

In Scenario 9, the UE has valid PUCCH resource for SR when the BSR is triggered.

In Scenario 10, the UE does not have valid PUCCH resource for SR when the BSR is triggered.

In Scenario 11, data from CCCH is available for transmission (and/or becomes available for transmission) when the BSR is triggered.

In Scenario 12, data from DCCH is available for transmission (and/or becomes available for transmission) when the BSR is triggered.

In Scenario 13, data from DTCH is available for transmission (and/or becomes available for transmission) when the BSR is triggered.

In Scenario 14, data from SRB0 is available for transmission (and/or becomes available for transmission) when the BSR is triggered.

In Scenario 15, data from SRB1 is available for transmission (and/or becomes available for transmission) when the BSR is triggered.

In Scenario 16, data from SRB2 is available for transmission (and/or becomes available for transmission) when the BSR is triggered.

In Scenario 17, data from SRB3 is available for transmission (and/or becomes available for transmission) when the BSR is triggered.

In Scenario 18, data from a DRB (e.g., a user DRB) is available for transmission (and/or becomes available for transmission) when the BSR is triggered.

In some examples, in one or more of the Scenarios 1-18, the UE may determine whether or not to initiate (and/or whether or not the UE is allowed to initiate) a 2-step RA procedure for transmitting the BSR, such as transmitting the BSR to an NTN cell.

In some examples, in one or more of the Scenarios 1-18, the UE may determine whether or not the BSR triggers (e.g., directly triggers) a 2-step RA procedure.

In some examples, the check may be applicable to one or more of the Scenarios 1-18. For example, the check may be performed in one or more of the Scenarios 1-18 (e.g., the check may be performed to determine whether or not to initiate a 2-step RA procedure for transmitting the BSR).

In some examples, in one or more of the Scenarios 1-18, the UE may not initiate (and/or the UE may not be allowed to initiate) a 2-step RA procedure for transmitting the BSR, such as transmitting the BSR to an NTN cell.

In some examples, in one or more of the Scenarios 1-18, the BSR may not trigger (e.g., directly trigger) a 2-step RA procedure.

In some examples, the check may not be applicable to one or more of the Scenarios 1-18. For example, the check may not be performed in one or more of the Scenarios 1-18 (e.g., the check may not be performed to determine whether or not to initiate a 2-step RA procedure for transmitting the BSR). For example, in one or more of the Scenarios 1-18, the UE may determine not to initiate a 2-step RA procedure for transmitting the BSR (and/or the UE may determine that the UE is not allowed to initiate a 2-step RA procedure for transmitting the BSR).

“During an RRC procedure” may mean that an action and/or event occurs after the RRC procedure starts and before the RRC procedure ends. In an example with respect to Scenario 5, “the BSR is triggered during an RRC connection establishment procedure” may mean that the BSR is triggered after the RRC connection establishment procedure starts and before the RRC connection establishment procedure ends.

In some examples, the UE may determine whether or not to initiate (e.g., directly initiate) a 2-step RA procedure for transmitting BSR to an NTN cell. In some examples, the determination of whether or not to initiate (e.g., directly initiate) the 2-step RA procedure for transmitting the BSR to the NTN cell may be performed based on (and/or in response to) performing the check (e.g., the determination may be performed based on and/or in response to a determination that the check is passed). Alternatively and/or additionally, the determination of whether or not to initiate (e.g., directly initiate) the 2-step RA procedure for transmitting the BSR to the NTN cell may be performed based on (and/or in response to) a determination that one or more conditions of the check are met. Alternatively and/or additionally, the determination of whether or not to initiate (e.g., directly initiate) the 2-step RA procedure for transmitting the BSR to the NTN cell may be performed based on (and/or in response to) a determination that the UE is in a scenario of one or more first scenarios of Scenarios 1-18 and/or that the UE is not in a scenario of one or more second scenarios of Scenarios 1-18. In some examples, the determination of whether or not to initiate (e.g., directly initiate) the 2-step RA procedure for transmitting the BSR to the NTN cell may be based on first information associated with one or more of the following factors.

In some examples, probability may be considered as a factor in performing the determination of whether or not to initiate (e.g., directly initiate) the 2-step RA procedure for transmitting the BSR to the NTN cell. The first information may comprise a number (e.g., a random number, such as a pseudo-random number) and/or a threshold. The number may be compared with the threshold, wherein the determination may be performed based on whether or not the number meets the threshold.

In some examples, an NW configuration for 2-step BSR (with which the UE is configured, for example) may be considered as a factor in performing the determination of whether or not to initiate (e.g., directly initiate) the 2-step RA procedure for transmitting the BSR to the NTN cell. The first information may comprise the NW configuration. The determination may be performed based on at least one of an activation indication (e.g., an indication indicative of activating 2-step RA for transmitting BSR) in the NW configuration, an allowing indication (e.g., an indication indicative of allowing 2-step RA for transmitting BSR) in the NW configuration, an enabling indication (e.g., an indication indicative of enabling 2-step RA for transmitting BSR) in the NW configuration, a deactivation indication (e.g., an indication indicative of deactivating 2-step RA for transmitting BSR) in the NW configuration, a disallowing indication (e.g., an indication indicative of disallowing 2-step RA for transmitting BSR) in the NW configuration, a disabling indication (e.g., an indication indicative of disabling 2-step RA for transmitting BSR) in the NW configuration, etc.

In some examples, a size of a BSR Medium Access Control (MAC) Control Element (CE) (and/or a BSR type and/or a number of reported Logical Channel Groups (LCGs)) may be considered as a factor in performing the determination of whether or not to initiate (e.g., directly initiate) the 2-step RA procedure for transmitting the BSR to the NTN cell. The first information may comprise the size of the BSR MAC CE, the BSR type (of the BSR MAC CE, for example) and/or the number of reported LCGs (e.g., a number of LCGs reported in the BSR MAC CE).

In some examples, a timing offset value (e.g., a common timing offset value) may be considered as a factor in performing the determination of whether or not to initiate (e.g., directly initiate) the 2-step RA procedure for transmitting the BSR to the NTN cell. The first information may comprise the timing offset value and/or a threshold. The timing offset value may be compared with the threshold, wherein the determination may be performed based on whether or not the timing offset value meets the threshold.

In some examples, a Serving Cell (e.g., a Serving Cell of the UE) may be considered as a factor in performing the determination of whether or not to initiate (e.g., directly initiate) the 2-step RA procedure for transmitting the BSR to the NTN cell (e.g., the Serving Cell may be the same as the NTN cell). The first information may comprise an indication of the Serving Cell and/or a list of allowed cells (e.g., cells for which the UE is allowed to initiate the 2-step RA procedure for transmitting the BSR to the cells). The list of allowed cells may be analyzed based on the Serving Cell to determine whether or not the Serving Cell is included in the list of allowed cells, wherein the determination may be performed based on whether or not the Serving Cell is included in the list of allowed cells.

In some examples, a platform type (e.g., an NTN platform type, such as at least one of LEO, MEO, HEO, GEO, HAPS, etc.) may be considered as a factor in performing the determination of whether or not to initiate (e.g., directly initiate) the 2-step RA procedure for transmitting the BSR to the NTN cell (e.g., the platform type may correspond to a platform type of a platform of the NTN cell). The first information may comprise an indication of the platform type.

In some examples, one or more first RA resources configured in an active BWP (e.g., a current active BWP) and/or one or more second RA resources configured in one or more non-active BWPs may be considered as a factor in performing the determination of whether or not to initiate (e.g., directly initiate) the 2-step RA procedure for transmitting the BSR to the NTN cell. The first information may comprise an indication of the one or more first RA resources and/or the one or more second RA resources. In some examples, the determination may be performed based on whether or not the UE is performing BWP switching to a first BWP (e.g., a specific BWP).

In some examples, the determination of whether or not to initiate (e.g., directly initiate) the 2-step RA procedure for transmitting the BSR to the NTN cell may be performed based on one or more other factors other than those discussed herein (e.g., the one or more other factors may comprise at least one of an amount of UL resources for transmitting BSR, whether or not the amount of UL resources is less than a threshold amount of UL resources for transmitting BSR, whether or not a radio condition is sufficient, whether or not a quality of the radio condition meets a threshold quality, etc.). Alternatively and/or additionally, a RSRP of a downlink pathloss reference may be considered as a factor in performing the determination. In an example, the UE may initiate the 2-step RA for BSR based on the RSRP of the downlink pathloss reference being higher than a RSRP threshold (e.g., msgA-RSRP-Threshold) (and/or the UE may initiate the 2-step RA for BSR if the RSRP of the downlink pathloss reference is higher than the RSRP threshold). The 2-step RA for BSR may be initiated if one or more first factors (e.g., one or more necessary factors) are fulfilled (e.g., the 2-step RA for BSR may be initiated if all factors of the one or more first factors are fulfilled), wherein the one or more first factors may comprise one, some and/or all of the above mentioned factors and/or one or more other factors. In some examples, a factor of the one or more first factors may be considered to be fulfilled if one or more conditions associated with the factor are met. In some examples, the UE may consider (e.g., check) the one or more first factors (e.g., one, some and/or all of the above mentioned factors and/or one or more other factors) before (and/or upon) determining whether or not to initiate 2-step RA for transmitting the BSR. Alternatively and/or additionally, the UE may consider (e.g., check) the one or more first factors (e.g., one, some and/or all of the above mentioned factors and/or one or more other factors) in response to triggering the BSR.

In some examples, the UE may be in a cell of NTN. Alternatively and/or additionally, the UE may be connected to a cell of NTN.

In some examples, the UE may receive one or more first configurations associated with NTN, BSR, SR and/or RA. In some examples, the UE may receive one or more parameters, one or more configurations, one or more indications, one or more thresholds, and/or one or more lists associated with 2-step RA (for transmitting BSR, for example) in the one or more first configurations (e.g., the one or more first configurations may comprise the one or more parameters, the one or more configurations, the one or more indications, the one or more thresholds, and/or the one or more lists associated with 2-step RA, such as 2-step RA for transmitting BSR). The UE may receive one or more parameters, one or more configurations, one or more indications, one or more thresholds, and/or one or more lists associated with 2-step RA (for transmitting BSR, for example) in a RRC message, a MAC CE and/or a Downlink Control Information (DCI). The UE may receive a configuration associated with 2-step RA for one or more logical channels.

In some examples, the UE may receive one or more configurations associated with BSR and 2-step RA.

In some examples, throughout the present disclosure, such as throughout description of Concept 1, one, some and/or all instances of “UE” may refer to the UE, a MAC entity of the UE and/or a physical layer of the UE.

With respect to one or more embodiments herein, such as one or more embodiments provided with respect to Concept 1, in some examples, the UE may be a NR device. Alternatively and/or additionally, the UE may be a NR-light device (such as discussed in RP-193238). Alternatively and/or additionally, the UE may be a reduced capability device (such as discussed in RP-193238). Alternatively and/or additionally, the UE may be a mobile phone. Alternatively and/or additionally, the UE may be a wearable device. Alternatively and/or additionally, the UE may be a sensor. Alternatively and/or additionally, the UE may be a stationary device.

With respect to one or more embodiments herein, such as one or more embodiments provided with respect to Concept 1, in some examples, the NW may be a network node. Alternatively and/or additionally, the NW may be a base station. Alternatively and/or additionally, the NW may be an access point. Alternatively and/or additionally, the NW may be an eNB. Alternatively and/or additionally, the NW may be a gNB.

It may be appreciated that applying one or more of the techniques presented herein, such as one or more of the techniques provided with respect to Concept 1, may result in one or more benefits including, but not limited to, enabling a UE in an NTN cell to not unnecessarily transmit BSR by 2-step RA (e.g., directly by 2-step RA) (with or without triggering SR, for example).

Concept 2

To enable BSR over 2-step RA (e.g., to enable transmitting BSR over a 2-step RA procedure), a UE may initiate 2-step RA (for transmitting BSR, for example) when there are no UL resources (e.g., dynamic UL grant and/or configured UL grant) for transmitting BSR (e.g., the UE may initiate the 2-step RA when the UE does not have a UL resource, such as a dynamic UL grant and/or a configured UL grant, for transmitting BSR). The BSR over 2-step RA may reduce an overall transmission delay that may be due to a large RTT (and/or large propagation delay) in NTN, but the BSR over 2-step RA may require RA resources in NTN. As mentioned in R2-2009064, when the UE has a large amount of data to transmit (e.g., an amount of data exceeding a threshold), the UE may have a higher tolerance for transmission delay. If the UE always initiates 2-step RA when there are no UL resources for transmitting BSR, the NW may need to provide (and/or configure) an increased amount of PRACH resources and/or PUSCH resources to the UE for MSGA transmission (e.g., MSGA transmission of the 2-step RA). The greater need for PRACH resources and/or PUSCH resources may cause resource shortage and/or collisions between UEs (thus resulting in a higher collision probability, for example). The higher collision probability may result in lower success probability of the 2-step RA procedure, and may weaken the effectiveness of the mechanism (e.g., transmitting BSR via the 2-step RA). If a collision happens during an RA procedure, the UE may retransmit a MSGA. The BSR may be transmitted in MSGA with an additional RTT (and/or at least an additional RTT). Alternatively and/or additionally, if there is no PUSCH resource (e.g., valid PUSCH resource) associated with a selected PRACH resource (e.g., if a PUSCH resource related to the selected PRACH resource is not available for the UE), the UE may transmit a RA preamble without a PUSCH payload in MSGA (e.g., the UE may not include the BSR in the MSGA due to the MSGA not comprising the PUSCH payload), and then may receive a fallbackRAR in Message B (MSGB) (e.g., MSGB of the RA procedure) from the NW. The BSR may be transmitted in Message 3 (Msg3) (e.g., Msg3 of the RA procedure) with an additional RTT. For example, one or more fallback actions (e.g., transmission of the fallbackRAR and/or transmission of Msg3) may be performed to fallback from 2-step RA to 4-step RA. The one or more fallback actions may increase transmission delay. To provide a balance between latency and RACH resource shortage, there may be one or more limitations for the usage of BSR over 2-step RA in NTN. When there are no UL resources for transmitting BSR, the UE may need to decide whether or not to initiate 2-step RA (for transmitting BSR, for example).

To solve one or more of the aforementioned issues (e.g., higher collision probability in 2-step RA, RACH resource shortage and/or higher latency for transmitting BSR), a UE may determine whether or not to initiate (and/or whether or not the UE is allowed to initiate) a 2-step RA procedure (for transmitting BSR, for example) by considering one or more factors, such as one or more of the factors discussed below (e.g., one or more of the factors discussed with respect to Concept 2). For example, if a factor is fulfilled (e.g., if a condition associated with the factor is met), the UE may initiate (and/or may be allowed to initiate) a 2-step RA procedure (for transmitting BSR, for example). Alternatively and/or additionally, if the factor is not fulfilled (e.g., if the condition associated with the factor is not met), the UE may not (and/or may not be allowed to) initiate a 2-step RA procedure (for transmitting BSR, for example). Alternatively and/or additionally, if a factor is fulfilled (e.g., if a condition associated with the factor is met), the BSR may trigger (e.g., directly trigger) a 2-step RA procedure (and/or the UE may be allowed to trigger the 2-step RA procedure in response to the BSR, such as directly in response to the BSR). Alternatively and/or additionally, if the factor is not fulfilled (e.g., if the condition associated with the factor is not met), the BSR may not trigger (e.g., directly trigger) a 2-step RA procedure (and/or the UE may not be allowed to trigger the 2-step RA procedure in response to the BSR, such as directly in response to the BSR).

In some examples, the BSR triggering (e.g., directly triggering) a 2-step RA procedure may mean that the 2-step RA procedure is triggered (e.g., directly triggered) by the BSR (instead of the 2-step RA procedure being triggered by a SR that is triggered by the BSR).

### Embodiment 7

In Embodiment 7, to solve one or more of the aforementioned issues, a UE may determine whether or not to initiate (and/or whether or not the UE is allowed to initiate) 2-step RA (for transmitting BSR, for example) based on a probability of initiation (e.g., the UE may consider the probability of initiation as a factor in determining whether or not to initiate the 2-step RA and/or in determining whether or not the UE is allowed to initiate the 2-step RA). The probability of initiation may be determined by a NW. The UE may receive a first parameter (for deriving the probability of initiation, for example) from the NW. For example, the UE may determine the probability of initiation based on the first parameter. There may be a first probability (e.g., a first likelihood) that the UE initiates (and/or is allowed to initiate) 2-step RA (for transmitting BSR, for example) and a second probability (e.g., a second likelihood) that the UE does not initiate (and/or is not allowed to initiate) 2-step RA (for transmitting BSR, for example). The first probability and/or the second probability may depend on the probability of initiation. In an example, the UE may determine a random number (e.g., ‘rand’) within a range. The random number may be a pseudo-random number. The UE may select (e.g., draw), such as randomly select, the random number from numbers within the range (e.g., the numbers may be uniformly distributed in the range). In an example, the range may be [0, 1), wherein 0 <the random number (e.g., ‘rand’) <1. The UE may compare the random number (e.g., ‘rand’) with a value of the first parameter. The value of the first parameter may be (and/or may be based on) the probability of initiation. The value of the first parameter may be indicated by the first parameter (and/or may be determined based on the first parameter). If the random number (e.g., ‘rand’) meets a condition associated with the value of the first parameter, the UE may initiate 2-step RA (for transmitting BSR, for example) and/or the UE may determine that the UE is allowed to initiate 2-step RA (for transmitting BSR, for example). If the random number (e.g., ‘rand’) does not meet the condition associated with the value of the first parameter, the UE may not initiate 2-step RA (for transmitting BSR, for example) and/or the UE may determine that the UE is not allowed to initiate 2-step RA (for transmitting BSR, for example).

In an example, if the random number (e.g., ‘rand’) is lower than (or not higher than) the value of the first parameter, the UE may initiate 2-step RA (for transmitting BSR, for example) and/or the UE may determine that the random number meets the condition associated with the value of the first parameter. If the random number (e.g., ‘rand’) is not lower than (or higher than) the value of the first parameter, the UE may not initiate 2-step RA (for transmitting BSR, for example) and/or the UE may determine that the random number does not meet the condition associated with the value of the first parameter.

In an example, if the random number (e.g., ‘rand’) is higher than (or not lower than) the value of the first parameter, the UE may initiate 2-step RA (for transmitting BSR, for example) and/or the UE may determine that the random number meets the condition associated with the value of the first parameter. If the random number (e.g., ‘rand’) is not higher than (or lower than) the value of the first parameter, the UE may not initiate 2-step RA (for transmitting BSR, for example) and/or the UE may determine that the random number does not meet the condition associated with the value of the first parameter.

One or more of the techniques, factors and/or conditions according to Embodiment 7 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the random number (e.g., ‘rand’), the probability of initiation and/or the first parameter.

One or more of the techniques, factors and/or conditions according to Embodiment 7 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the random number (e.g., ‘rand’), the probability of initiation and/or the first parameter.

In some examples, the first parameter may be a random parameter. The first parameter may indicate (and/or represent) a probability (e.g., a likelihood) that 2-step RA would be initiated (for transmitting BSR, for example). Alternatively and/or additionally, the first parameter may indicate (and/or represent) a probability that 2-step RA would not be initiated (for transmitting BSR, for example). The value of the first parameter may be within a second range, wherein the second range may be the same as the range comprising the random number (e.g., ‘rand’). In an example, the second range may be [0, 1), wherein 0≤the value of the first parameter <1. The first parameter may be received (and/or configured) in a first configuration (e.g., the UE may be configured with the first parameter via the first configuration). The first configuration may be a BSR configuration, an SR configuration, an RA configuration and/or an NTN configuration (e.g., the UE may be configured with the first parameter via the NTN configuration). In some examples, the UE may initiate 2-step RA (for transmitting BSR, for example) if (and/or when) the first parameter is absent in the received configuration. The UE may initiate 2-step RA (for transmitting BSR, for example) if (and/or when) the value of the first parameter is 1.

### Embodiment 8

In Embodiment 8, to solve one or more of the aforementioned issues, a UE may determine whether or not to initiate (and/or whether or not the UE is allowed to initiate) 2-step RA (for transmitting BSR, for example) based on a configuration (e.g., the UE may consider the configuration as a factor in determining whether or not to initiate the 2-step RA and/or in determining whether or not the UE is allowed to initiate the 2-step RA). In an example, the configuration may be a NW configuration (e.g., the configuration may be received from and/or configured by a NW). In some examples, if the configuration (received from the NW, for example) enables the UE (and/or indicates to the UE) to initiate 2-step RA (for transmitting BSR, for example), the UE may initiate 2-step RA (for transmitting BSR, for example). Alternatively and/or additionally, if the configuration (received from the NW, for example) disables initiating 2-step RA (for transmitting BSR, for example) for the UE (and/or if the configuration does not indicate to initiate 2-step RA for transmitting BSR and/or if the configuration indicates to the UE not to initiate 2-step RA for transmitting BSR), the UE may not initiate 2-step RA (for transmitting BSR, for example).

In an example, if the configuration has been received by the UE, the UE may initiate 2-step RA (for transmitting BSR, for example). If the configuration has not been received by the UE, the UE may not initiate 2-step RA (for transmitting BSR, for example).

In an example, if the configuration is set to true and/or is enabled, the UE may initiate 2-step RA (for transmitting BSR, for example). If the configuration is set to false and/or is disabled, the UE may not initiate 2-step RA (for transmitting BSR, for example).

In an example, if the configuration is present (e.g., if the UE is currently configured with the configuration), the UE may initiate 2-step RA (for transmitting BSR, for example). If the configuration is absent (e.g., if the UE is not currently configured with the configuration), the UE may not initiate 2-step RA (for transmitting BSR, for example).

In an example, if the configuration indicates activation, the UE may initiate 2-step RA (for transmitting BSR, for example). If the configuration indicates deactivation, the UE may not initiate 2-step RA (for transmitting BSR, for example).

One or more of the techniques, factors and/or conditions according to Embodiment 8 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the configuration.

One or more of the techniques, factors and/or conditions according to Embodiment 8 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the configuration.

The configuration may be (and/or may comprise) a second parameter, a configuration (with which the UE is configured, for example), and/or an indication. The second parameter may indicate whether or not the UE can initiate a 2-step RA (for transmitting BSR, for example). The configuration may be received (and/or configured) in a RRC message, a MAC CE and/or a DCI (e.g., the UE may be configured with the configuration via the RRC message, the MAC CE and/or the DCI). Alternatively and/or additionally, the configuration may be received (and/or configured) in a BSR configuration (e.g., the UE may be configured with the configuration via the BSR configuration). The configuration may be received (and/or configured) in an SR configuration (e.g., the UE may be configured with the configuration via the SR configuration). The configuration may be received (and/or configured) in an RA configuration (e.g., the UE may be configured with the configuration via the RA configuration). The configuration may be received (and/or configured) in an NTN configuration (e.g., the UE may be configured with the configuration via the NTN configuration).

One, some and/or all instances of “configuration” discussed with respect to Embodiment 8 may be replaced with “indication”, “indication received from the NW” and/or “NW configuration and/or indication”.

### Embodiment 9

In Embodiment 9, to solve one or more of the aforementioned issues, a UE may determine whether or not to initiate (and/or whether or not the UE is allowed to initiate) 2-step RA (for transmitting BSR, for example) based on a size of a BSR (e.g., the UE may consider the size of the BSR as a factor in determining whether or not to initiate the 2-step RA and/or in determining whether or not the UE is allowed to initiate the 2-step RA). If the size of the BSR (e.g., a size of a MAC CE, such as a size of a BSR MAC CE) matches a limitation (e.g., if the size of the BSR meets a threshold size, such as if the size of the BSR is smaller than the threshold size), the UE may initiate 2-step RA (for transmitting the BSR, for example). If the size of the BSR (e.g., the size of the MAC CE, such as the size of the BSR MAC CE) does not match the limitation (e.g., if the size of the BSR does not meet the threshold size, such as if the size of the BSR is larger than the threshold size), the UE may not initiate 2-step RA (for transmitting the BSR, for example).

In an example, if the BSR is a Short BSR, the UE may initiate 2-step RA (for transmitting the BSR, for example). If the BSR is a Long BSR, the UE may not initiate 2-step RA (for transmitting the BSR, for example).

In an example, if a number of reported LCGs (e.g., a reported LCG number) in the BSR (e.g., a number of LCGs indicated by the BSR) is less than a first threshold, the UE may initiate 2-step RA (for transmitting the BSR, for example). If the number of reported LCGs in the BSR is greater than (or equal to) the first threshold, the UE may not initiate 2-step RA (for transmitting the BSR, for example). The first threshold may be a threshold indicating a limited number of LCGs in a BSR. The first threshold may be received (and/or configured) in a BSR configuration (e.g., the UE may be configured with the first threshold via the BSR configuration).

One or more of the techniques, factors and/or conditions according to Embodiment 9 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the size of the BSR, the number of reported LCGs and/or whether the BSR is a Short BSR or a Long BSR.

One or more of the techniques, factors and/or conditions according to Embodiment 9 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the size of the BSR, the number of reported LCGs and/or whether the BSR is a Short BSR or a Long BSR.

### Embodiment 10

In Embodiment 10, to solve one or more of the aforementioned issues, a UE may determine whether or not to initiate (and/or whether or not the UE is allowed to initiate) 2-step RA (for transmitting BSR, for example) based on a common timing offset value (e.g., the UE may consider the common timing offset value as a factor in determining whether or not to initiate the 2-step RA and/or in determining whether or not the UE is allowed to initiate the 2-step RA). The UE may receive a common timing offset value from the NW. If the common timing offset value is higher than a second threshold, the UE may initiate 2-step RA (for transmitting BSR, for example). If the common timing offset value is not higher than the second threshold, the UE may not initiate 2-step RA (for transmitting BSR, for example). The common timing offset value may be broadcast by the NW. The common timing offset value may be received (and/or configured) in a RRC message, a MAC CE and/or a DCI (e.g., the UE may be configured with the common timing offset value via the RRC message, the MAC CE and/or the DCI). The second threshold may be a timing offset threshold. The second threshold may indicate a shortest timing offset (e.g., a shortest timing offset value) for the UE to initiate 2-step RA (for transmitting BSR, for example). The second threshold may be received (and/or configured) in a BSR configuration (e.g., the UE may be configured with the second threshold via the BSR configuration). The second threshold may be received (and/or configured) in an SR configuration (e.g., the UE may be configured with the second threshold via the SR configuration). The second threshold may be received (and/or configured) in an RA configuration (e.g., the UE may be configured with the second threshold via the RA configuration). The second threshold may be received (and/or configured) in an NTN configuration (e.g., the UE may be configured with the second threshold via the NTN configuration).

One or more of the techniques, factors and/or conditions according to Embodiment 10 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the common timing offset value and/or the second threshold.

One or more of the techniques, factors and/or conditions according to Embodiment 10 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the random number (e.g., ‘rand’), the probability of initiation and/or the first parameter.

### Embodiment 11

In Embodiment 11, to solve one or more of the aforementioned issues, a UE may determine whether or not to initiate (and/or whether or not the UE is allowed to initiate) 2-step RA (for transmitting BSR, for example) based on a Serving Cell of the UE (e.g., the UE may consider the Serving Cell as a factor in determining whether or not to initiate the 2-step RA and/or in determining whether or not the UE is allowed to initiate the 2-step RA). If the UE is allowed to initiate 2-step RA (for transmitting BSR, for example) to the Serving Cell, the UE may initiate 2-step RA (for transmitting BSR, for example). If the UE is not allowed to initiate 2-step RA (for transmitting BSR, for example) to the Serving Cell, the UE may not initiate 2-step RA (for transmitting BSR, for example). Alternatively and/or additionally, if the Serving Cell is allowed to perform 2-step RA (for transmitting BSR, for example) in response to initiation of the 2-step RA by the UE, the UE may initiate 2-step RA (for transmitting BSR, for example). If the Serving Cell is not allowed to perform 2-step RA (for transmitting BSR, for example) in response to initiation of the 2-step RA by the UE, the UE may not initiate 2-step RA (for transmitting BSR, for example).

In an example, if a Serving Cell ID of the Serving Cell is in a first list (e.g., if the first list comprises the Serving Cell ID), the UE may initiate 2-step RA (for transmitting BSR, for example). If the Serving Cell ID is not in the first list, the UE may not initiate 2-step RA (for transmitting BSR, for example). The first list may be a list of Serving Cell IDs. The first list may indicate one or more Serving Cells for which the UE is allowed to initiate 2-step RA (for transmitting BSR, for example) (e.g., the first list may indicate which Serving Cells allow the UE to initiate 2-step RA for transmitting BSR). Alternatively and/or additionally, the first list may indicate one or more Serving Cells that are allowed to perform 2-step RA (for transmitting BSR, for example) in response to initiation of the 2-step RA by the UE (e.g., the first list may indicate which Serving Cells are allowed to perform 2-step RA for transmitting BSR in response to initiation of the 2-step RA by the UE). The first list may be received (and/or configured) in a BSR configuration (e.g., the UE may be configured with the first list via the BSR configuration). The first list may be received (and/or configured) in an SR configuration (e.g., the UE may be configured with the first list via the SR configuration). The first list may be received (and/or configured) in an RA configuration (e.g., the UE may be configured with the first list via the RA configuration). The first list may be received (and/or configured) in an NTN configuration (e.g., the UE may be configured with the first list via the NTN configuration).

In an example, if a third parameter in a Serving Cell configuration of the Serving Cell is set to true and/or is enabled, the UE may initiate 2-step RA (for transmitting BSR, for example). If the third parameter in the Serving Cell configuration is set to false and/or is disabled, the UE may not initiate 2-step RA (for transmitting BSR, for example).

In an example, if the third parameter in the Serving Cell configuration is present (e.g., present in the Serving Cell configuration), the UE may initiate 2-step RA (for transmitting BSR, for example). If the third parameter in the Serving Cell configuration is absent (e.g., absent from the Serving Cell configuration, such as not included in the Serving Cell configuration), the UE may not initiate 2-step RA (for transmitting BSR, for example). In some examples, the third parameter may indicate whether or not the UE is allowed to initiate 2-step RA (for transmitting BSR, for example) to the Serving Cell. Alternatively and/or additionally, the third parameter may indicate whether or not the Serving Cell is allowed to perform 2-step RA (for transmitting BSR, for example).

One or more of the techniques, factors and/or conditions according to Embodiment 11 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the Serving Cell, the first list, the third parameter and/or the Serving Cell configuration.

One or more of the techniques, factors and/or conditions according to Embodiment 11 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the Serving Cell, the first list, the third parameter and/or the Serving Cell configuration.

### Embodiment 12

In Embodiment 12, to solve one or more of the aforementioned issues, a UE may determine whether or not to initiate (and/or whether or not the UE is allowed to initiate) 2-step RA (for transmitting BSR, for example) based on one or more first platform types in NTN (e.g., the UE may consider the one or more first platform types as a factor in determining whether or not to initiate the 2-step RA and/or in determining whether or not the UE is allowed to initiate the 2-step RA). If the UE is linked to a platform type of one or more second platform types (e.g., one or more specific platform types), the UE may initiate 2-step RA (for transmitting BSR, for example). If the UE is not linked to a platform type of the one or more second platform types, the UE may not initiate 2-step RA (for transmitting BSR, for example). The one or more second platform types may correspond to (and/or may be distinguished by) different airborne and/or spaceborne vehicles (e.g., the one or more second platform types may correspond to at least one of GEO, MEO, HEO, LEO, HAPS, etc.). Alternatively and/or additionally, the one or more second platform types may correspond to (and/or may be distinguished by) altitude. Alternatively and/or additionally, the one or more second platform types may correspond to (and/or may be distinguished by) whether or not an orbital period is equal to the Earth's rotational period (e.g., at least one of GEO, Non-Geostationary Earth Orbiting (NGEO), etc.).

In an example, if the one or more first platform types are in a second list (and/or if at least one platform type of the one or more first platform types is in the second list), the UE may initiate 2-step RA (for transmitting BSR, for example). If the one or more first platform types are not in the second list (and/or if no platform type of the one or more first platform types is in the second list), the UE may not initiate 2-step RA (for transmitting BSR, for example). The second list may be a list of platform types. The second list may indicate one or more platform types (e.g., the one or more second platform types) associated with platforms with which the UE is allowed to initiate 2-step RA (for transmitting BSR, for example) (e.g., the second list may indicate which platform types allow the UE to initiate 2-step RA for transmitting BSR). Alternatively and/or additionally, the second list may indicate one or more platform types (e.g., the one or more second platform types) of platforms that are allowed to perform 2-step RA (for transmitting BSR, for example) in response to initiation of the 2-step RA by the UE (e.g., the second list may indicate which platform types are allowed to perform 2-step RA for transmitting BSR in response to initiation of the 2-step RA by the UE). The second list may be received (and/or configured) in a BSR configuration (e.g., the UE may be configured with the second list via the BSR configuration). The second list may be received (and/or configured) in an SR configuration (e.g., the UE may be configured with the second list via the SR configuration). The second list may be received (and/or configured) in an RA configuration (e.g., the UE may be configured with the second list via the RA configuration). The second list may be received (and/or configured) in an NTN configuration (e.g., the UE may be configured with the second list via the NTN configuration).

In an example, if there is a fourth parameter associated with a platform type (of the one or more first platform types, for example) that indicates 2-step RA (for transmitting BSR, for example), the UE may initiate 2-step RA (for transmitting BSR, for example) (e.g., if the UE is configured with the fourth parameter that indicates 2-step RA for transmitting BSR, the UE may initiate 2-step RA for transmitting BSR). If there is not a parameter (e.g., the fourth parameter) associated with a platform type (of the one or more first platform types, for example) that indicates 2-step RA (for transmitting BSR, for example), the UE may not initiate 2-step RA (for transmitting BSR, for example) (e.g., if the UE is not configured with the fourth parameter that indicates 2-step RA for transmitting BSR, the UE may not initiate 2-step RA for transmitting BSR). For example, if the fourth parameter associated with a platform type (of the one or more first platform types, for example) enables 2-step RA (for transmitting BSR, for example), the UE may initiate 2-step RA (for transmitting BSR, for example). If the fourth parameter associated with a platform type (of the one or more first platform types, for example) disables 2-step RA (for transmitting BSR, for example), the UE may not initiate 2-step RA (for transmitting BSR, for example). The fourth parameter may comprise one or more parameters indicative of whether or not the UE is allowed to initiate 2-step RA (for transmitting BSR, for example) with a platform type (of the one or more first platform types, for example). Alternatively and/or additionally, the fourth parameter may comprise one or more parameters indicative of whether or not a platform type (of the one or more first platform types, for example) is allowed to perform 2-step RA (for transmitting BSR, for example) in response to initiation of the 2-step RA by the UE. The fourth parameter may be received (and/or configured) in an NTN configuration (e.g., the UE may be configured with the fourth parameter via the NTN configuration).

In an example, if an altitude of a platform type (of the one or more first platform types, for example) is higher than a third threshold, the UE may initiate 2-step RA (for transmitting BSR, for example). If an altitude of a platform type (of the one or more first platform types, for example) is lower than (or equal to) a third threshold, the UE may not initiate 2-step RA (for transmitting BSR, for example). The third threshold may be an altitude threshold. The third threshold may be received (and/or configured) in a BSR configuration (e.g., the UE may be configured with the third threshold via the BSR configuration). The third threshold may be received (and/or configured) in an SR configuration (e.g., the UE may be configured with the third threshold via the SR configuration). The third threshold may be received (and/or configured) in an RA configuration (e.g., the UE may be configured with the third threshold via the RA configuration). The third threshold may be received (and/or configured) in an NTN configuration (e.g., the UE may be configured with the third threshold via the NTN configuration).

In some examples, the one or more first platform types may be one or more platform types of one or more platforms with which the UE is linked. Alternatively and/or additionally, the one or more first platform types may be one or more platform types of one or more platforms through which the UE is linked to an NTN. In an example, the one or more first platform types may correspond to at least one of one or more types of airborne and/or spaceborne vehicles of one or more platforms, one or more altitudes of the one or more platforms, etc. (e.g., a platform type of the one or more first platform types may correspond to a type of airborne and/or spaceborne vehicle of a platform and/or an altitude of the platform).

One or more of the techniques, factors and/or conditions according to Embodiment 12 (e.g., techniques, factors and/or conditions discussed herein for determining whether or not to initiate a 2-step RA procedure, such as a 2-step RA procedure for transmitting BSR) may be applied to determine whether or not the UE is allowed to initiate a 2-step RA procedure (for transmitting BSR, for example). For example, whether or not the UE is allowed to initiate a 2-step RA procedure (for transmitting BSR, for example) may be determined based on the one or more first platform types, the one or more second platform types, the second list, the fourth parameter and/or the third threshold.

One or more of the techniques, factors and/or conditions according to Embodiment 12 (e.g., techniques, factors and/or conditions discussed herein for determining whether or not to initiate a 2-step RA procedure, such as a 2-step RA procedure for transmitting BSR) may be applied to determine whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR). For example, whether or not the BSR triggers (e.g., directly triggers) a 2-step RA procedure and/or whether or not the UE is allowed to trigger the 2-Step RA procedure in response to the BSR (e.g., in response to triggering the BSR), such as directly in response to the BSR (e.g., directly in response to triggering the BSR) may be determined based on the one or more first platform types, the one or more second platform types, the second list, the fourth parameter and/or the third threshold.

One, some and/or all instances of “fourth parameter” discussed with respect to Embodiment 12 may be replaced with “indication” and/or “fourth parameter and/or indication”.

In some examples, one, some and/or all of the techniques, factors and/or conditions discussed with respect to one, some and/or all of Embodiments 7-12 may be formed and/or combined to a new embodiment.

In one or more examples discussed with respect to one, some and/or all of Embodiments 7-12 in which a determination is made to initiate 2-step RA (for transmitting BSR, for example), the determination may be replaced with (and/or may be in addition to) a determination that the UE is allowed to initiate a 2-step RA procedure (for transmitting BSR, for example). In one or more examples discussed with respect to one, some and/or all of Embodiments 7-12 in which a determination is made not to initiate 2-step RA (for transmitting BSR, for example), the determination may be replaced with (and/or may be in addition to) a determination that the UE is not allowed to initiate a 2-step RA procedure (for transmitting BSR, for example).

In one or more examples discussed with respect to one, some and/or all of Embodiments 7-12 in which a determination is made to initiate 2-step RA (for transmitting BSR, for example), the determination may be replaced with (and/or may be in addition to) a determination that the BSR triggers (e.g., directly triggers) the 2-step RA procedure (and/or a determination that the UE is allowed to trigger the 2-step RA procedure in response to the BSR, such as directly in response to the BSR). In one or more examples discussed with respect to one, some and/or all of Embodiments 7-12 in which a determination is made not to initiate 2-step RA (for transmitting BSR, for example), the determination may be replaced with (and/or may be in addition to) a determination that the BSR does not trigger (e.g., directly trigger) the 2-step RA procedure (and/or a determination that the UE is not allowed to trigger the 2-step RA procedure in response to the BSR, such as directly in response to the BSR).

In some examples, the determination of whether or not to initiate the 2-step RA procedure (for transmitting BSR, for example) may be determined based on one or more other factors other than those discussed herein with respect to Embodiment 7, Embodiment 8, Embodiment 9, Embodiment 10, Embodiment 11 and/or Embodiment 12. The one or more other factors may comprise an amount of UL resources for transmitting BSR (e.g., an amount of available UL resources for transmitting BSR) and/or whether or not the amount of UL resources is less than a threshold amount of UL resources for transmitting BSR. Alternatively and/or additionally, the one or more other factors may comprise a 2-step RA configuration. In some examples, the UE may initiate 2-step RA (for transmitting BSR, for example) (and/or the UE may determine the UE is allowed to initiate a 2-step RA procedure and/or the UE may determine the BSR triggers, such as directly triggers, the 2-step RA procedure) if one or more first factors (e.g., one or more necessary factors) are fulfilled, such as if all factors of the one or more first factors are fulfilled. In some examples, a factor of the one or more first factors may be considered to be fulfilled if one or more conditions associated with the factor are met. The one or more first factors may comprise one, some and/or all factors discussed with respect to Embodiment 7, Embodiment 8, Embodiment 9, Embodiment 10, Embodiment 11 and/or Embodiment 12. Alternatively and/or additionally, the one or more first factors may comprise one, some and/or all of the one or more other factors. The UE may consider (e.g., check) the one or more first factors (e.g., one, some and/or all of the above mentioned factors and/or one or more other factors) to determine whether or not to initiate 2-step RA (for transmitting the BSR, for example). Alternatively and/or additionally, the UE may determine whether or not to initiate 2-step RA (for transmitting the BSR, for example) based on a result of the one or more first factors (e.g., the result may indicate whether or not one or more conditions associated with the one or more first factors are met). Alternatively and/or additionally, the UE may consider (e.g., check) the one or more first factors (e.g., one, some and/or all of the above mentioned factors and/or one or more other factors) to determine whether or not the UE is allowed to initiate 2-step RA (for transmitting the BSR, for example). Alternatively and/or additionally, the UE may determine whether or not to initiate 2-step RA (for transmitting the BSR, for example) based on a result of the one or more first factors (e.g., the result may indicate whether or not one or more conditions associated with the one or more first factors are met). Alternatively and/or additionally, the UE may determine whether or not the UE is allowed to initiate 2-step RA (for transmitting the BSR, for example) based on a result of the one or more first factors (e.g., the result may indicate whether or not one or more conditions associated with the one or more first factors are met).

An example is provided in which one or more of the techniques, factors and/or conditions according to Embodiment 10 are used. A UE may receive a BSR configuration, an SR configuration, an RA configuration, and/or an NTN configuration from an NW (e.g., an NTN). The RA configuration comprises a 2-step RA configuration. The NTN configuration comprises the second threshold (e.g., timing offset threshold) for timing offset. The UE may receive a common timing offset value broadcast from the NW. The UE may trigger a BSR when UL data arrives (e.g., arrives at the UE). If there are no UL resources (e.g., dynamic UL grant and/or configured UL grant) for transmitting the BSR, the UE may compare the common timing offset value with the second threshold. If the common timing offset value is higher than the second threshold, the UE may initiate an RA procedure (for transmitting BSR, for example). When the RA procedure is initiated, the UE may set an RA type of the RA procedure to 2-step RA (for transmitting BSR, for example). After initiating the RA procedure and/or setting the RA type of the RA procedure to 2-step RA, the UE may transmit the BSR in a PUSCH payload of MSGA (e.g., MSGA of the RA procedure). The UE may receive a UL grant for UL data in MSGB (e.g., MSGB of the RA procedure) from the NW. The UE may transmit the UL data (e.g., the UE may transmit the UL data after the RA procedure corresponding to 2-step RA).

It may be appreciated that applying one or more of the techniques presented herein, such as one or more of the techniques provided with respect to Concept 2, may result in one or more benefits including, but not limited to, enabling a UE to balance transmission delay and RACH resource shortage in NTN when using a 2-step RA to transmit BSR.

Concept 3

According to clause 5.1.2a of 3GPP TS 38.321 V16.2.1, after the UE initiates a 2-step RA procedure (e.g., a contention-based 2-step RA procedure) for transmitting a BSR, the UE selects an SSB, selects a RA preamble associated with the selected SSB, and determines (e.g., selects) a PRACH occasion (e.g., a next available PRACH occasion) from PRACH occasions corresponding to the selected SSB (e.g., the UE may determine the next available PRACH occasion after selecting the selected SSB and/or selecting the RA preamble). The UE selects a PUSCH occasion corresponding to the selected RA preamble and the selected PRACH occasion. The UE may perform MSGA transmission (e.g., MSGA transmission of the 2-step RA procedure) on the selected PRACH occasion and the selected PUSCH occasion.

However, in some scenarios, there may be no valid PUSCH occasion (e.g., no available PUSCH occasion) corresponding to the selected RA preamble and/or the selected PRACH occasion (e.g., the selected RA preamble and/or the selected PRACH occasion are mapped to an invalid PUSCH occasion). As the result, the UE does not transmit data on PUSCH when performing the MSGA transmission (on the selected PRACH occasion, for example). The NW may then respond with a fallback Random Access Response (RAR) comprising a UL grant for the UE to transmit data on PUSCH. In this scenario, the UE is not able to transmit the BSR in a first step (e.g., an initial step) of a 2-step RA procedure, and thus may not reduce UL scheduling delay (as described above, for example).

To solve one or more of the aforementioned issues (e.g., to ensure that the UE is able to transmit a BSR in a first step (e.g., an initial step) of a 2-step RA procedure initiated for transmitting the BSR, such as a 2-step RA procedure that is initiated directly for transmitting the BSR), the UE may apply one or more of the techniques and/or perform one or more of the operations provided with respect to one or more of Embodiments 13-15.

### Embodiment 13

In Embodiment 13, the UE may select a PRACH occasion that is mapped (and/or that corresponds) to a valid PUSCH occasion, and/or the UE may not select a PRACH occasion that is not mapped (and/or that does not correspond) to a valid PUSCH occasion.

In an example, when determining the next available PRACH occasion, such as when the UE selects the next available PRACH occasion from the PRACH occasions corresponding to the selected SSB (e.g., the SSB selected in response to initiating the 2-step RA procedure), the UE may prioritize a first PRACH occasion that is mapped to a valid PUSCH occasion over a second PRACH occasion that is not mapped to a valid PUSCH occasion, and/or the UE may select the first PRACH occasion accordingly. For example, for selection of the next available PRACH occasion, one or more PRACH occasions that are mapped to one or more valid PUSCH occasions may be prioritized over one or more PRACH occasions that are not mapped to one or more valid PUSCH occasions, wherein selection of the next available PRACH occasion may be based on priorities of PRACH occasions (e.g., a PRACH occasion may be selected as the next available PRACH occasion based on a determination that the PRACH occasion has a higher priority than one or more other PRACH occasions).

In a scenario in which the 2-step RA procedure is initiated (e.g., directly initiated) for transmitting a BSR (such as where the 2-step RA procedure is initiated in response to triggering the BSR, such as initiated directly in response to triggering the BSR), the UE may not consider (and/or may exclude) a PRACH occasion, that is not mapped to a valid PUSCH occasion, as a next available PRACH occasion when determining the next available PRACH occasion.

In a scenario in which the 2-step RA procedure is not initiated (e.g., directly initiated) for transmitting a BSR (such as where the 2-step RA procedure is initiated due to a pending SR), the UE may consider (and/or may be allowed to consider) a PRACH occasion, that is not mapped to a valid PUSCH occasion, as the next available PRACH occasion when determining the next available PRACH occasion.

In some examples, the UE may perform the selection of the next available PRACH occasion (as described above, for example) after (and/or in response to) selecting the selected SSB (e.g., the SSB selected in response to initiating the 2-step RA procedure). The UE may perform the selection of the next available PRACH occasion (as described above, for example) before selecting a PUSCH occasion (e.g., a PUSCH occasion, of the 2-step RA procedure, for transmission of the BSR).

In some scenarios, the PRACH occasions corresponding to the selected SSB (e.g., the PRACH occasions from which the UE is configured to select a PRACH occasion) may not comprise a PRACH occasion (e.g., any PRACH occasion) that is mapped to a valid PUSCH occasion. In these scenarios, regardless of which PRACH occasion corresponding to the selected SSB is selected, the UE may not be able to transmit the BSR during a MS GA transmission (e.g., a MSGA transmission, of the 2-step RA procedure, on the selected PRACH occasion). In these scenarios, the UE may perform the selection of the next available PRACH occasion (as described above, for example), or the UE may not perform the selection of the next available PRACH occasion (as described above, for example). In these scenarios, the UE may select a PRACH occasion (e.g., the next available PRACH occasion) regardless of whether or not the PRACH occasion is mapped to a valid PUSCH occasion.

### Embodiment 14

In Embodiment 14, the UE may skip a PRACH transmission (and/or a MSGA transmission) if the selected PRACH occasion (e.g., the next available PRACH occasion selected from the PRACH occasions corresponding to the selected SSB) is not mapped (and/or does not correspond) to a valid PUSCH occasion.

After (and/or in response to) the UE selecting a PRACH occasion (e.g., selecting the PRACH occasion from the PRACH occasions corresponding to the selected SSB), the UE may determine whether or not the selected PRACH occasion is mapped to (and/or corresponds to) a valid PUSCH occasion. In some examples, the UE may perform the determination before performing a MSGA transmission (on the selected PRACH occasion, for example).

In some examples, in response to determining that the selected PRACH occasion is not mapped (and/or does not correspond) to a valid PUSCH occasion, the UE may perform RA Resource selection (as specified in clause 5.1.2a of 3GPP TS 38.321 V16.2.1, for example) again. In the scenario in which the UE determines that the selected PRACH occasion is not mapped (and/or does not correspond) to a valid PUSCH occasion, the UE may select a second SSB that is different from the SSB selected in a previous RA Resource selection.

In some examples, the UE may perform RA Backoff before performing the RA Resource selection (as specified in clause 5.1.2a of 3GPP TS 38.321 V16.2.1, for example) again. For example, the UE may perform RA Backoff in response to determining that the selected PRACH occasion is not mapped (and/or does not correspond) to a valid PUSCH occasion.

Alternatively and/or additionally, in response to determining that the selected PRACH occasion is not mapped (and/or does not correspond) to a valid PUSCH occasion, the UE may determine the next available PRACH occasion (e.g., the UE may select the next available PRACH occasion from the PRACH occasions corresponding to the selected SSB. For example, in response to determining that the selected PRACH occasion is not mapped (and/or does not correspond) to a valid PUSCH occasion, rather than performing a selection of the second SSB that is different from the selected SSB, the UE may select the next available PRACH occasion (e.g., a second PRACH occasion) from the PRACH occasions corresponding to the selected SSB (e.g., the selected SSB remains the same), wherein the next available PRACH occasion (e.g., the second PRACH occasion) may be different from the selected PRACH occasion.

In some examples, the UE may increment a counter (e.g., PREAMBLE TRANSMISSION COUNTER) by one in response to skipping the PRACH transmission (and/or the MSGA transmission).

### Embodiment 15

In Embodiment 15, the UE may cancel the 2-step RA procedure (for transmitting a BSR, for example) and/or may trigger a SR for the triggered BSR (e.g., the triggered BSR in response to which the 2-step RA procedure is initiated).

After (and/or in response to) the UE selecting a PRACH occasion, the UE may determine whether or not the selected PRACH occasion is mapped to (and/or corresponds to) a valid PUSCH occasion. In some examples, the UE may perform the determination before performing a MSGA transmission (on the selected PRACH occasion, for example).

In some examples, the UE may cancel the 2-step RA procedure and/or trigger (e.g., re-trigger) a SR for the triggered BSR based on the determination of whether or not the selected PRACH occasion is mapped to and/or corresponds to) a valid PUSCH occasion. In an example, the UE may cancel the 2-step RA procedure and/or trigger (e.g., re-trigger) the SR for the triggered BSR instead of selecting (and/or waiting for) a second PRACH occasion that is mapped to a valid PUSCH occasion.

In an example, the UE may cancel the 2-step RA procedure in response to determining that the selected PRACH occasion is not mapped (and/or does not correspond) to a valid PUSCH occasion, wherein the 2-step RA procedure was initiated for transmitting the BSR.

In an example, the UE may trigger (e.g., re-trigger) a SR for the BSR in response to determining that the selected PRACH occasion is not mapped (and/or does not correspond) to a valid PUSCH occasion, wherein the 2-step RA procedure was initiated for transmitting the BSR.

In some examples, one, some and/or all of the techniques and/or operations discussed with respect to one, some and/or all of Embodiments 13-15 may be formed and/or combined to a new embodiment.

In some scenarios, even if the selected PRACH occasion (e.g., the PRACH occasion selected from the PRACH occasions corresponding to the selected SSB) is mapped to a PUSCH occasion that is valid, it is possible that the MSGA transmission (on the selected PRACH occasion and the PRACH occasion) is not successful (e.g., an initial attempt of the MSGA transmission is not successful). In these scenarios, re-transmission of MSGA may be required. In these scenarios, the BSR may not be delivered to the NW due to the MSGA transmission not being successful (e.g., failure of the MSGA transmission).

To reduce delay in transmitting the BSR (and/or to avoid introducing too much delay, such as delay exceeding a threshold, in transmitting the BSR), the UE may cancel (and/or determine whether or not to cancel) the 2-step RA procedure and/or trigger (e.g., re-trigger) a SR for the triggered BSR in Scenario 19 and/or Scenario 20.

Scenario 19

In Scenario 19, msgB-ResponseWindow expires in the 2-step RA procedure.

In some examples, the UE may not receive a MSGB, that is in response to the MSGA transmission, before the msgB-ResponseWindow expires. In a scenario in which the UE does not receive the MSGB before the msgB-ResponseWindow expires, the MSGA transmission may be considered to be unsuccessful, and/or the UE may cancel the 2-step RA procedure (e.g., the UE may cancel the 2-step RA procedure in order to avoid additional delay in transmitting the BSR).

In some examples, the UE may cancel the 2-step RA procedure (that is initiated for transmitting the BSR, for example), in response to expiry (e.g., timer expiration) of the msgB-ResponseWindow.

In some examples, the UE may trigger (e.g., re-trigger) a SR for the triggered BSR in response to expiry (e.g., timer expiration) of the msgB-ResponseWindow.

The msgB-ResponseWindow may correspond to a time window to monitor and/or receive one or more RA responses for 2-step RA type.

The msgB-ResponseWindow may be started in response to transmission of MSGA preamble (and/or when MSGA preamble is transmitted).

The UE may monitor PDCCH addressed to MSGB-Radio Network Temporary Identifier (RNTI) when the msgB-ResponseWindow is running (e.g., during the msgB-ResponseWindow).

The msgB-ResponseWindow may be stopped in response to (and/or when) MSGB is received.

The msgB-ResponseWindow may be a timer.

Scenario 20

In Scenario 20, MSGA transmission has failed one or more times in the 2-step RA procedure.

In some examples, the UE performs multiple MSGA transmission attempts (e.g., multiple attempts to perform MSGA transmission of the 2-step RA procedure), wherein the multiple MSGA transmission attempts are not successful (e.g., the multiple transmission attempts fail). The UE may cancel the 2-step RA procedure (e.g., the UE may cancel the 2-step RA procedure in order to avoid additional delay in transmitting the BSR).

The UE may count a number of MSGA transmission attempts of the multiple MSGA transmission attempts using a counter (e.g., PREAMBLE TRANSMISSION COUNTER). For example, the UE may increase (e.g., increment by one) the counter for each MSGA transmission attempt of the multiple MSGA transmission attempts.

The UE may determine that the MSGA transmission has failed a threshold number of times based on the counter meeting (e.g., reaching or exceeding) a threshold. The threshold may be msgA-TransMax. The threshold may be different from msgA-TransMax (e.g., the threshold may be a threshold other than msgA-TransMax), and/or may be used in scenarios in which the 2-step RA procedure is performed for transmitting BSR.

The UE may cancel the 2-step RA procedure (that is initiated for transmitting the BSR, for example) in response to the counter meeting (e.g., reaching or exceeding) the threshold.

The UE may trigger (e.g., re-trigger) a SR for the triggered BSR in response to that the counter meeting (e.g., reaching or exceeding) the threshold.

With respect to one or more embodiments herein, such as one or more embodiments provided with respect to Concept 3, a 2-step RA procedure initiated (e.g., directly initiated) for transmitting BSR may mean that the 2-step RA procedure is triggered and/or initiated by the BSR (instead of the 2-step RA procedure being triggered and/or initiated by a SR that is triggered by BSR).

With respect to one or more embodiments herein, such as one or more embodiments provided with respect to Concept 3, the BSR may be a short BSR. Alternatively and/or additionally, the BSR may be a truncated BSR. Alternatively and/or additionally, the BSR may be a long BSR. Alternatively and/or additionally, the BSR may not be a long BSR. In some examples, the BSR may be triggered due to (e.g., in response to) UL data becoming available for transmission. In some examples, the UL data may be UL data for a logical channel that belongs to a LCG. Alternatively and/or additionally, the UL data may belong to a first logical channel with a first priority that is higher than one or more priorities of one or more other logical channels containing available UL data (e.g., the one or more other logical channels may comprise all logical channels, other than the first logical channel, that contain available UL data), wherein the one or more other logical channels may belong to any LCG. For example, the first priority may be a highest priority among priorities of logical channels containing available UL data. Alternatively and/or additionally, the UL data may become available for transmission when (and/or after) no logical channels that belong to a LCG (e.g., a LCG to which a logical channel containing the UL data belongs) contains available UL data (e.g., any available UL data).

With respect to one or more embodiments herein, such as one or more embodiments provided with respect to Concept 3, the 2-step RA procedure may be triggered (and/or initiated) by BSR. The 2-step RA procedure may not be triggered (and/or initiated) by SR. The 2-step RA procedure may not be triggered (and/or initiated) by BFR.

With respect to one or more embodiments herein, such as one or more embodiments provided with respect to Concept 3, the UE may be configured with transmitting BSR over a 2-step RA procedure (e.g., the UE may be configured with a configuration that enables the UE to transmit BSR over a 2-step RA procedure).

With respect to one or more embodiments herein, such as one or more embodiments provided with respect to Concept 3, the UE may receive a configuration of one or more PUCCH resources for SR. The UE may be configured with the one or more PUCCH resources for SR (e.g., the UE may be configured with the one or more PUCCH resources for SR via the configuration).

It may be appreciated that applying one or more of the techniques presented herein, such as one or more of the techniques provided with respect to Concept 3, may result in one or more benefits including, but not limited to, enabling a UE in an NTN Cell to transmit a BSR in a first step (e.g., an initial step) of a 2-step RA procedure and/or enabling a UE in an NTN Cell to fallback to SR procedure after initiating a 2-step RA procedure for transmitting a BSR.

Concept 4

To enable BSR over 2-step RA (e.g., to enable transmitting BSR over a 2-step RA procedure), a UE may initiate 2-step RA (for transmitting BSR, for example) when there are no UL resources (e.g., dynamic UL grant and/or configured UL grant) for transmitting BSR (e.g., the UE may initiate the 2-step RA when the UE does not have a UL resource, such as a dynamic UL grant and/or a configured UL grant, for transmitting BSR). In some examples, a UE connected to a NTN cell may initiate a 2-step RA procedure (for transmitting a BSR, for example) even if (and/or regardless of whether or not) there is a valid PUCCH resource for SR transmission (e.g., the UE connected to the NTN cell may initiate the 2-step RA procedure for transmitting the BSR regardless of whether or not the UE has a valid PUCCH resource for transmitting a SR).

According to NR MAC specification (e.g., current NR MAC specification) regarding random access procedure and BWP operation (e.g., clause 5.1.1 and 5.15 of 3GPP TS 38.321 V16.2.1), after the UE initiates a RA procedure, the UE selects a carrier (e.g., a supplementary uplink (SUL) carrier and/or a normal uplink (NUL) carrier) and the UE performs BWP operation. If PRACH occasions are not configured for an active UL BWP (e.g., currently active UL BWP), the UE switches the active UL BWP to an initial UL BWP (e.g., the initial UL BWP is a UL BWP that is indicated by initialUplinkBWP). Alternatively and/or additionally, if the PRACH occasions are configured for the active UL BWP (e.g., the currently active UL BWP), the UE does not switch the active UL BWP. However, it is possible that the UE has a 4-step RA configuration on the active UL BWP (e.g., the currently active UL BWP) and does not have a 2-step RA configuration on the active UL BWP (e.g., the currently active UL BWP) (e.g., the UE has the 4-step RA configuration on the active UL BWP and does not have a 2-step RA configuration on the active UL BWP when the UE initiates the RA procedure). The UE may have a 2-step RA configuration on an inactive BWP (e.g., a currently inactive BWP) (e.g., the UE may have the 2-step RA configuration on the inactive BWP when the UE initiates the RA procedure). The UE may not switch the UL BWP since the PRACH occasions are configured (for 4-step RA, for example) on the active BWP (e.g., the currently active BWP). The UE may not have 2-step RA Resources to perform a 2-step RA procedure (on the active UL BWP, such as the currently active UL BWP, for example). The UE may perform a 4-step RA procedure (on the active UL BWP, such as the currently active UL BWP, for example). In this scenario, the UE is not able to transmit the BSR in a 2-step RA procedure, and thus may not be able to reduce UL scheduling delay (as described above, for example).

To solve one or more of the aforementioned issues (e.g., to enable the UE to transmit the BSR in a 2-step RA procedure), the UE may apply one or more of the techniques and/or perform one or more of the operations provided with respect to one or more of Embodiments 16-17. In an example, the UE may apply one or more of the techniques and/or perform one or more of the operations provided with respect to one or more of Embodiments 16-17 when (e.g., in response to) initiating a RA procedure (e.g., initiating the RA procedure for transmitting BSR).

### Embodiment 16

In Embodiment 16, the UE may switch a UL BWP of the UE (e.g., an active UL BWP of the UE) from a first UL BWP without a 2-step RA configuration to a second UL BWP with a 2-step RA configuration.

Switching the UL BWP of the UE (e.g., the active UL BWP of the UE) from the first UL BWP to the second UL BWP may correspond to switching from the first UL BWP being active to the second UL BWP being active. For example, before switching the UL BWP of the UE from the first UL BWP to the second UL BWP, the first UL BWP may be the active UL BWP of the UE. After switching the active UL BWP from the first UL BWP to the second UL BWP, the second UL BWP may be the active UL BWP of the UE.

In some examples, the first UL BWP is the active UL BWP of the UE (e.g., the first UL BWP is the active UL BWP of the UE when the RA procedure is initiated and/or before the RA procedure is initiated). In some examples, 2-step RA is not configured on the first UL BWP. Alternatively and/or additionally, 2-step RA Resources may not be configured in the first UL BWP. Alternatively and/or additionally, PRACH occasions for 2-step RA may not be configured for the first UL BWP. Alternatively and/or additionally, the first UL BWP may be configured with 4-step RA (e.g., the first UL BWP may be configured with 4-step RA resources and/or PRACH occasions for 4-step RA).

In some examples, the second UL BWP is not the active UL BWP (e.g., the second UL BWP is not the active UL BWP when the RA procedure is initiated and/or before the RA procedure is initiated). For example, the second UL BWP may be an inactive UL BWP (e.g., the second UL BWP may be an inactive UL BWP when the RA procedure is initiated and/or before the RA procedure is initiated). In some examples, 2-step RA is configured on the second UL BWP. Alternatively and/or additionally, 2-step RA Resources are configured in the second UL BWP. Alternatively and/or additionally, PRACH occasions for 2-step RA are configured for the second UL BWP. The second UL BWP may be an initial UL BWP (e.g., the initial UL BWP is a UL BWP that is indicated by initialUplinkBWP). The second UL BWP may not be an initial UL BWP (e.g., the second UL BWP may not be indicated by initialUplinkBWP).

In some examples, in response to a BSR (e.g., a Regular BSR) being triggered (and/or in order to transmit the BSR), if the current active UL BWP of the UE (e.g., the first UL BWP) is configured with 2-step RA (e.g., if the current active UL BWP is configured with PRACH resources for 2-step RA and/or is configured with PRACH occasions for 2-step RA), the UE initiates a 2-step RA procedure in the current active UL BWP (e.g., the first UL BWP). For example, the UE may not switch the active UL BWP (e.g., the UE may not switch the active UL BWP in response to the BSR being triggered and/or in order to transmit the BSR) if the current active UL BWP of the UE is configured with 2-step RA. Alternatively and/or additionally, if the current active BWP (e.g., the first UL BWP) is not configured with 2-step RA (e.g., if the current active UL BWP is not configured with PRACH resources for 2-step RA and/or is not configured with PRACH occasions for 2-step RA), the UE switches the active UL BWP to another BWP (e.g., the second UL BWP) that is configured with 2-step RA (e.g., the second UL BWP that is configured with PRACH resources for 2-step RA and/or is configured with PRACH occasions for 2-step RA). The UE initiates a 2-step RA procedure in the second UL BWP.

The UE may perform a determination of whether or not 2-step RA is configured on the first UL BWP (e.g., whether or not the first UL BWP is configured with 2-step RA). In some examples, the determination may comprise determining whether or not 2-step RA resources are configured in the first UL BWP (e.g., whether or not the first UL BWP is configured with 2-step RA resources). In some examples, the determination may comprise determining whether or not PRACH occasions for 2-step RA are configured on the first UL BWP (e.g., whether or not the first UL BWP is configured with PRACH occasions for 2-step RA).

The UE may perform the determination after (and/or in response to) initiating the RA procedure. The UE may perform the determination after (and/or in response to) selecting a carrier (e.g., a SUL carrier and/or a NUL carrier), such as after (and/or in response to) selecting a carrier associated with the RA procedure. The UE may perform the determination after (and/or in response to) performing BWP operation, such as after (and/or in response to) performing BWP operation associated with the RA procedure. The UE may perform the determination after (and/or in response to) selecting a RA type (e.g., selecting, from among 2-step RA and 4-step RA, a RA type of the RA procedure).

In some examples, based on the determination, the UE determines whether or not to switch the active UL BWP of the UE (e.g., switch the active UL BWP of the UE from the first UL BWP of the UE to the second UL BWP of the UE).

In an example, the UE may switch the active UL BWP of the UE (e.g., the UE may switch the active UL BWP of the UE from the first UL BWP of the UE to the second UL BWP of the UE) if the determination comprises determining that the 2-step RA is not configured on the first UL BWP (e.g., 2-step RA resources are not configured in the first UL BWP and/or PRACH occasions for 2-step RA are not configured on the first UL BWP).

Alternatively and/or additionally, the UE may not switch the active UL BWP of the UE (e.g., the UE may not switch the active UL BWP of the UE from the first UL BWP of the UE to the second UL BWP of the UE) if the determination comprises determining that the 2-step RA is configured on the first UL BWP (e.g., 2-step RA resources are configured in the first UL BWP and/or the PRACH occasions for 2-step RA are configured on the first UL BWP).

The UE may switch a downlink (DL) BWP of the UE (e.g., an active DL BWP of the UE) from a first DL BWP to a second DL BWP. The first DL BWP is the active DL BWP of the UE (e.g., the first DL BWP is the active DL BWP of the UE when the RA procedure is initiated and/or before the RA procedure is initiated). In some examples, the second DL BWP is a DL BWP with the same BWP ID (e.g., bwp-Id) as the second UL BWP. In some examples, the UE switches the DL BWP of the UE (e.g., the active DL BWP of the UE) from the first DL BWP to the second DL BWP in association with switching the UL BWP of the UE (e.g., the active UL BWP of the UE) from the first UL BWP to the second UL BWP. The UE may switch the UL BWP of the UE (and the DL BWP of the UE, for example) after selecting a carrier (e.g., a SUL carrier and/or a NUL carrier), such as after selecting a carrier associated with the RA procedure. The UE may switch the UL BWP of the UE (and the DL BWP of the UE, for example) when (and/or in response to) performing BWP operation, such as BWP operation associated with the RA procedure. The UE may switch the UL BWP (and the DL BWP, for example) before (or in response to) selecting a RA type (e.g., selecting, from among 2-step RA and 4-step RA, a RA type of the RA procedure). The UE may switch the UL BWP of the UE (and the DL BWP of the UE, for example) when (and/or in response to) performing the determination. The UE may switch the UL BWP of the UE (and the DL BWP of the UE, for example) before performing a RA Resource selection procedure, such as a RA Resource selection procedure associated with the RA procedure. The UE may activate the second UL BWP (and the second DL BWP, for example) and deactivate the first UL BWP (and the first DL BWP, for example). For example, switching the UL BWP of the UE may comprise activating the second UL BWP and deactivating the first UL BWP. Alternatively and/or additionally, switching the DL BWP of the UE may comprise activating the second DL BWP and deactivating the first DL BWP. The UE may perform the 2-step RA procedure (for transmitting BSR, for example) on the second UL BWP (and the second DL BWP, for example).

The UE may perform the switch (e.g., switching the UL BWP of the UE from the first UL BWP to the second UL BWP and/or switching the DL BWP of the UE from the first DL BWP to the second DL BWP) autonomously. For example, the UE may perform the switch without receiving an indication to switch BWP from a NW (and/or performing the switch may not be based on an indication to switch BWP from the NW).

### Embodiment 17

In Embodiment 17, the UE may cancel the RA procedure and/or may trigger a SR for the triggered BSR on a first UL BWP (in response to determining that there are no 2-step RA resources configured in the first UL BWP, for example).

In some examples, the first UL BWP is the active UL BWP of the UE (e.g., the first UL BWP is the active UL BWP of the UE when the RA procedure is initiated and/or before the RA procedure is initiated). In some examples, 2-step RA is not configured on the first UL BWP. Alternatively and/or additionally, 2-step RA Resources may not be configured in the first UL BWP. Alternatively and/or additionally, PRACH occasions for 2-step RA may not be configured for the first UL BWP. Alternatively and/or additionally, the first UL BWP may be configured with 4-step RA (e.g., the first UL BWP may be configured with 4-step RA resources and/or PRACH occasions for 4-step RA).

In some examples, in response to a BSR (e.g., a Regular BSR) being triggered (and/or in order to transmit the BSR), if the current active UL BWP of the UE (e.g., the first UL BWP) is configured with 2-step RA (e.g., if the current active UL BWP is configured with PRACH resources for 2-step RA and/or is configured with PRACH occasions for 2-step RA), the UE initiates a 2-step RA procedure in the current active UL BWP (e.g., the first UL BWP). For example, the UE may not switch the active UL BWP (e.g., the UE may not switch the active UL BWP in response to the BSR being triggered and/or in order to transmit the BSR) if the current active UL BWP of the UE is configured with 2-step RA. Alternatively and/or additionally, if the current active BWP (e.g., the first UL BWP) is not configured with 2-step RA (e.g., the current active UL BWP is not configured with PRACH resources for 2-step RA and/or is not configured with PRACH occasions for 2-step RA) and no other BWP (e.g., no other UL BWP, other than the current active UL BWP, with which the UE can perform a RA procedure) is configured with 2-step RA (e.g., no other BWP, other than the current active UL BWP, is configured with PRACH resources for 2-step RA and/or is configured with PRACH occasions for 2-step RA), the UE cancels the 2-step RA procedure. The UE may trigger a SR.

The UE may perform a determination of whether or not 2-step RA is configured on the first UL BWP (e.g., whether or not the first UL BWP is configured with 2-step RA). In some examples, the determination may comprise determining whether or not 2-step RA resources are configured in the first UL BWP (e.g., whether or not the first UL BWP is configured with 2-step RA resources). In some examples, the determination may comprise determining whether or not PRACH occasions for 2-step RA are configured on the first UL BWP (e.g., whether or not the first UL BWP is configured with PRACH occasions for 2-step RA).

The UE may perform the determination after (and/or in response to) initiating the RA procedure. The UE may perform the determination after (and/or in response to) selecting a carrier (e.g., a SUL carrier and/or a NUL carrier), such as after (and/or in response to) selecting a carrier associated with the RA procedure. The UE may perform the determination after (and/or in response to) performing BWP operation, such as after (and/or in response to) performing BWP operation associated with the RA procedure. The UE may perform the determination after (and/or in response to) selecting a RA type (e.g., selecting, from among 2-step RA and 4-step RA, a RA type of the RA procedure).

In some examples, based on the determination, the UE determines whether or not to cancel the RA procedure.

In an example, the UE may cancel the 2-step RA procedure if the determination comprises determining that the 2-step RA is not configured on the first UL BWP (e.g., 2-step RA resources are not configured in the first UL BWP and/or PRACH occasions for 2-step RA are not configured on the first UL BWP).

Alternatively and/or additionally, the UE may cancel the 2-step RA procedure if the determination comprises determining that the 2-step RA is not configured on the first UL BWP (e.g., 2-step RA resources are not configured in the first UL BWP and/or PRACH occasions for 2-step RA are not configured on the first UL BWP) and if the UE determines that no other BWP (e.g., no other UL BWP, other than the current active UL BWP, with which the UE can perform a RA procedure) is configured with 2-step RA (e.g., no other BWP, other than the current active UL BWP, is configured with PRACH resources for 2-step RA and/or is configured with PRACH occasions for 2-step RA).

Alternatively and/or additionally, the UE may not cancel the 2-step RA procedure if the determination comprises determining that the 2-step RA is configured on the first UL BWP (e.g., 2-step RA resources are configured in the first UL BWP and/or the PRACH occasions for 2-step RA are configured on the first UL BWP).

The UE may cancel the RA procedure (for transmitting BSR, for example) after (and/or in response to) initiating the RA procedure. The UE may cancel the RA procedure after (and/or in response to) selecting a carrier (e.g., a SUL carrier and/or a NUL carrier), such as after (and/or in response to) selecting a carrier associated with the RA procedure. The UE may cancel the RA procedure after (and/or in response to) performing BWP operation, such as BWP operation associated with the RA procedure. The UE may cancel the RA procedure after (and/or in response to) selecting the RA type (e.g., selecting, from among 2-step RA and 4-step RA, a RA type of the RA procedure). The UE may cancel the RA procedure (for transmitting BSR, for example) after (and/or in response to) the determination. The UE may not perform a RA Resource selection procedure, such as a RA Resource selection procedure associated with the RA procedure (e.g., the UE may cancel the RA procedure prior to a RA Resource selection procedure of the RA procedure). The UE may not transmit a RA preamble and/or MS GA, such as a RA preamble and/or MSGA associated with the RA procedure (e.g., the UE may cancel the RA procedure prior to transmission of a RA preamble and/or MSGA of the RA procedure). The UE may trigger a SR after (and/or in response to) cancelling the RA procedure (e.g., the RA procedure for transmitting BSR).

In some examples, one, some and/or all of the techniques and/or conditions discussed with respect to one and/or all of Embodiments 16-17 may be formed and/or combined to a new embodiment.

With respect to one or more embodiments herein, such as one or more embodiments provided with respect to Concept 4, the UE may be configured with multiple BWPs (e.g., multiple UL BWPs and/or multiple DL BWPs). The UE may be in a cell of an NTN. The UE may be connected to the cell of the NTN. The UE may be configured with transmitting BSR over 2-step RA procedure.

It may be appreciated that applying one or more of the techniques presented herein, such as one or more of the techniques provided with respect to Concept 4, may result in one or more benefits including, but not limited to, enabling a UE to handle a scenario in which there is no 2-step RA configuration on an active UL BWP when the UE attempts to transmit BSR over 2-step RA in an NTN Cell.

One, some and/or all of the foregoing examples, concepts, techniques and/or embodiments may be formed and/or combined to a new embodiment.

In some examples, embodiments disclosed herein, such as embodiments described with respect to Concept 1, Concept 2, Concept 4 and Concept 4, may be implemented independently and/or separately. Alternatively and/or additionally, a combination of embodiments described herein, such as embodiments described with respect to Concept 1, Concept 2, Concept 4 and/or Concept 4, may be implemented. Alternatively and/or additionally, a combination of embodiments described herein, such as embodiments described with respect to Concept 1, Concept 2, Concept 4 and/or Concept 4, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

With respect to one or more embodiments herein, such as one or more embodiments provided with respect to Concept 1, Concept 2, Concept 3 and/or Concept 4, in some examples, the BSR may be a Regular BSR.

With respect to one or more embodiments herein, in some examples, a BSR triggering a 2-step RA procedure may correspond to the BSR triggering the 2-step RA procedure directly (e.g., the 2-step RA procedure is triggered directly in response to the BSR). In an example, rather than the 2-step RA procedure being triggered by a SR that is triggered by the BSR, the 2-step RA procedure may be triggered (e.g., directly triggered) by the BSR (without taking a SR that is triggered by the BSR into account, for example).

With respect to one or more embodiments herein, in some examples, a UE initiating a 2-step RA procedure for transmitting a BSR may correspond to the UE directly initiating the BSR in response to the BSR (e.g., in response to the BSR being triggered). In an example, rather than the 2-step RA procedure being initiated in response to a SR that is triggered by the BSR, the 2-step RA procedure may be initiated directly in response to the BSR (e.g., directly in response to the BSR being triggered) (without taking a SR that is triggered by the BSR into account, for example).

With respect to one or more embodiments herein, in some examples, an entity being allowed to perform an action may mean that the entity is configured and/or enabled to perform the action (and/or the entity is not prevented from performing the action). In an example, a UE being allowed to initiate a 2-step RA procedure for transmitting a BSR may mean that the UE is configured and/or enabled to initiate the 2-step RA procedure for transmitting the BSR (and/or the UE is not prevented from initiating the 2-step RA procedure for transmitting the BSR). Alternatively and/or additionally, an entity not being allowed to perform an action may mean that the entity is not configured and/or enabled to perform the action (and/or the entity is prevented from performing the action). In an example, a UE not being allowed to initiate a 2-step RA procedure for transmitting a BSR may mean that the UE is not configured and/or not enabled to initiate the 2-step RA procedure for transmitting the BSR (and/or the UE is prevented from initiating the 2-step RA procedure for transmitting the BSR).

FIG. 7 is a flow chart 700 according to one exemplary embodiment from the perspective of a UE. In step 705, the UE triggers a Regular BSR. In step 710, the UE determines, in response to triggering the Regular BSR, that there is no UL resource on PUSCH (e.g., no available UL resource on PUSCH) for transmitting the Regular BSR. In step 715, if one or more first conditions are met (e.g., if the UE fulfills the one or more first conditions), the UE determines, in response to determining that there is no UL resource on PUSCH for transmitting the Regular BSR, whether or not the UE can initiate a 2-step RA procedure for transmitting the Regular BSR. Alternatively and/or additionally, in step 715, if the one or more first conditions are not met (e.g., if the UE does not fulfill the one or more first conditions), the UE does not determine whether or not the UE can initiate a 2-step RA procedure for transmitting the Regular BSR (e.g., if the one or more first conditions are not met, the UE does not determine, in response to triggering the Regular BSR, whether or not the UE can initiate a 2-step RA procedure for transmitting the Regular BSR).

In one embodiment, the determination (performed if the one or more first conditions are met, for example) of whether or not the UE can initiate a 2-step RA procedure for transmitting the Regular BSR may correspond to a determination of whether or not the UE is allowed and/or configured to initiate the 2-step RA procedure for transmitting the Regular BSR.

In one embodiment, if the one or more first conditions are met and the UE initiates the 2-step RA procedure for transmitting the Regular BSR, the UE triggers a SR (e.g., the SR may be triggered in response to triggering the Regular BSR if the one or more first conditions are met and the UE initiates the 2-step RA procedure for transmitting the Regular BSR). In an example, the UE may initiate the 2-step RA procedure for transmitting the Regular BSR based on a determination that the UE can initiate the 2-step RA procedure for transmitting the Regular BSR.

In one embodiment, if the one or more first conditions are met and the UE initiates the 2-step RA procedure for transmitting the Regular BSR, the UE does not trigger a SR (e.g., a SR is not triggered in response to triggering the Regular BSR if the one or more first conditions are met and the UE initiates the 2-step RA procedure for transmitting the Regular BSR). In an example, the UE may initiate the 2-step RA procedure for transmitting the Regular BSR based on a determination that the UE can initiate the 2-step RA procedure for transmitting the Regular BSR.

In one embodiment, the UE has one or more valid PUCCH resources for the SR when the UE initiates the 2-step RA procedure for transmitting the Regular BSR.

In one embodiment, the UE does not initiate (and/or does not trigger) a 2-step RA procedure based on the UE not having a valid PUCCH resource for the SR (e.g., the UE does not initiate and/or trigger a 2-step RA procedure for transmitting the Regular BSR if the UE does not have a valid PUCCH resource for the SR).

In one embodiment, the UE triggers a SR if the one or more first conditions are not met (e.g., the UE does not fulfill the one or more first conditions) and the UE does not have a valid PUCCH resource for the SR.

In one embodiment, the one or more first conditions comprise a condition associated with whether or not the UE is in a first RRC state when the Regular BSR is triggered. In an example, the condition is met if the UE is in the first RRC state when the Regular BSR is triggered, wherein the condition is not met if the UE is not in the first RRC state when the Regular BSR is triggered.

In one embodiment, the one or more first conditions comprise a condition associated with whether or not the UE is not in a second RRC state when the Regular BSR is triggered. In an example, the condition is met if the UE is not in the first RRC state when the Regular BSR is triggered, wherein the condition is not met if the UE is in the first RRC state when the Regular BSR is triggered.

In one embodiment, the one or more first conditions comprise a condition associated with whether or not a logical channel that triggered the BSR is a first logical channel. In an example, the condition is met if the logical channel that triggered the BSR is the first logical channel, wherein the condition is not met if the logical channel that triggered the BSR is not the first logical channel.

In one embodiment, the one or more first conditions comprise a condition associated with whether or not a logical channel that triggered the BSR is not a second logical channel. In an example, the condition is met if the logical channel that triggered the BSR is not the second logical channel, wherein the condition is not met if the logical channel that triggered the BSR is the second logical channel.

In one embodiment, the one or more first conditions comprise a condition associated with whether or not a first radio bearer does not have data available for transmission when the BSR is triggered. In an example, the condition is met if the first radio bearer does not have data available for transmission when the BSR is triggered, wherein the condition is not met if the first radio bearer has data available for transmission when the BSR is triggered.

In one embodiment, the one or more first conditions comprise a condition associated with whether or not a second radio bearer has data available for transmission when the BSR is triggered. In an example, the condition is met if the second radio bearer has data available for transmission when the BSR is triggered, wherein the condition is not met if the second radio bearer does not have data available for transmission when the BSR is triggered.

In one embodiment, the one or more first conditions comprise a condition associated with whether or not a first RRC message is not to be transmitted (e.g., whether or not the first RRC message is not pending transmission) when the BSR is triggered. In an example, the condition is met if the first RRC message is not to be transmitted (e.g., the first RRC message is not pending transmission) when the BSR is triggered, wherein the condition is not met if the first RRC message is to be transmitted (e.g., the first RRC message is pending transmission) when the BSR is triggered.

In one embodiment, the one or more first conditions comprise a condition associated with whether or not a second RRC message is to be transmitted (e.g., whether or not the second RRC message is pending transmission) when the BSR is triggered. In an example, the condition is met if the second RRC message is to be transmitted (e.g., the second RRC message is pending transmission) when the BSR is triggered, wherein the condition is not met if the second RRC message is not to be transmitted (e.g., the second RRC message is not pending transmission) when the BSR is triggered.

In one embodiment, the one or more first conditions comprise a condition associated with whether or not a first RRC procedure is ongoing when the BSR is triggered (e.g., whether or not the BSR is triggered between a start of the first RRC procedure and an end of the first RRC procedure). In an example, the condition is met if the first RRC procedure is ongoing when the BSR is triggered (e.g., the BSR is triggered between the start of the first RRC procedure and the end of the first RRC procedure), wherein the condition is not met if the first RRC procedure is not ongoing when the BSR is triggered (e.g., the BSR is triggered at a time that is not between the start of the first RRC procedure and the end of the first RRC procedure).

In one embodiment, the one or more first conditions comprise a condition associated with whether or not a second RRC procedure is not ongoing when the BSR is triggered (e.g., whether or not the BSR is triggered at a time that is not between a start of the second RRC procedure and an end of the second RRC procedure). In an example, the condition is met if the second RRC procedure is not ongoing when the BSR is triggered (e.g., the BSR is triggered at a time that is not between the start of the second RRC procedure and the end of the second RRC procedure), wherein the condition is not met if the second RRC procedure is ongoing when the BSR is triggered (e.g., the BSR is triggered between the start of the second RRC procedure and the end of the second RRC procedure).

Referring back to FIGS. 3 and 4, in one exemplary embodiment of a UE, the device 300 includes a program code 312 stored in the memory 310. The CPU 308 may execute program code 312 to enable the UE (i) to trigger a Regular BSR, (ii) to determine, in response to triggering the Regular BSR, that there is no UL resource on PUSCH for transmitting the Regular BSR, and (iii) if one or more first conditions are met, to determine, in response to determining that there is no UL resource on PUSCH for transmitting the Regular BSR, whether or not the UE can initiate a 2-step RA procedure for transmitting the Regular BSR, or if the one or more first conditions are not met, to not determine whether or not the UE can initiate a 2-step RA procedure for transmitting the Regular BSR. Furthermore, the CPU 308 can execute the program code 312 to perform one, some and/or all of the above-described actions and steps and/or others described herein.

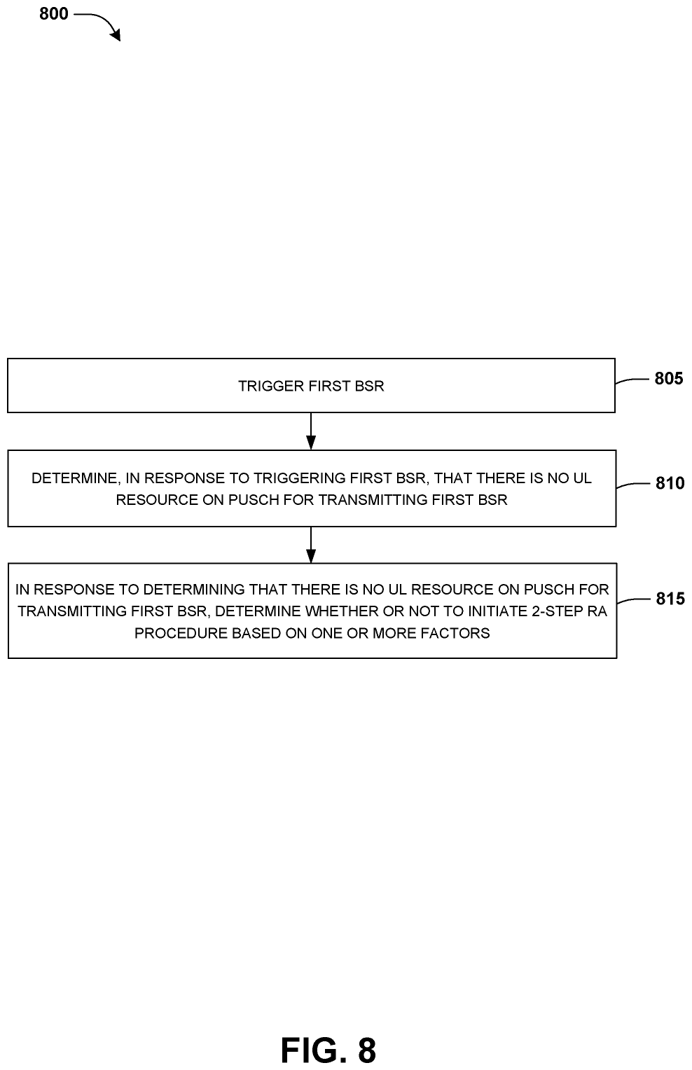

FIG. 8 is a flow chart 800 according to one exemplary embodiment from the perspective of a UE. In step 805, the UE triggers a first BSR. In step 810, the UE determines, in response to triggering the first BSR, that there is no UL resource on PUSCH (e.g., no available UL resource on PUSCH) for transmitting the first BSR. In step 815, in response to determining that there is no UL resource on PUSCH for transmitting the first BSR, the UE determines whether or not to initiate a 2-step RA procedure (for transmitting the first BSR, for example) based on one or more factors (e.g., the UE determines whether or not to initiate a 2-step RA procedure for transmitting the first BSR by considering the one or more factors).

In one embodiment, a factor of the one or more factors is a probability of initiation.

In one embodiment, the UE determines to initiate a 2-step RA procedure (for transmitting the first BSR, for example) based on a random number (e.g., a pseudo-random number) meeting (e.g., being lower than) the probability of initiation. For example, the UE may initiate the 2-step RA procedure (for transmitting the first BSR, for example) based on the random number meeting (e.g., being lower than) the probability of initiation. In an example, if the random number meets (e.g., is lower than) the probability of initiation, the UE initiates the 2-step RA procedure (for transmitting the first BSR, for example).

In one embodiment, the UE determines not to initiate a 2-step RA procedure (for transmitting the first BSR, for example) based on the random number (e.g., a pseudo-random number) not meeting (e.g., not being lower than) the probability of initiation. For example, the UE may not initiate a 2-step RA procedure (for transmitting the first BSR, for example) based on the random number not meeting (e.g., not being lower than) the probability of initiation. In an example, if the random number does not meet (e.g., is not lower than) the probability of initiation, the UE does not initiate a 2-step RA procedure (for transmitting the first BSR, for example).

In one embodiment, the random number is selected (e.g., drawn), such as randomly selected, from numbers within a range (e.g., the numbers may be uniformly distributed in the range). In an example, the range may be [0, 1), wherein 0 ≤the random number <1.:

In one embodiment, a factor of the one or more factors is a NW configuration (e.g., the configuration may be received from and/or configured by a NW).

In one embodiment, the UE determines to initiate a 2-step RA procedure (for transmitting the first BSR, for example) based on the NW configuration indicating 2-step RA (for transmitting BSR, for example). For example, the UE may initiate the 2-step RA procedure (for transmitting the first BSR, for example) based on the NW configuration indicating 2-step RA (for transmitting BSR, for example). In an example, if the NW configuration indicates 2-step RA (for transmitting BSR, for example), the UE initiates the 2-step RA procedure (for transmitting the first BSR, for example).

In one embodiment, the UE determines not to initiate a 2-step RA procedure (for transmitting the first BSR, for example) based on the NW configuration not being indicative of 2-step RA (for transmitting BSR, for example). For example, the UE may not initiate a 2-step RA procedure (for transmitting the first BSR, for example) based on the NW configuration not being indicative of 2-step RA (for transmitting BSR, for example). In an example, if the NW configuration does not indicate 2-step RA (for transmitting BSR, for example), the UE does not initiate a 2-step RA procedure (for transmitting the first BSR, for example).

In one embodiment, a factor of the one or more factors is a size of the first BSR.

In one embodiment, the UE determines to initiate a 2-step RA procedure (for transmitting the first BSR, for example) based on a number of reported LCGs (e.g., reported LCG number) in the first BSR (e.g., a number of LCGs indicated by the first BSR) being less than a first threshold. For example, the UE may initiate the 2-step RA procedure (for transmitting the first BSR, for example) based on the number of reported LCGs in the first BSR being less than the first threshold. In an example, if the number of reported LCGs in the first BSR is less than the first threshold, the UE initiates the 2-step RA procedure (for transmitting the first BSR, for example).

In one embodiment, the UE determines not to initiate a 2-step RA procedure (for transmitting the first BSR, for example) based on the number of reported LCGs in the first BSR not being less than a first threshold. For example, the UE may not initiate a 2-step RA procedure (for transmitting the first BSR, for example) based on the number of reported LCGs in the first BSR not being less than the first threshold. In an example, if the number of reported LCGs in the first BSR is not less than the first threshold, the UE does not initiate a 2-step RA procedure (for transmitting the first BSR, for example).

In one embodiment, the first threshold is a limited number of LCGs in a BSR, wherein the limited number of LCGs is received from the NW.

In one embodiment, a factor of the one or more factors is a common timing offset value.

In one embodiment, the UE determines to initiate a 2-step RA procedure (for transmitting the first BSR, for example) based on the common timing offset value being higher than a second threshold. For example, the UE may initiate the 2-step RA procedure (for transmitting the first BSR, for example) based on the common timing offset value being higher than the second threshold. In an example, if the common timing offset value is higher than the second threshold, the UE initiates the 2-step RA procedure (for transmitting the first BSR, for example).

In one embodiment, the UE determines not to initiate a 2-step RA procedure (for transmitting the first BSR, for example) based on the common timing offset value not being higher than the second threshold. For example, the UE may not initiate a 2-step RA procedure (for transmitting the first BSR, for example) based on the common timing offset value not being higher than the second threshold. In an example, if the common timing offset value is not higher than the second threshold, the UE does not initiate a 2-step RA procedure (for transmitting the first BSR, for example).

In one embodiment, the common timing offset value is broadcast by the NW (e.g., the NW broadcasts the common timing offset value to one or more UEs comprising the UE).

In one embodiment, the second threshold is a shortest timing offset (e.g., a shortest timing offset value) received from the NW.

In one embodiment, a factor of the one or more factors is a Serving Cell of the UE.

In one embodiment, the UE determines to initiate a 2-step RA procedure (for transmitting the first BSR, for example) based on a Serving Cell ID of the Serving Cell being in a first list. For example, the UE may initiate the 2-step RA procedure (for transmitting the first BSR, for example) based on the Serving Cell ID of the Serving Cell being in the first list. In an example, if the Serving Cell ID of the Serving Cell is in the first list, the UE initiates the 2-step RA procedure (for transmitting the first BSR, for example).

In one embodiment, the UE determines not to initiate a 2-step RA procedure (for transmitting the first BSR, for example) based on the Serving Cell ID of the Serving Cell not being in the first list. For example, the UE may not initiate a 2-step RA procedure (for transmitting the first BSR, for example) based on the Serving Cell ID of the Serving Cell not being in the first list. In an example, if the Serving Cell ID of the Serving Cell is not in the first list, the UE does not initiate a 2-step RA procedure (for transmitting the first BSR, for example).

In one embodiment, the first list is a list of allowed Serving Cells, wherein the list of allowed Serving Cells is received from the NW.

In one embodiment, a factor of the one or more factors is a platform type in NTN (e.g., a platform type of a platform with which the UE is linked and/or a platform type of a platform through which the UE is linked to the NTN).

In one embodiment, the UE determines to initiate a 2-step RA procedure (for transmitting the first BSR, for example) based on the UE being linked to a first platform type. For example, the UE may initiate the 2-step RA procedure (for transmitting the first BSR, for example) based on the UE being linked to the first platform type. In an example, if the UE is linked to the first platform type, the UE initiates the 2-step RA procedure (for transmitting the first BSR, for example).

In one embodiment, the UE determines not to initiate a 2-step RA procedure (for transmitting the first BSR, for example) based on the UE not being linked to the first platform type. For example, the UE may not initiate a 2-step RA procedure (for transmitting the first BSR, for example) based on the UE not being linked to the first platform type. In an example, if the UE is not linked to the first platform type, the UE does not initiate a 2-step RA procedure (for transmitting the first BSR, for example).

In one embodiment, the first platform type (e.g., a specific platform type) is indicated by the NW (e.g., the UE receives an indication of the first platform type from the NW).

In one embodiment, the first BSR is a Regular BSR.

In one embodiment, the UE is in a cell of NTN.

In one embodiment, the UE is a NR device and/or a NR-light device.

In one embodiment, the UE is a reduced capability device and/or a stationary device.

In one embodiment, the UE is a mobile phone, a wearable device, and/or a sensor.

In one embodiment, the UE is with mobility capability.

In one embodiment, the UE is with no mobility capability.

Referring back to FIGS. 3 and 4, in one exemplary embodiment of a UE, the device 300 includes a program code 312 stored in the memory 310. The CPU 308 may execute program code 312 to enable the UE (i) to trigger a first BSR, (ii) to determine, in response to triggering the first BSR, that there is no UL resource on PUSCH for transmitting the first BSR, and (iii) in response to determining that there is no UL resource on PUSCH for transmitting the first BSR, to determine whether or not to initiate a 2-step RA procedure (for transmitting the first BSR, for example) based on one or more factors. Furthermore, the CPU 308 can execute the program code 312 to perform one, some and/or all of the above-described actions and steps and/or others described herein.

FIG. 9 is a flow chart 900 according to one exemplary embodiment from the perspective of a UE. In step 905, the UE receives a configuration, of a logical channel, associated with 2-step RA procedure. For example, the configuration may be indicative of information associated with the UE performing a 2-step RA procedure associated with the logical channel (and/or whether or not the UE is configured and/or enabled to perform a 2-step RA procedure associated with the logical channel). In step 910, the UE triggers a Regular BSR for the logical channel. In step 915, the UE determines, based on the configuration of the logical channel, whether to initiate a first 2-step RA procedure (e.g., initiate the first 2-step RA procedure for transmitting the Regular BSR) or to initiate a first 4-step RA procedure (e.g., initiate the first 4-step RA procedure for transmitting the Regular BSR). In some examples, the determination of whether to initiate the first 2-step RA procedure or to initiate the first 4-step RA procedure is based on other information in addition to the configuration of the logical channel.

In one embodiment, the UE initiates the first 2-step RA procedure for transmitting the Regular BSR based on the configuration indicating that the logical channel can trigger a 2-step RA procedure. In an example, the UE may initiate the first 2-step RA procedure for transmitting the Regular BSR based on the configuration indicating that the logical channel is configured and/or enabled to trigger a 2-step RA procedure (e.g., based on the configuration indicating that triggering a 2-step RA procedure in response to UL data of the logical channel becoming available is enabled). In an example, the UE may initiate the first 2-step RA procedure for transmitting the Regular BSR based on the configuration comprising an activation indication (e.g., an indication indicative of activating 2-step RA for transmitting BSR triggered in response to UL data of the logical channel becoming available). In an example, the UE may initiate the first 2-step RA procedure for transmitting the Regular BSR based on the configuration indicating that the UE is configured and/or enabled to initiate a 2-step RA procedure associated with the logical channel (e.g., based on the configuration indicating that the UE is configured and/or enabled to initiate a 2-step RA procedure for transmitting a BSR that is triggered in response to UL data of the logical channel becoming available, such as becoming available for transmission).

In one embodiment, the UE initiates the first 2-step RA procedure for transmitting the Regular BSR if the configuration indicates that the logical channel can trigger a 2-step RA procedure. In an example, the UE may initiate the first 2-step RA procedure for transmitting the Regular BSR if the configuration indicates that the logical channel is configured and/or enabled to trigger a 2-step RA procedure (e.g., if the configuration indicates that triggering a 2-step RA procedure in response to UL data of the logical channel becoming available is enabled). In an example, the UE may initiate the first 2-step RA procedure for transmitting the Regular BSR if the configuration comprises an activation indication (e.g., an indication indicative of activating 2-step RA for transmitting BSR triggered in response to UL data of the logical channel becoming available). In an example, the UE may initiate the first 2-step RA procedure for transmitting the Regular BSR if the configuration indicates that the UE is configured and/or enabled to initiate a 2-step RA procedure associated with the logical channel (e.g., if the configuration indicates that the UE is configured and/or enabled to initiate a 2-step RA procedure for transmitting a BSR that is triggered in response to UL data of the logical channel becoming available, such as becoming available for transmission).

In one embodiment, the UE does not initiate the first 2-step RA procedure for transmitting the Regular BSR based on the configuration indicating that the logical channel cannot trigger a 2-step RA procedure. In an example, the UE may not initiate the first 2-step RA procedure for transmitting the Regular BSR based on the configuration indicating that the logical channel is not configured and/or is not enabled to trigger a 2-step RA procedure (e.g., based on the configuration indicating that triggering a 2-step RA procedure in response to UL data of the logical channel becoming available is not enabled). In an example, the UE may not initiate the first 2-step RA procedure for transmitting the Regular BSR based on the configuration indicating that the UE is not configured and/or is not enabled to initiate a 2-step RA procedure associated with the logical channel (e.g., based on the configuration indicating that the UE is not configured and/or is not enabled to initiate a 2-step RA procedure for transmitting a BSR that is triggered in response to UL data of the logical channel becoming available, such as becoming available for transmission).

In one embodiment, the UE does not initiate the first 2-step RA procedure for transmitting the Regular BSR if the configuration indicates that the logical channel cannot trigger a 2-step RA procedure. In an example, the UE may not initiate the first 2-step RA procedure for transmitting the Regular BSR if the configuration indicates that the logical channel is not configured and/or is not enabled to trigger a 2-step RA procedure (e.g., if the configuration indicates that triggering a 2-step RA procedure in response to UL data of the logical channel becoming available is not enabled). In an example, the UE may not initiate the first 2-step RA procedure for transmitting the Regular BSR if the configuration indicates that the UE is not configured and/or is not enabled to initiate a 2-step RA procedure associated with the logical channel (e.g., if the configuration indicates that the UE is not configured and/or is not enabled to initiate a 2-step RA procedure for transmitting a BSR that is triggered in response to UL data of the logical channel becoming available, such as becoming available for transmission).

In one embodiment, the UE initiates the first 4-step RA procedure for transmitting the Regular BSR based on the configuration indicating that the logical channel cannot trigger a 2-step RA procedure. In an example, the UE may initiate the first 4-step RA procedure for transmitting the Regular BSR based on the configuration indicating that the logical channel is not configured and/or is not enabled to trigger a 2-step RA procedure (e.g., based on the configuration indicating that triggering a 2-step RA procedure in response to UL data of the logical channel becoming available is not enabled). In an example, the UE may initiate the first 4-step RA procedure for transmitting the Regular BSR based on the configuration indicating that the UE is not configured and/or is not enabled to initiate a 2-step RA procedure associated with the logical channel (e.g., based on the configuration indicating that the UE is not configured and/or is not enabled to initiate a 2-step RA procedure for transmitting a BSR that is triggered in response to UL data of the logical channel becoming available, such as becoming available for transmission).

In one embodiment, the UE initiates the first 4-step RA procedure for transmitting the Regular BSR if the configuration indicates that the logical channel cannot trigger a 2-step RA procedure. In an example, the UE may initiate the first 4-step RA procedure for transmitting the Regular BSR if the configuration indicates that the logical channel is not configured and/or is not enabled to trigger a 2-step RA procedure (e.g., if the configuration indicates that triggering a 2-step RA procedure in response to UL data of the logical channel becoming available is not enabled). In an example, the UE may initiate the first 4-step RA procedure for transmitting the Regular BSR if the configuration indicates that the UE is not configured and/or is not enabled to initiate a 2-step RA procedure associated with the logical channel (e.g., if the configuration indicates that the UE is not configured and/or is not enabled to initiate a 2-step RA procedure for transmitting a BSR that is triggered in response to UL data of the logical channel becoming available, such as becoming available for transmission).

In one embodiment, a measured RSRP is higher than a configured RSRP threshold.

In one embodiment, the UE initiates the first 2-step RA procedure for transmitting the Regular BSR based on the measured RSRP being higher than the configured RSRP threshold.

In one embodiment, the measured RSRP is a RSRP of a downlink pathloss reference.

In one embodiment, the measured RSRP is lower than the configured RSRP threshold, wherein the UE initiates the first 4-step RA procedure for transmitting the Regular BSR based on the measured RSRP being lower than the configured RSRP threshold.

In one embodiment, the Regular BSR is triggered in response to UL data for the logical channel becoming available. In an example, the Regular BSR is triggered when the UL data for the logical channel becomes available.

In one embodiment, the UE does not have an available UL resource for transmitting the Regular BSR (e.g., the UE is not configured with and/or provided with an available UL resource for transmitting the Regular BSR). In an example, the UE does not have an available UL resource for transmitting the Regular BSR when the Regular BSR is triggered. In an example, the determination of whether to initiate the first 2-step RA procedure or to initiate the first 4-step RA procedure may be performed in response to the UE determining that the UE does not have an available UL resource for transmitting the Regular BSR.

In one embodiment, the UE does not have a valid PUCCH resource for a SR (e.g., the UE is not configured with and/or provided with a valid PUCCH resource for a SR). In an example, the UE does not have a valid PUCCH resource for the SR when the Regular BSR is triggered.

In one embodiment, the UE has a valid PUCCH resource for a SR (e.g., the UE is configured with and/or provided with a valid PUCCH resource for a SR). In an example, the UE has the valid PUCCH resource for the SR when the Regular BSR is triggered.

In one embodiment, the UE is in a cell of an NTN and/or is connected to the cell of the NTN.

In an example in which the UE initiates the first 2-step RA procedure for transmitting the Regular BSR, the UE transmits the Regular BSR (e.g., to a NW, such as an NTN) during the first 2-step RA procedure. In an example, the UE transmits the Regular BSR via MSGA transmission of the first 2-step RA procedure. The MSGA transmission may comprise a first transmission (e.g., a RA preamble transmission) performed via one or more PRACH resources and/or a second transmission (e.g., a UL data transmission, such as a PUSCH payload transmission) performed via one or more PUSCH resources. In an example, the Regular BSR is transmitted via the second transmission.

Referring back to FIGS. 3 and 4, in one exemplary embodiment of a UE, the device 300 includes a program code 312 stored in the memory 310. The CPU 308 may execute program code 312 to enable the UE (i) to receive a configuration, of a logical channel, associated with 2-step RA procedure, (ii) to trigger a Regular BSR for the logical channel, and (iii) to determine whether to initiate a first 2-step RA procedure or to initiate a first 4-step RA procedure based on the configuration of the logical channel. Furthermore, the CPU 308 can execute the program code 312 to perform one, some and/or all of the above-described actions and steps and/or others described herein.

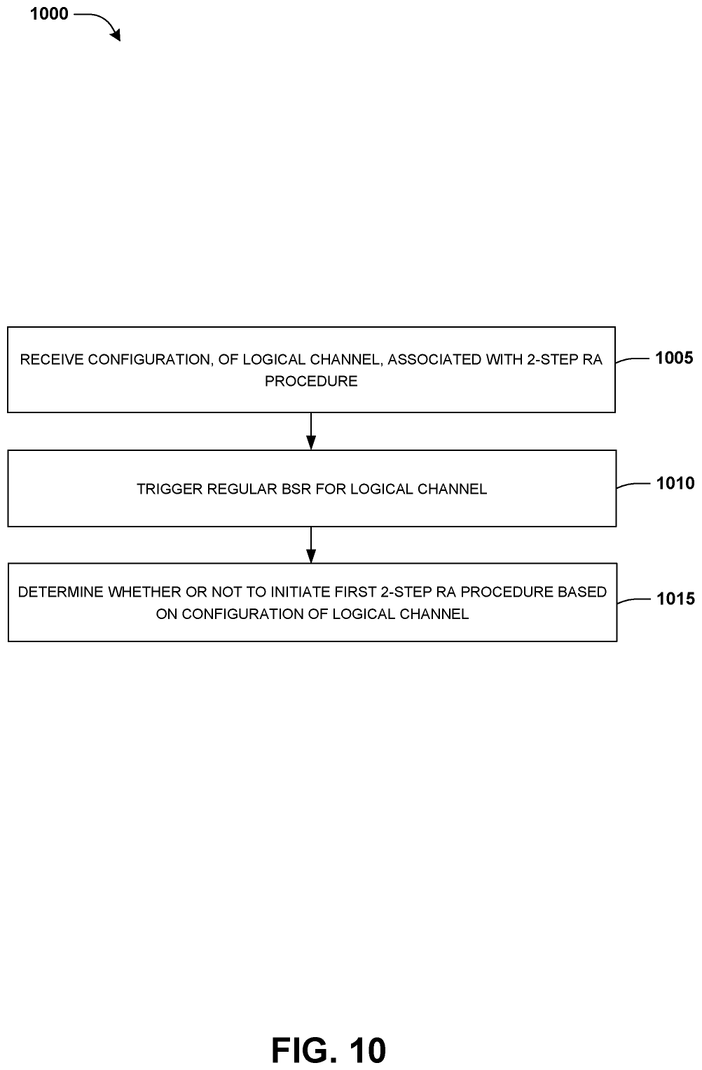

FIG. 10 is a flow chart 1000 according to one exemplary embodiment from the perspective of a UE. In step 1005 the UE receives a configuration, of a logical channel, associated with 2-step RA procedure. For example, the configuration may be indicative of information associated with the UE performing a 2-step RA procedure associated with the logical channel (and/or whether or not the UE is configured and/or enabled to perform a 2-step RA procedure associated with the logical channel). In step 1010, the UE triggers a Regular BSR for the logical channel. In step 1015, the UE determines, based on the configuration of the logical channel, whether or not to initiate a first 2-step RA procedure (e.g., initiate the first 2-step RA procedure for transmitting the Regular BSR). In some examples, the determination of whether or not to initiate the first 2-step RA procedure is based on other information in addition to the configuration of the logical channel.

In one embodiment, the UE initiates the first 2-step RA procedure for transmitting the Regular BSR based on the configuration indicating that the logical channel can trigger a 2-step RA procedure. In an example, the UE may initiate the first 2-step RA procedure for transmitting the Regular BSR based on the configuration indicating that the logical channel is configured and/or enabled to trigger a 2-step RA procedure (e.g., based on the configuration indicating that triggering a 2-step RA procedure in response to UL data of the logical channel becoming available is enabled). In an example, the UE may initiate the first 2-step RA procedure for transmitting the Regular BSR based on the configuration comprising an activation indication (e.g., an indication indicative of activating 2-step RA for transmitting BSR triggered in response to UL data of the logical channel becoming available). In an example, the UE may initiate the first 2-step RA procedure for transmitting the Regular BSR based on the configuration indicating that the UE is configured and/or enabled to initiate a 2-step RA procedure associated with the logical channel (e.g., based on the configuration indicating that the UE is configured and/or enabled to initiate a 2-step RA procedure for transmitting a BSR that is triggered in response to UL data of the logical channel becoming available, such as becoming available for transmission).

In one embodiment, the UE initiates the first 2-step RA procedure for transmitting the Regular BSR if the configuration indicates that the logical channel can trigger a 2-step RA procedure. In an example, the UE may initiate the first 2-step RA procedure for transmitting the Regular BSR if the configuration indicates that the logical channel is configured and/or enabled to trigger a 2-step RA procedure (e.g., if the configuration indicates that triggering a 2-step RA procedure in response to UL data of the logical channel becoming available is enabled). In an example, the UE may initiate the first 2-step RA procedure for transmitting the Regular BSR if the configuration comprises an activation indication (e.g., an indication indicative of activating 2-step RA for transmitting BSR triggered in response to UL data of the logical channel becoming available). In an example, the UE may initiate the first 2-step RA procedure for transmitting the Regular BSR if the configuration indicates that the UE is configured and/or enabled to initiate a 2-step RA procedure associated with the logical channel (e.g., if the configuration indicates that the UE is configured and/or enabled to initiate a 2-step RA procedure for transmitting a BSR that is triggered in response to UL data of the logical channel becoming available, such as becoming available for transmission).

In one embodiment, the UE does not initiate the first 2-step RA procedure for transmitting the Regular BSR based on the configuration indicating that the logical channel cannot trigger a 2-step RA procedure. In an example, the UE may not initiate the first 2-step RA procedure for transmitting the Regular BSR based on the configuration indicating that the logical channel is not configured and/or is not enabled to trigger a 2-step RA procedure (e.g., based on the configuration indicating that triggering a 2-step RA procedure in response to UL data of the logical channel becoming available is not enabled). In an example, the UE may not initiate the first 2-step RA procedure for transmitting the Regular BSR based on the configuration indicating that the UE is not configured and/or is not enabled to initiate a 2-step RA procedure associated with the logical channel (e.g., based on the configuration indicating that the UE is not configured and/or is not enabled to initiate a 2-step RA procedure for transmitting a BSR that is triggered in response to UL data of the logical channel becoming available, such as becoming available for transmission).

In one embodiment, the UE does not initiate the first 2-step RA procedure for transmitting the Regular BSR if the configuration indicates that the logical channel cannot trigger a 2-step RA procedure. In an example, the UE may not initiate the first 2-step RA procedure for transmitting the Regular BSR if the configuration indicates that the logical channel is not configured and/or is not enabled to trigger a 2-step RA procedure (e.g., if the configuration indicates that triggering a 2-step RA procedure in response to UL data of the logical channel becoming available is not enabled). In an example, the UE may not initiate the first 2-step RA procedure for transmitting the Regular BSR if the configuration indicates that the UE is not configured and/or is not enabled to initiate a 2-step RA procedure associated with the logical channel (e.g., if the configuration indicates that the UE is not configured and/or is not enabled to initiate a 2-step RA procedure for transmitting a BSR that is triggered in response to UL data of the logical channel becoming available, such as becoming available for transmission).

In one embodiment, the UE initiates a 4-step RA procedure for transmitting the Regular BSR based on the configuration indicating that the logical channel cannot trigger a 2-step RA procedure. In an example, the UE may initiate the 4-step RA procedure for transmitting the Regular BSR based on the configuration indicating that the logical channel is not configured and/or is not enabled to trigger a 2-step RA procedure (e.g., based on the configuration indicating that triggering a 2-step RA procedure in response to UL data of the logical channel becoming available is not enabled). In an example, the UE may initiate the 4-step RA procedure for transmitting the Regular BSR based on the configuration indicating that the UE is not configured and/or is not enabled to initiate a 2-step RA procedure associated with the logical channel (e.g., based on the configuration indicating that the UE is not configured and/or is not enabled to initiate a 2-step RA procedure for transmitting a BSR that is triggered in response to UL data of the logical channel becoming available, such as becoming available for transmission).

In one embodiment, the UE initiates the 4-step RA procedure for transmitting the Regular BSR if the configuration indicates that the logical channel cannot trigger a 2-step RA procedure. In an example, the UE may initiate the 4-step RA procedure for transmitting the Regular BSR if the configuration indicates that the logical channel is not configured and/or is not enabled to trigger a 2-step RA procedure (e.g., if the configuration indicates that triggering a 2-step RA procedure in response to UL data of the logical channel becoming available is not enabled). In an example, the UE may initiate the 4-step RA procedure for transmitting the Regular BSR if the configuration indicates that the UE is not configured and/or is not enabled to initiate a 2-step RA procedure associated with the logical channel (e.g., if the configuration indicates that the UE is not configured and/or is not enabled to initiate a 2-step RA procedure for transmitting a BSR that is triggered in response to UL data of the logical channel becoming available, such as becoming available for transmission).

In one embodiment, the measured RSRP is lower than the configured RSRP threshold, wherein the UE does not initiate the first 2-step RA procedure for transmitting the Regular BSR based on the measured RSRP being lower than the configured RSRP threshold and/or the UE initiates a 4-step RA procedure for transmitting the Regular BSR based on the measured RSRP being lower than the configured RSRP threshold.

In one embodiment, the UE does not have an available UL resource for transmitting the Regular BSR (e.g., the UE is not configured with and/or provided with an available UL resource for transmitting the Regular BSR). In an example, the UE does not have an available UL resource for transmitting the Regular BSR when the Regular BSR is triggered. In an example, the determination of whether or not to initiate the first 2-step RA procedure may be performed in response to the UE determining that the UE does not have an available UL resource for transmitting the Regular BSR.

Referring back to FIGS. 3 and 4, in one exemplary embodiment of a UE, the device 300 includes a program code 312 stored in the memory 310. The CPU 308 may execute program code 312 to enable the UE (i) to receive a configuration, of a logical channel, associated with 2-step RA procedure, (ii) to trigger a Regular BSR for the logical channel, and (iii) to determine whether or not to initiate a first 2-step RA procedure based on the configuration of the logical channel. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 7-10. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 7-10, and/or one, some and/or all of the above-described actions and steps and/or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a User Equipment (UE), the method comprising:
receiving a configuration, of a logical channel, associated with 2-step Random Access (RA) procedure;
triggering a Regular Buffer Status Report (BSR) for the logical channel; and
determining whether to initiate a first 2-step RA procedure or to initiate a first 4-step RA procedure based on the configuration of the logical channel.

2. The method of claim 1, wherein:
the UE initiates the first 2-step RA procedure for transmitting the Regular BSR based on the configuration indicating that the logical channel can trigger a 2-step RA procedure.

3. The method of claim 1, wherein:
the UE does not initiate the first 2-step RA procedure for transmitting the Regular BSR based on the configuration indicating that the logical channel cannot trigger a 2-step RA procedure.

4. The method of claim 1, wherein:
the UE initiates the first 4-step RA procedure for transmitting the Regular BSR based on the configuration indicating that the logical channel cannot trigger a 2-step RA procedure.

5. The method of claim 1, wherein:
a measured Reference Signal Received Power (RSRP) is higher than a configured RSRP threshold.

6. The method of claim 5, comprising:
initiating the first 2-step RA procedure for transmitting the Regular BSR based on the measured RSRP being higher than the configured RSRP threshold.

7. The method of claim 1, wherein:
triggering the Regular BSR is in response to uplink (UL) data for the logical channel becoming available.

8. The method of claim 1, wherein:
the UE does not have an available uplink (UL) resource for transmitting the Regular BSR.

9. The method of claim 1, wherein:
the UE does not have a valid Physical Uplink Control Channel (PUCCH) resource for a Scheduling Request (SR).

10. The method of claim 1, wherein:
the UE has a valid Physical Uplink Control Channel (PUCCH) resource for a Scheduling Request (SR).

11. The method of claim 1, wherein:
the UE is at least one of in or connected to a cell of a Non-Terrestrial Network (NTN).

12. A User Equipment (UE), comprising:
a control circuit;
a processor installed in the control circuit; and
a memory installed in the control circuit and operatively coupled to the processor, wherein the processor is configured to execute a program code stored in the memory to perform operations, the operations comprising:
receiving a configuration, of a logical channel, associated with 2-step Random Access (RA) procedure;
triggering a Regular Buffer Status Report (BSR) for the logical channel; and
determining whether or not to initiate a first 2-step RA procedure based on the configuration of the logical channel.

13. The UE of claim 12, wherein:
the UE initiates the first 2-step RA procedure for transmitting the Regular BSR based on the configuration indicating that the logical channel can trigger a 2-step RA procedure.

14. The UE of claim 12, wherein:
the UE does not initiate the first 2-step RA procedure for transmitting the Regular BSR based on the configuration indicating that the logical channel cannot trigger a 2-step RA procedure.

15. The UE of claim 14, wherein:
the UE initiates a 4-step RA procedure for transmitting the Regular BSR based on the configuration indicating that the logical channel cannot trigger a 2-step RA procedure.

16. The UE of claim 12, wherein:
a measured Reference Signal Received Power (RSRP) is higher than a configured RSRP threshold.

17. The UE of claim 15, the operations comprising:
initiating the first 2-step RA procedure for transmitting the Regular BSR based on the measured RSRP being higher than the configured RSRP threshold.

18. The UE of claim 12, wherein:
triggering the Regular BSR is in response to uplink (UL) data for the logical channel becoming available.

19. The UE of claim 12, wherein:
the UE is at least one of in or connected to a cell of a Non-Terrestrial Network (NTN).

20. A non-transitory computer-readable medium comprising processor-executable instructions that when executed by a User Equipment (UE) cause performance of operations, the operations comprising:
receiving a configuration, of a logical channel, associated with 2-step Random Access (RA) procedure;
triggering a Regular Buffer Status Report (BSR) for the logical channel; and
determining whether to initiate a first 2-step RA procedure or to initiate a first 4-step RA procedure based on the configuration of the logical channel.
